(19) United States
(12) Patent Application Publication
(10) Pub. No.: US 2003/0119452 A1
(43) Pub. Date: Jun. 26, 2003

(54) Apparatus and method for controlling transmission power of downlink data channel in a mobile communication system supporting MBMS

(75) Inventors: Sung-Hoon Kim, Seoul (KR); Joon-Goo Park, Seoul (KR); Sung-Ho Choi, Songnam-shi (KR); Yong-Jun Kwak, Yongin-shi (KR); Jin-Weon Chang, Yongin-shi (KR); Kook-Heui Lee, Songnam-shi (KR); Ju-Ho Lee, Suwon-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/273,114

(22) Filed: Oct. 17, 2002

(30) Foreign Application Priority Data
Oct. 19, 2001 (KR) 2001-65542
May 3, 2002 (KR) 2002-24547

(51) Int. Cl. H04B 1/00; H04B 7/00; H04M 1/00; H04B 1/38

(52) U.S. Cl. 455/69; 455/572

(57) ABSTRACT

Disclosed is a method for controlling transmission power of a plurality of UEs (User Equipments) by a Node B to perform broadcasting in a mobile communication system including the Node B and the UEs capable of communicating with the Node B in a cell occupied by the Node B, the Node B being capable of broadcasting common information to specified UEs among the plurality of UEs. The method comprises receiving channel quality information for each UE from the UEs; and increasing or decreasing transmission power of the Node B based on the worst channel quality information among the channel quality information received from the UEs.

### PRIORITY

This application claims priority to an application entitled “Apparatus and Method for Controlling Transmission Power of Downlink Data Channel in a Mobile Communication System Supporting MBMS” filed in the Korean Industrial Property Office on Oct. 19, 2001 and assigned Serial No. 2001-65542, and an application entitled “Apparatus and Method for Controlling Transmission Power of Downlink Data Channel in a Mobile Communication Supporting MBMS” filed in the Korean Industrial Property Office on May 3, 2002 and assigned Serial No. 2002-24547, the contents of each which are incorporated herein by reference.

### BACKGROUND OF THE INVENTION

1. Field of the Invention

The present invention relates generally to a mobile communication system, and in particular, to an apparatus and method for providing a multimedia broadcast/multicast service (MBMS) through a dedicated physical channel.

2. Description of the Related Art

These days, due to the development of the communication industry, a CDMA (Code Division Multiple Access) mobile communication system provides a multimedia multicast service for transmitting not only voice data but also mass data such as packet data and circuit data. In order to support the multimedia multicast service, a broadcast/multicast service for providing services to a plurality of UEs (User Equipments) has been proposed. The broadcast/multicast service can be divided into a cell broadcast service (CBS) for mainly supporting messages, and a multimedia broadcast/multicast service (MBMS) for supporting multimedia data such as real-time video/audio, still image and character.

The CDMA communication system has various types of channels, including broadcast channels for broadcasting information to a plurality of UEs. Further, the CDMA communication system, for example, Release 99 communication system has several kinds of broadcast channels according to their uses. The broadcast channels include a BCH (Broadcasting Channel) and a FACH (Forward Access Channel). The BCH is used to broadcast Node B's system information (SI) needed for cell access by a UE, and the FACH is used to broadcast control information for assigning a dedicated channel to a specified UE and broadcast messages. Further, the FACH is also used for the same purpose as the BCH.

As stated above, the broadcast channels are used to transmit common control information to a plurality of UEs or individual control information to a specified UE. Therefore, the broadcast channels rarely have room to transmit user data. It is not possible to control transmission power of the broadcast channels because the broadcast channels transmit information to an unspecified number of UEs in a cell radius. Therefore, transmission power of the broadcast channels is set such that the broadcast channel can be received by the UEs at all points in the cell radius.

A method of setting transmission power of the broadcast channels will be described with reference to FIG. 1.

FIG. 1 schematically illustrates a method for setting transmission power of broadcast channels in a general CDMA communication system. Referring to FIG. 1, transmission power of broadcast channels transmitted by a Node B is set such that the broadcast channels can be transmitted to all UEs in a cell radius of the Node B. Thus, all the UEs in the Node B can receive the broadcast channels. Generally, in the W-CDMA communication system, the Node B controls transmission power to a transmission power level proper to a specific UE according to a channel condition between the Node B and the specific UE. However, unlike other channels, the broadcast channels transmit information to an unspecified number of UEs, so the Node B cannot control transmission power of the broadcast channels.

Further, in the CDMA mobile communication system, transmission power of a Node B, together with a downlink OVSF (Orthogonal Variable Spreading Factor) code resource, is the most important downlink transmission resource. Therefore, allowing all UEs in a cell radius of the Node B to receive the broadcast channels causes a considerable reduction in performance of the CDMA communication system. Thus, the CDMA communication system suppresses the use of the broadcast channels, if possible. Meanwhile, the MBMS, a service for simultaneously transmitting voice data and image data, requires a large quantity of transmission resources. Since there is a possibility that several services will be simultaneously performed in one Node B, it is necessary to control transmission power of the broadcast channels although the MBMS is serviced through the broadcast channels. In particular, when a small number of UEs receiving the MBMS service exist in one Node B, providing the MBMS service over the broadcast channels causes a reduction in efficiency of transmission resources, so it is necessary to provide the MBMS service over dedicated channels instead of common channel such as the broadcast channels. Even in this case, it is very important to control transmission power for the MBMS service in order to increase the service quality.

### SUMMARY OF THE INVENTION

It is, therefore, an object of the present invention to provide an apparatus and method for controlling transmission power of a Node B using common channels in a mobile communication system supporting a multimedia broadcast/multicast service (MBMS).

It is another object of the present invention to provide an apparatus and method for controlling transmission power of a Node B by assigning dedicated channels or common channels according to the number of UEs receiving MBMS in a mobile communication system supporting the MBMS.

It is further another object of the present invention to provide an apparatus and method for controlling transmission power of a Node B according to a handover state of a UE receiving MBMS in a mobile communication system supporting the MBMS.

To achieve the above and other objects, the present invention provides a method for controlling transmission power of a plurality of UEs by a Node B to perform broadcasting in a mobile communication system including the Node B and the UEs capable of communicating with the Node B in a cell occupied by the Node B, the Node B being capable of broadcasting common information to specified UEs among the plurality of UEs. The method comprises receiving channel quality information for each UE from the plurality of UEs; and increasing or decreasing transmission power of the Node B based on the worst channel quality information among the channel quality information received from the UEs.

To achieve the above and other objects, the present invention provides a method for controlling transmission power of a Node B by a UE in a mobile communication system including the Node B and a plurality of UEs capable of communicating with the Node B in a cell occupied by the Node B, the Node B being capable of broadcasting common information to specific UEs among the plurality of UEs. The method comprises measuring a channel quality by receiving the common information for a first preset period; and transmitting an up-TPC command for a second preset period if the measured channel quality is less than a preset target channel quality.

To achieve the above and other objects, the present invention provides an apparatus for controlling transmission power of a plurality of UEs by a Node B to perform broadcasting in a mobile communication system including the Node B and the UEs capable of communicating with the Node B in a cell occupied by the Node B, the Node B being capable of broadcasting common information to specified UEs among the plurality of UEs. The apparatus comprises a receiver for receiving channel quality information for each UE from the plurality of UEs; and a transmitter for increasing or decreasing transmission power of the Node B based on the worst channel quality information among the channel quality information received from the UEs.

To achieve the above and other objects, the present invention provides an apparatus for controlling transmission power of a Node B by a UE in a mobile communication system including the Node B and a plurality of UEs capable of communicating with the Node B in a cell occupied by the Node B, the Node B being capable of broadcasting common information to specific UEs among the plurality of UEs. The apparatus comprises a receiver for measuring a channel quality by receiving the common information for a first preset period; and a transmitter for transmitting an up-TPC command for a second preset period if the measured channel quality is less than a preset target channel quality.

### BRIEF DESCRIPTION OF THE DRAWINGS

The above and other objects, features and advantages of the present invention will become more apparent from the following detailed description when taken in conjunction with the accompanying drawings in which:

FIG. 1 schematically illustrates a method for setting transmission power of broadcast channels in a general CDMA communication system;

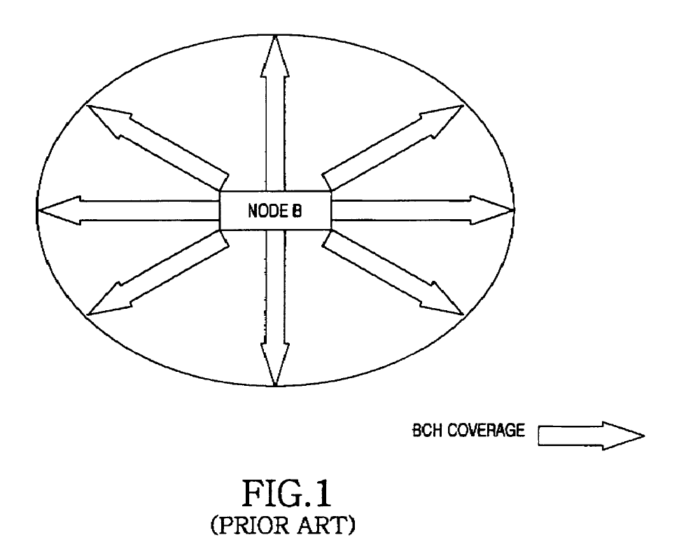

FIG. 2 illustrates a schematic structure of a CDMA mobile communication system supporting a multimedia broadcast/multicast service according to a first embodiment of the present invention;

FIG. 3 illustrates a detailed structure of each entity in the CDMA mobile communication system of FIG. 2;

FIG. 4 illustrates a structure of a physical broadcast multicast shared channel (PBMSCH) for a CDMA communication system supporting the MBMS according to a first embodiment of the present invention;

FIG. 5 schematically illustrates a process of exchanging control messages to provide MBMS in a CDMA mobile communication system according to a first embodiment of the present invention;

FIG. 6 illustrates a signal flow diagram illustrating a process of starting an MBMS service in a CDMA mobile communication system;

FIG. 7 is a flow chart illustrating a process of transmitting and receiving a control message by a UE of FIG. 5;

FIG. 8 is a flow chart illustrating a process of transmitting and receiving a control message by the RNC of FIG. 5;

FIG. 9A illustrates a CPCCH structure proposed by the present invention;

FIG. 9B illustrates a CPCCH structure applied to the UMTS communication system;

FIG. 10 is a flow chart illustrating a downlink transmission power control process by a UE according to a first embodiment of the present invention;

FIG. 11 is a flow chart illustrating a process of determining an uplink transmission power value for controlling transmission power of PBMSCH by a UE according to a first embodiment of the present invention;

FIG. 12 is a flow chart illustrating a process of controlling transmission power of PBMSCH by a Node B according to a first embodiment of the present invention;

FIG. 13 is a block diagram illustrating an internal structure of a UE according to a first embodiment of the present invention;

FIG. 14 is a block diagram illustrating an internal structure of a Node B according to a first embodiment of the present invention;

FIG. 15 schematically illustrates a scheme for providing an MBMS service using a shared channel in a mobile communication system;

FIG. 16 schematically illustrates a network structure for dynamically assigning channel resources based on the number of MBMS UEs according to a second embodiment of the present invention;

FIG. 17 schematically illustrate structures of a downlink DPDCH, a downlink informal DPCCH and an uplink DPCH according to a second embodiment of the present invention;

FIG. 18 is a flow diagram illustrating a process of providing an MBMS service in a mobile communication system according to a second embodiment of the present invention;

FIG. 19 illustrates an internal structure of a UE according to a second embodiment of the present invention;

FIG. 20 illustrates an operating process of a UE according to a second embodiment of the present invention;

FIG. 21 illustrates an internal structure of a Node B according to a second embodiment of the present invention;

FIG. 22 is a flow chart illustrating an operating process of a Node B according to a second embodiment of the present invention;

FIG. 23 is a flow chart illustrating an operating process of an RNC according to a second embodiment of the present invention;

FIG. 24 schematically illustrates a network structure for dynamically assigning channel resources according to the number of MBMS UEs according to a third embodiment of the present invention;

FIG. 25 schematically illustrates structures of a downlink DPDCH, a downlink DPCH and an uplink DPCH according to a third embodiment of the present invention;

FIG. 26A illustrates a transmission power control operation by the transmission power controller of FIG. 21 according to the second embodiment of the present invention;

FIG. 26B illustrates a transmission power control operation by a transmission power controller of FIG. 29 according to a third embodiment of the present invention;

FIG. 27 is a block diagram illustrating an internal structure of a UE according to a third embodiment of the present invention;

FIG. 28 is a flow chart illustrating an operating process of a UE according to a third embodiment of the present invention;

FIG. 29 illustrates a structure of a Node B for performing an operation according to a third embodiment of the present invention;

FIG. 30 is a flow chart illustrating an operating process of a Node B according to a third embodiment of the present invention;

FIG. 31 is a flow chart illustrating an operating process of an RNC according to a third embodiment of the present invention;

FIG. 32 schematically illustrates transmission power control during a general SHO;

FIG. 33 schematically illustrates a transmission power control process during a soft handover according to a fourth embodiment of the present invention;

FIG. 34 is a flow diagram schematically illustrating a process of indicating by an RNC to a Node B that a UE enters an SHO region according to a fourth embodiment of the present invention;

FIG. 35 schematically illustrates a network structure for determining a type of channels to be dynamically assigned based on the number of MBMS UEs according to a fifth embodiment of the present invention;

FIGS. 36A and 36B are flow diagrams illustrating a process of providing an MBMS service in a mobile communication system according to a fifth embodiment of the present invention;

FIG. 37 is a flow chart illustrating an operating process of the RNC shown in FIG. 36A according to a fifth embodiment of the present invention;

FIG. 38 is a flow chart illustrating an operating process of the RNC shown in FIG. 36B according to a fifth embodiment of the present invention;

FIG. 39 is a flow chart illustrating an operating process of the Node B shown in FIG. 36A according to a fifth embodiment of the present invention; and

FIG. 40 is a flow chart illustrating an operating process of the Node B shown in FIG. 36B according to a fifth embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

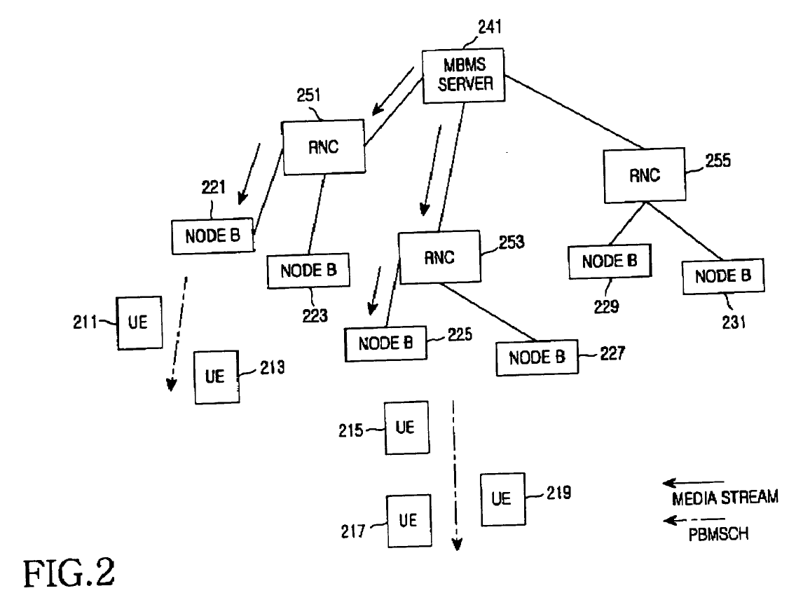

FIG. 2 illustrates a schematic structure of a CDMA mobile communication system supporting a multimedia broadcast/multicast service according to a first embodiment of the present invention.

The multimedia broadcast/multicast service (MBMS) means a broadcast service in which multicast multimedia data transmitted by one transmitter, or a Node B, is received by a plurality of receivers, or UEs (User Equipments). The MBMS can advantageously transmit mass data while maintaining high efficiency of transmission resources.

Referring to FIG. 2, UEs 211 and 213 are communicating with a Node B 221, and UEs 215, 217 and 219 are communicating with a Node B 225. An MBMS server 241 transmits the same MBMS data only once instead of repeatedly transmitting the same MBMS data to the UEs 211, 213, 215, 217 and 219, so that the UEs 211, 213, 215, 217 and 219 can receive the MBMS data. The MBMS data transmitted by the MBMS server 241 is transmitted to an RNC (Radio Network Controller) 251 connected to the Node B 221 and an RNC 253 connected to the Node B 225. The RNC 251 transmits the MBMS data from the MBMS server 241 to Node Bs 221 and 223 connected thereto, and the RNC 253 transmits the MBMS data from the MBMS server 241 to Node Bs 225 and 227 connected thereto. It is assumed in FIG. 2 that only the Node B 221 is communicating with the UEs 221 and 213 to perform the MBMS. However, if it is assumed that the Node B 223 is also communicating with UEs intending to receive the MBMS, the RNC 251 transmits the MBMS data received from the MBMS server 241 to the Node B 221 and the Node B 223. MBMS Server 241 does not transmit any MBMS data to RNC 255 as there are no UEs requests MBMS to Node B 229 or Node B 231.

When an RNC transmits MBMS data to a Node B in this manner, the Node B broadcasts the MBMS data received from the RNC to a cell region managed by the Node B through a physical broadcast multicast shared channel (PBMSCH), a broadcast channel for transmitting the MBMS data. Here, the PBMSCH is a broadcast channel proposed by the present invention, and a detailed structure of the PBMSCH will be described later. Then, UEs existing in the cell region of the Node B receive the MBMS data broadcasted by the Node B through the PBMSCH, thus receiving the MBMS.

In order to perform the MBMS, control messages for the MBMS must be exchanged between the UE and an RNC, between the RNC and a Node B, and between the RNC and the MBMS server. A process of exchanging control messages for the MBMS between the UE and an RNC, between the RNC and a Node B, and between the RNC and the MBMS server will be described herein below.

First, a UE notifies a RNC of a service type of the MBMS that it desires to receive. The RNC, notified by the UE of the service type of the MBMS that the UE desires to receive, transmits a request for a service corresponding to the notified service type of the MBMS to the MBMS server in order to request the service corresponding to the notified service type of the MBMS. Further, the RNC must control the Node B to assign PBMSCH, or a physical channel for transmitting the MBMS data. Here, a control message exchange between the UE and the RNC is performed through an RRC (Radio Resource Control) layer, and a process of exchanging control messages between the UE and the RNC through the RRC layer will be described later. In addition, a control message exchange between the RNC and the Node B is performed through an NBAP (Node B Application Part) message, and a process of exchanging this message will also be described later.

A control message exchange for the MBMS between the RNC and the MBMS server is defined in a new protocol. Control messages needed between the RNC and the MBMS server include an MBMS Request message used by the RNC to request a service for a specific service type of the MBMS, and an MBMS Cancel message used by the RNC to cancel a service for a specific service type of the MBMS. The MBMS Request message includes an indicator indicating a service type of the MBMS to be requested, and the MBMS Cancel message includes an indicator indicating a service type of the MBMS to be canceled.

As the RNC transmits the MBMS Request message or the MBMS Cancel message, the MBMS server must transmit response messages in reply to the messages received. A response message for the MBMS Request message is an MBMS Request Response message, and a response message for the MBMS Cancel message is an MBMS Cancel Response message. The MBMS Request Response message must include information on the requested service type of the MBMS such as a data rate, a service start time and a target service quality for the requested service type of the MBMS. Likewise, the MBMS Cancel Response message must include information on the service type of the MBMS canceled in reply to the MBMS Cancel message.

The RNC transmits the MBMS Request message to the MBMS server. Upon receiving the MBMS Request message, the MBMS server transmits an MBMS Request Response message to the RNC after completing preparation for performing MBMS corresponding to the MBMS Request message. Upon receiving the MBMS Request Response message, the RNC instructs a corresponding Node B, which has requested the MBMS, to establish PBMSCH, a broadcast channel for performing the MBMS. The Node B then establishes the PBMSCH, and if MBMS data provided from the MBMS server is transmitted over the established PBMSCH, the Node B notifies this fact to the UE along with information needed for the MBMS, thereby performing the MBMS.

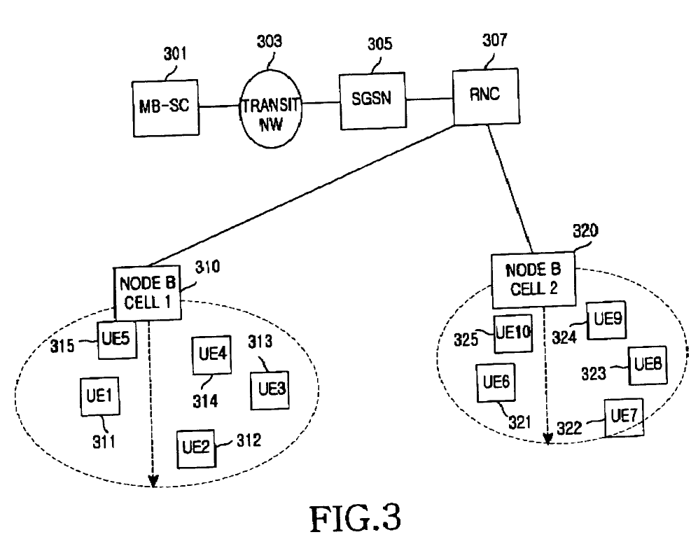

Now, a structure of a CDMA communication system for providing the MBMS service described in conjunction with FIG. 2 will be described with reference to FIG. 3.

FIG. 3 illustrates a detailed structure of each entity in the CDMA mobile communication system of FIG. 2. Referring to FIG. 3, a multicast/broadcast-service center (MB-SC) 301 is a source providing an MBMS data stream. The MB-SC 301 transmits the MBMS data stream to a transmission network 303 after scheduling. The transmission network 303, a network intervening between the MB-SC 301 and SGSN (Serving GPRS (General Packet Radio Service) Support Node) 305, transmits the MBMS data stream provided from the MB-SC 301 to the SGSN 305. The SGSN 305 can be comprised of GGSN (Gateway GPTS Support Node) and an external network. It will be assumed that a plurality of UEs desiring to receive the MBMS service at a certain time, e.g., UE1 311, UE2 312, UE3 313, UE4 314 and UE5 315 belonging to a Node B1 310 and UE6 321, UE7 322, UE8 323, UE9 324 and UE10 325 belonging to a Node B2 320 exist in the SGSN 305. The SGSN 305, receiving the MBMS data stream provided from the transmission network 303, controls an MBMS service-related service of subscribers, or UEs desiring to receive the MBMS service data. For example, the SGSN 305 controls an MBMS service-related service by selectively transmitting MBMS service account-related data and MBMS data of each subscriber to an RNC (Radio Network Controller) 307. Further, the SGSN 305 makes and manages an SGSN Service Context for the MBMS service X, and transmits a stream for the MBMS service to the RNC 307 again. The RNC 307 controls a plurality of Node Bs, and transmits MBMS data to a Node B in which a UE requiring the MBMS service exists, among the Node Bs managed by the RNC 307 itself. Further, the RNC 307 controls a radio channel set up to provide the MBMS service, and forms and manages an RNC Service Context for the MBMS service X, using a stream for the MBMS service provided from the SGSN 305. As illustrated in FIG. 3, only one radio channel is formed between a certain Node B, or a Node B1 310, and UEs 311, 312, 313, 314 and 315 belonging to the Node B1 310, to provide the MBMS service. Though not illustrated in FIG. 3, a home location register (HLR) is communicated with the SGSN 305 and performs subscriber authentication for the MBMS service.

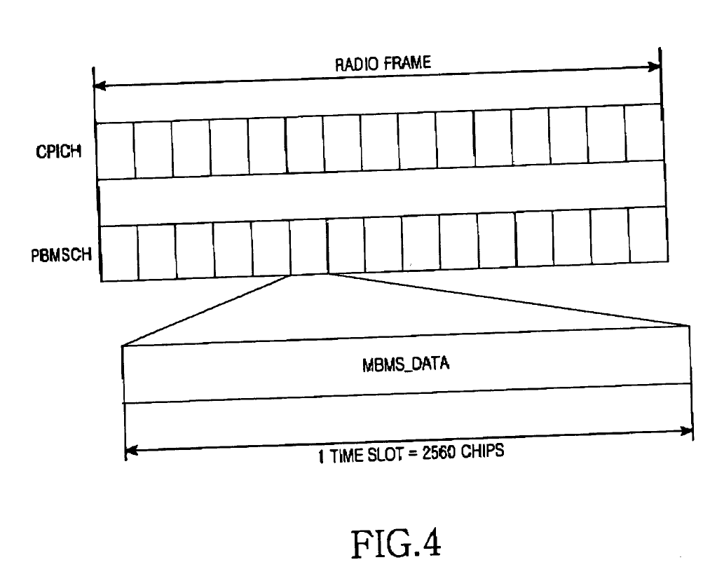

Next, a structure of the PBMSCH will be described herein below with reference to FIG. 4.

FIG. 4 illustrates a structure of a physical broadcast multicast shared channel (PBMSCH) for a CDMA communication system supporting the MBMS according to a first embodiment of the present invention. A radio frame structure of the PBMSCH is illustrated in FIG. 4. One time slot of the PBMSCH is comprised of 2,560 chips. The PBMSCH is identical to a common pilot channel (CPICH) in a radio frame boundary. Unlike the other channels, the PBMSCH transmits only pure MBMS data instead of control information such as uplink TPC (Transmission Power Control) command, TFCI (Transport Format Combination Indicator) symbol, and pilot symbol. A spreading factor (SF) for the PBMSCH is determined according to a service type of the MBMS service. For example, if the MBMS is a 64 Kbps video service using QPSK (Quadrature Phase Shift Keying) modulation and convolutional coding with a coding rate=1/3, then SF for the PBMSCH is 32. In this case, the MBMS data is comprised of 53 bits. Alternatively, a plurality of PBMSCHs can exist in one Node B.

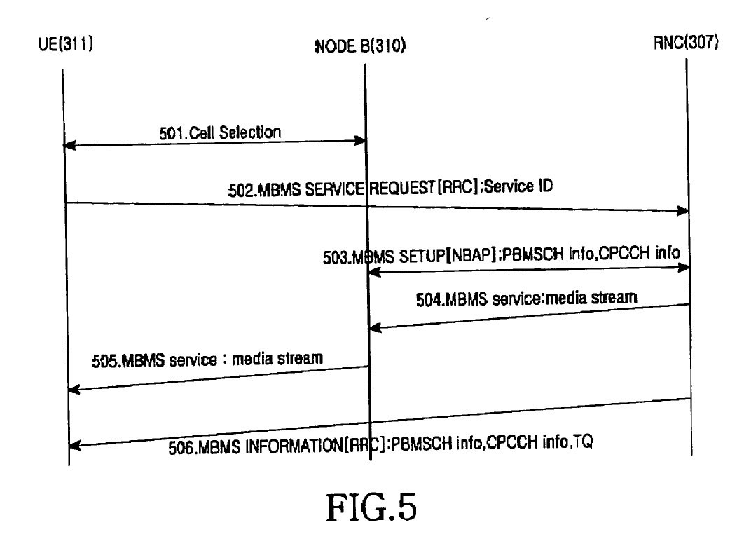

Next, a process of exchanging control messages among UE, Node B and RNC to perform the MBMS will be described with reference to FIG. 5.

FIG. 5 schematically illustrates a process of exchanging control messages to provide MBMS in a CDMA mobile communication system according to a first embodiment of the present invention. Referring to FIG. 5, a UE selects a cell, or a Node B providing MBMS in step 501 (Cell Selection). In the cell selection process, the UE performs frame synchronization and cell synchronization by receiving a P-CPICH (Primary-Common Pilot Channel) signal from the cell, and acquires information used to access the system by receiving system information (SI) transmitted over a broadcast channel (BCH). For example, the system information includes code information and random access information of RACH (Random Access Channel) used by a UE to transmit a message to a system.

After completing the cell selection, the UE transmits an MBMS Request message to an RNC through a Node B to which the UE belongs in step 502 (MBMS Request). The MBMS Request message, as described in conjunction with FIG. 4, includes an indicator indicating a service type of MBMS requested by the UE, and the MBMS Request message is transmitted through an RRC message. The indicator indicating the service type of the MBMS is previously agreed between the UE and a network.

Upon receiving the MBMS Request message, the RNC may manage MBMS service registration data according to the MBMS service request from the UE. That is, the RNC may perform authentication to an MBMS service authentication center for authentication of UEs that have requested the MBMS service. The RNC must have (i) information on UEs receiving the MBMS service, (ii) information on a current MBMS service channel, or current PBMSCH, (iii) information on a common power control channel (CPCCH) provided for power control, and (iv) information on a target quality (TQ) of the requested MBMS service type, the target quality becoming a criterion for controlling transmission power of an MBMS service channel. The Node B can determine whether an MBMS service is provided in the cell of the Node B, by analyzing the information managed by the RNC. If it is determined that a corresponding MBMS service type is provided in the Node B, the RNC transmits an MBMS Information message to the UE through an RRC message in step 506. The MBMS Information message includes (i) MBMS data reception-related information, such as OVSF (Orthogonal Variable Spreading Factor) code information for PBMSCH, or a physical channel transmitting the MBMS data, (ii) MCS (Modulation and Coding Scheme) level information, (iii) TQ information of MBMS corresponding to a requested service type, and (iv) information on CPCCH slot format. The CPCCH slot format information includes information on a length of a measurement period, a length of a TPC command period, and a period of a guard period (GP). A detailed description of the CPCCH slot format information will be given later. Upon receiving the MBMS Information message from the RNC, the UE performs the MBMS.

However, if the MBMS service type requested by the UE is not provided by the Node B to which the UE belongs, an operation of the Node B is changed as follows according to circumstances. If the MBMS service type requested by the UE is not supported in the Node B where the UE is located, but is supported in the RNC where the UE is located, i.e., if the MBMS of the corresponding service type is transmitted to another Node B through the corresponding RNC, the RNC transmits in step 503 an MBMS Setup Request message to a Node B to which the UE belongs using an NBAP message in order to set up PBMSCH capable of supporting MBMS of the corresponding service type. Upon receiving the MBMS Setup Request message, the Node B establishes PBMSCH for performing the MBMS, and if the PBMSCH is successfully established, the Node B transmits an MBMS Setup Complete message to the RNC.

Upon receiving the MBMS Setup Complete message, the RNC transmits MBMS data corresponding to the service type requested by the UE to the Node B in step 504, and the Node B transmits MBMS data reception-related information through MBMS Information message to the UE in step 505. Upon receiving the MBMS Information message from the Node B, the UE starts to perform MBMS corresponding to the requested service type using the MBMS data reception-related information.

Meanwhile, if the MBMS service type requested by the UE is not supported not only in the Node B to which the UE belongs, but also in the RNC to which the UE belongs, the RNC transmits a request for MBMS corresponding to the service type requested by the UE to an MBMS server, and establishes the PBMSCH through an MBMS setup process. The RNC transmits MBMS data of the service type requested by the UE through the established PBMSCH so that the UE receives the MBMS data.

The MBMS Request message, the MBMS Information message, the MBMS Setup Request message and the MBMS Setup Complete message are newly proposed by the present invention to transmit MBMS data through the PBMSCH. Information included in the MBMS Request message, the MBMS Information message, the MBMS Setup Request message and the MBMS Setup Complete message will be described herein below.

First, the MBMS Request message includes an indicator indicating the MBMS service type requested by the UE. Second, the MBMS Information message includes the PBMSCH-related information and transmission power control-related information. The PBMSCH-related information includes an OVSF code for the PBMSCH, and the transmission power control-related information includes the CPCCH slot format structure and target quality information. Third, the MBMS Setup Request message includes the PBMSCH-related information. Finally, the MBMS Setup Complete message includes information indicating successful establishment of the PBMSCH.

More specifically, the UE uses RACH in order to transmit the MBMS Request message to the RNC. After completing the cell selection, an RRC layer of the UE transmits an MBMS Request message to a physical layer through an RLC (Radio Link Control) layer and a MAC-c/sh (Medium Access Control for a common/shared channel) layer, and the physical layer transmits the MBMS Request message to the RLC layer over the RACH. The RLC layer performs retransmission of a message, and the MAC-c/sh layer performs UE identification.

Upon receiving the MBMS Request message from the UE, the RNC transmits an MBMS Information message to the physical layer through the RLC layer and the MAC-c/sh layer, and the physical layer transmits the MBMS Information message over the FACH. Here, the MBMS Information message is transmitted to an RRC layer through the physical layer and the MAC-c/sh layer of the UE and the RLC layer, and the RRC layer transmits to the physical layer a CPHY-CONFIG-REQ primitive with PBMSCH information included in the MBMS Information message and power control-related information. The physical layer establishes PBMSCH based on the PBMSCH information and the power control-related information included in the CPHY-CONFIG-REQ primitive.

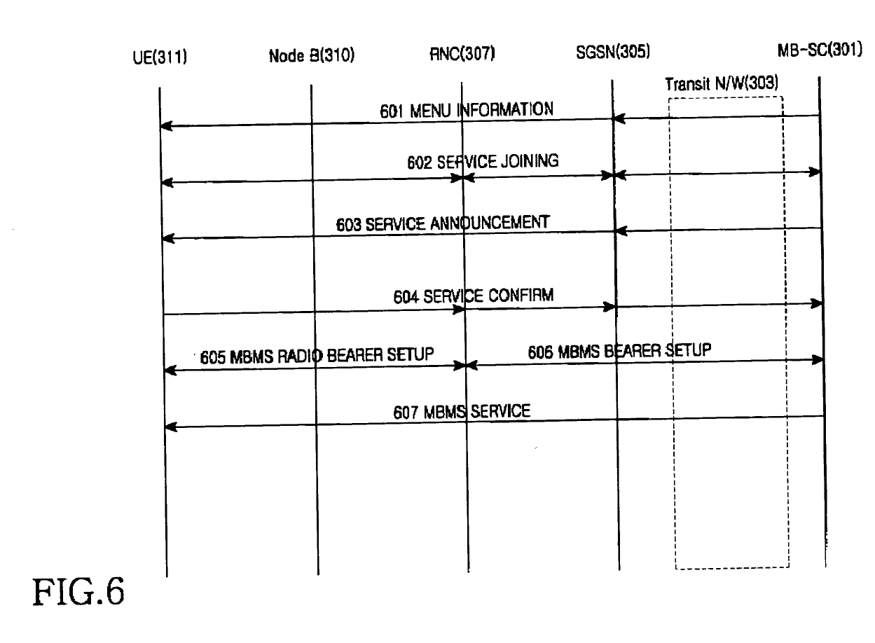

Next, a signal flow for starting an MBMS service in a CDMA mobile communication system will be described with reference to FIG. 6.

FIG. 6 illustrates a signal flow diagram illustrating a process of starting an MBMS service in a CDMA mobile communication system. Referring to FIG. 6, MB-SC 301 notifies MBMS service subscribers or UEs of menu information for available MBMS services (Step 601). The “menu information” refers to information indicating whether a specific MBMS service is provided at a certain time. The MB-SC 301 can broadcast the menu information to a predetermined service area, or transmit the menu information only to the UEs that have requested the MBMS service. Through the menu information, the MB-SC 301 provides an MBMS Service ID for identifying the MBMS service. For the sake of convenience, it will be assumed in FIG. 6 that the MBMS service subscriber is a UE 311. Upon receiving the menu information, the UE 311 selects a specific MBMS service from the menu information, and transmits a service request for the selected MBMS service to the MB-SC 301 (Step 602) (Service Joining). In the service joining process, the UE selects an ID of a service requested by the UE itself among MBMS Service IDs received through the menu information, and transmits the selected Service ID along with information on the UE requesting the MBMS service. Of course, the service request is transmitted to the MB-SC 301 through the path described in conjunction with FIG. 3, i.e., the UE 311, the Node B 310, the RNC 307, the SGSN 305 and the transmission network 303. Upon receiving the service request for a specific MBMS service from the UE 311, the MB-SC 301 transmits a response for the service request to the UE 311. In contrast, the response for the service request is transmitted from the MB-SC 301 to the UE 311 through the transmission network 303, the SGSN 305 and the RNC 307. The transmission network 303, the SGSN 305 and the RNC 307 store a UE ID (Identifier) indicating the UE 311 that has requested the specific MBMS service, and use the stored UE ID when actually starting the specific MBMS service. In this way, a network including the MB-SC 301, the transmission network 303, the SGSN 305 and the RNC 307 determines IDs of the UEs requesting the specific MBMS service and the number of the IDs.

After exchanging the request and the response for the specific MBMS service, the MB-SC 301 transmits to the UE 311 a service announcement message indicating that a specific MBMS service will be started in the near future (Step 603). It is assumed in FIG. 6 that the number of UEs desiring to receive a specific MBMS service is one, i.e., the UE 311. However, in the case where the network elements, i.e., the MB-SC 301, the transmission network 303, the SGSN 305 and the RNC 307 exchange service requests and responses for a specific MBMS service with a plurality of UEs, the MB-SC 301 recognizes the number of UEs and IDs indicating the UEs, so the MB-SC 301 may transmit the service announcement message to the respective UEs. The service announcement message is transmitted to the UE 311 through the transmission network 303, the SGSN 305 and the RNC 307, using a paging process defined in the UMTS (Universal Mobile Telecommunication System) standard. Here, the reason that the MB-SC 301 transmits the service announcement message is to allow a time period for which the transmission network 303, the SGSN 305 and the RNC 307 on the network can set up a transmission path for providing an MBMS service, and to detect UEs desiring to receive the MBMS service.

Upon receiving the service announcement message, the UE 311 transmits to the MB-SC 301 a service confirm message confirming that the UE 311 desires to receive the specific MBMS service (Step 604). The service confirm message is also transmitted to the MB-SC 301 through the RNC 307, the SGSN 305 and the transmission network 303. In this process, the transmission network 303, the SGSN 305 and the RNC 307 determine a service area and UEs to which the specific MBMS service must be provided, and set up a transmission path for actually providing the specific MBMS service. After the transmission path is set up on the network, the RNC 307 sets up a radio bearer, or a radio channel for exchanging a stream for the MBMS service with the UE 311 (Step 605). In addition, the SGSN 305 sets up an MBMS bearer, or a transmission path for exchanging a stream for the MBMS service with the RNC 307 (Step 606). The RNC 307 sets up a radio bearer only to the Node Bs where there exist UEs that have requested the MBMS service. Likewise, the SGSN 305 sets up an MBMS bearer only to the RNC where there exist UEs that have requested the MBMS service. In this state where the transmission path is set up on the network, the MB-SC 301 transmits a stream for the MBMS service at a corresponding time point, and the stream for the MBMS service is transmitted to the UE 311 through the set transmission path, actually starting the MBMS service (Step 607).

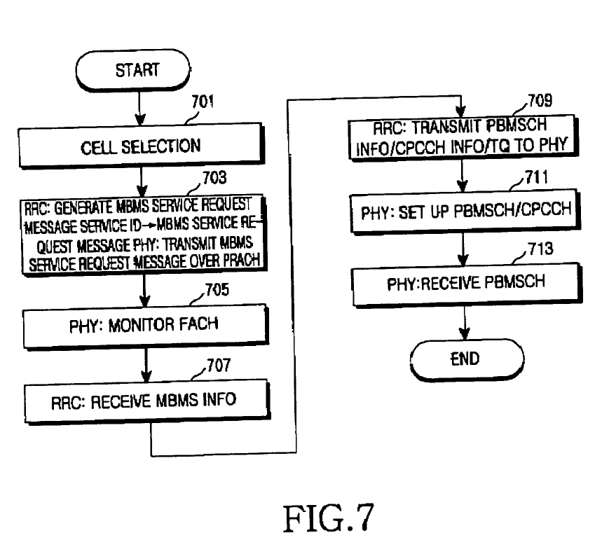

Next, an operation of receiving a PBMSCH signal by the UE 311 will be described with reference to FIG. 7.

FIG. 7 is a flow chart illustrating a process of transmitting and receiving a control message by a UE of FIG. 5. Referring to FIG. 7, if the UE 311 completes cell selection in step 701, an RRC layer of the UE 311 generates an MBMS Request message with a Service ID indicating a service type of the MBMS, and a physical layer of the UE 311 transmits' the generated MBMS Request message using PRACH (Physical RACH), in step 703. In step 705, the physical layer of the UE 311 receives information over FACH, a MAC-c/sh layer transmits to an RLC layer only information on the UE 311 among the received information, and the RLC layer, if necessary, performs retransmission, and transmits the retransmission information to an RRC layer. If a message transmitted from the RLC layer is MBMS Information in step 707, the RRC layer of the UE 311 transmits PBMSCH information, CPCCH information and target quality TQ included in the message to the physical layer in step 709. The physical layer of the UE 311 sets up the PBMSCH and the CPCCH based on the above information in step 711, and starts to receive MBMS data in step 713.

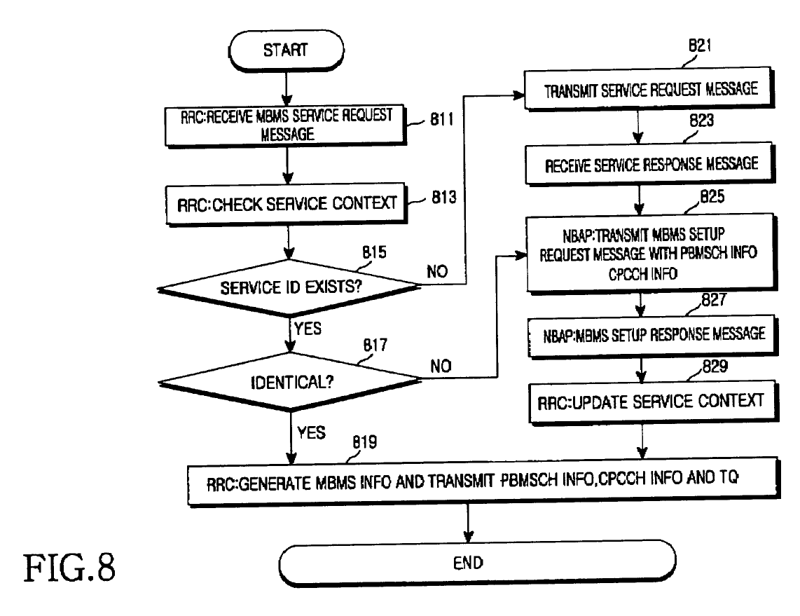

Next, an operation of performing the MBMS service by the RNC 307 will be described with reference to FIG. 8.

FIG. 8 is a flow chart illustrating a process of transmitting and receiving a control message by the RNC of FIG. 5. Before a description of FIG. 8, a Service Context will be described herein below. The Service Context is managed by the RNC, and has one item for each MBMS service type. Table 1 illustrates an example of the Service Context.

TABLE 1

| Service 1 | TQ 1 | | | |
|---|---|---|---|---|
| Cell 1 | PBMSCH 1 | OVSF Code | CPCCH 1 | OVSF Code |
| | | Other Info | | Slot Format |
| Cell 2 | PBMSCH 2 | OVSF Code | CPCCH 2 | OVSF Code |
| | | Other Info | | Slot Format |
| Cell n | PBMSCH n | OVSF Code | CPCCH n | OVSF Code |
| | | Other Info | | Slot Format |

As illustrated in Table 1, one target quality TQ is defined for each service type of the MBMS, and PBMSCH information and CPCCH information of the corresponding service are managed according to the cells where the corresponding service is provided.

Referring to FIG. 8, if an RRC layer of the RNC 307 receives an MBMS Request message in step 811, the RRC layer checks a Service Context managed in the RNC 307 in step 813. Thereafter, the RRC layer determines in step 815 whether an ID identical to a Service ID included in the MBMS Request message exists in the Service Context. As a result of the determination, if an ID identical to a Service ID included in the MBMS Request message exists in the Service Context, the RNC 307 determines in step 817 whether a cell identical to the cell that has transmitted an MBMS Request message belongs to the cells included in the corresponding Service ID. As a result of the determination, if a cell identical to the cell that has transmitted an MBMS Request message belongs to the cells included in the corresponding Service ID, the RNC 307 transmits in step 819 an MBMS Information message including PBMSCH information of a corresponding cell item in the Service Context, CPCCH information, and TQ of the corresponding service.

However, if an ID identical to a Service ID included in the MBMS Request message does not exist in the Service Context in step 815, it means that the corresponding service is not supported by the corresponding RNC. Therefore, the RNC 307 proceeds to step 821 and transmits a Service Request message having the corresponding Service ID as a parameter to a broadcast server. If a Service Response message for the Service Request message is received in step 823, the RNC 307 determines a PBMSCH parameter and a CPCCH parameter and transmits an MBMS Setup Request message to a Node B, in step 825. The RNC 307 receives an MBMS Setup Response message for the MBMS Setup Request message in step 827, and the RRC layer of the RNC 307 updates a corresponding cell item in the Service Context in step 829, and transmits MBMS information based on the updated Service Content in step 819. As a result of the determination in step 817, if a cell identical to the cell that has transmitted an MBMS Request message does not belong to the cells included in the corresponding Service ID, the RNC 307 determines a PBMSCH parameter and a CPCCH parameter for providing the corresponding service in the corresponding cell, and transmits an MBMS Setup message to the Node B, and then proceeds to step 827.

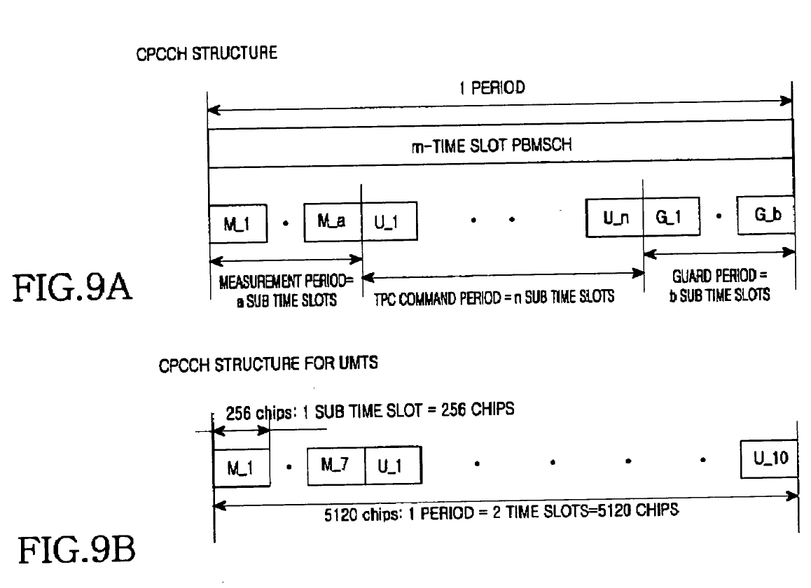

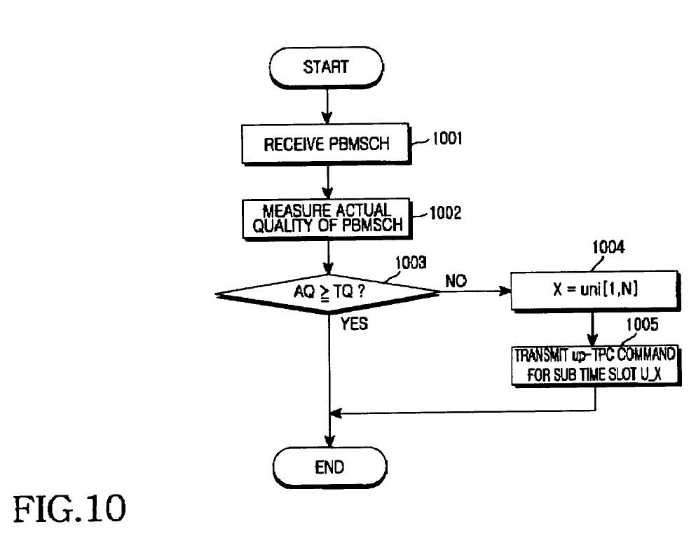

Next, a CPCCH structure for controlling transmission power of the PBMSCH will be described with reference to FIGS. 9A and 9B.

FIGS. 9A and 9B illustrate a CPCCH structure for a CDMA mobile communication system supporting MBMS according to a first embodiment of the present invention. Before a description of FIGS. 9A and 9B, reference will be made to the PBMSCH and the CPCCH. First, the PBMSCH must maintain a good channel condition for all UEs receiving the MBMS. That is, it is preferable to transmit the PBMSCH on the basis of a UE having the worst channel condition among the UEs receiving the PBMSCH. If TPC (Transmission Power Control) commands received from a plurality of UEs include at least one up-TPC command, the Node B increases transmission power of the PBMSCH signal in reply to the up-TPC command. That the Node B has received an up-TPC command for the PBMSCH signal means that the UEs that have received the PBMSCH signal include a UE which does not satisfy with the channel quality, i.e., the quality of the MBMS service provided over the PBMSCH. In contrast, if a down-TPC command is received, the Node B decreases transmission power of the PBMSCH. In this manner, it is possible for the Node B to transmit PBMSCH having a best channel condition at a certain point.

Together with transmission power control from a UE to the Node B, i.e., uplink transmission power control, control over an uplink transmission power control point should be performed. The reason is because if a plurality of UEs simultaneously perform uplink transmission power control, uplink interference will be increased. In addition, even when the UEs fail to maintain uplink transmission power to a proper level, the uplink interference is increased. However, the uplink interference problem during uplink transmission power control can be solved by controlling uplink transmission power using OLPC (Open Loop Power Control) based on power measurement on a pilot channel, and randomly distributing uplink transmission power control points.

For downlink transmission power control, however, it is not preferable to assign uplink dedicated channels to all UEs receiving the PBMSCH in order to transmit a downlink transmission power control command. The reasons are as follows. Each UE must be assigned a scrambling code for the uplink dedicated channel in order to receive an uplink dedicated channel signal and the Node B must receive the scrambling codes assigned to the respective UEs, thus causing a waste of code resources. In addition, information on the scrambling codes and information needed to set up the uplink dedicated channels must be previously exchanged between the Node B and the UEs.

Therefore, an embodiment of the present invention proposes a CPCCH structure in order to control the downlink transmission power.

The CPCCH is a channel for controlling downlink transmission power, and a common channel using a single scrambling code. The CPCCH is set up in association with the PBMSCH on a one-to-one basis, and the single scrambling code is previously agreed between the Node B and the UEs. That is, the UEs previously recognize the single scrambling code through previous agreement on the PBMSCH and the CPCCH associated with the PBMSCH.

FIG. 9A illustrates a CPCCH structure proposed by the present invention. Referring to FIG. 9A, one CPCCH period is comprised of a plurality of sub time slots. The one period means a time period where TPC commands are exchanged between the Node B and the UEs, and has a different value according to the type of a communication system to which the CPCCH is applied and the frequency of necessary transmission power controls. For example, if the communication system to which the CPCCH is applied is an UMTS communication system, one period of the CPCCH may be comprised of 0.667 ms-time slots. The CPCCH structure applied to the UMTS communication system is illustrated in FIG. 9B.

Meanwhile, the CPCCH is comprised of sub time slots [M_1, . . . , M_a] for measurement, sub time slots [U_1, . . . , U_n] for a TPC command, and sub time slots [G_1, . . . , G_b] for a guard period (GP). A period where the sub time slots [M_1, . . . , M_a] for measurement exist is called a “measurement period.” A period where the sub time slots [U_1, . . . , U_n] for a TPC command exist is called a “TPC command period.” A period where sub time slots [G_1, . . . , G_b] for a guard period is called a “guard period.”

The UE measures the channel quality of PBMSCH depending on a PBMSCH signal received for the measurement period, and if the measured channel quality of the PBMSCH is high, the UE continuously receives the PBMSCH signal without separate measures. If, however, the measured channel quality of the PBMSCH is low, the UE randomly selects one of idle sub time slots among the sub time slots existing in the TPC command period, and transmits an up-TPC command for the PBMSCH at the selected sub time slot. Here, the up-TPC command is modulated by BPSK (Binary Phase Shift Keying), and is set to “−1” or “1.” Although the up-TPC command has been described, it will be understood by those skilled in the art that a down-TPC command and a hold-TPC command can be set in the similar way.

The sub time slots for the guard period constitute a guard period where a TPC command transmitted by a UE existing at a boundary of the cell region of the Node B should not be mistaken for a TPC command in the next period of the CPCCH. The number “a” of the sub time slots for the measurement period, the number “n” of the sub time slots for the TPC command period, and the number “b” of the sub time slots for the guard period are adaptively set according to a state of the communication system to which the CPCCH is applied, and no signal is transmitted at the sub time slots for the measurement period and the sub time slots for the guard period.

FIG. 9B illustrates a CPCCH structure applied to the UMTS communication system. Referring to FIG. 9B, one period includes two time slots, and the period is comprised of 20 sub time slots each having a 256-chip size. The CPCCH uses a scrambling code previously assigned to the CPCCH, and one SF=256 OVSF code is assigned to the service. In the CPCCH structure of FIG. 9B, 7 sub time slots are assigned to the measurement period, and the remaining 13 sub time slots are assigned to the TPC command period and the measurement period is long enough, so no sub time slot is assigned to the guard period. In the UMTS communication system, although the b sub time slots, or the guard period is not set, the measurement period is an actual signal-less period. Therefore, it is not possible to distinguish a period of the CPCCH.

As described above, although the CPCCH varies in structure according to the type of the communication system to which the CPCCH is applied and the length of the period, the CPCCH structure proposed by the invention has the following characteristics.

(1) The CPCCH is a common channel over which TPC commands are transmitted by a plurality of UEs.

(2) The CPCCH is a channel in which one period includes a plurality of transmission slots.

(3) The CPCCH is a channel for transmitting a TPC command at a transmission slot selected by a UE when necessary.

(4) The CPCCH is a channel through which a Node B monitors TPC commands from the UEs. Here, the Node B responds in real time in reply to only an up-TPC command.

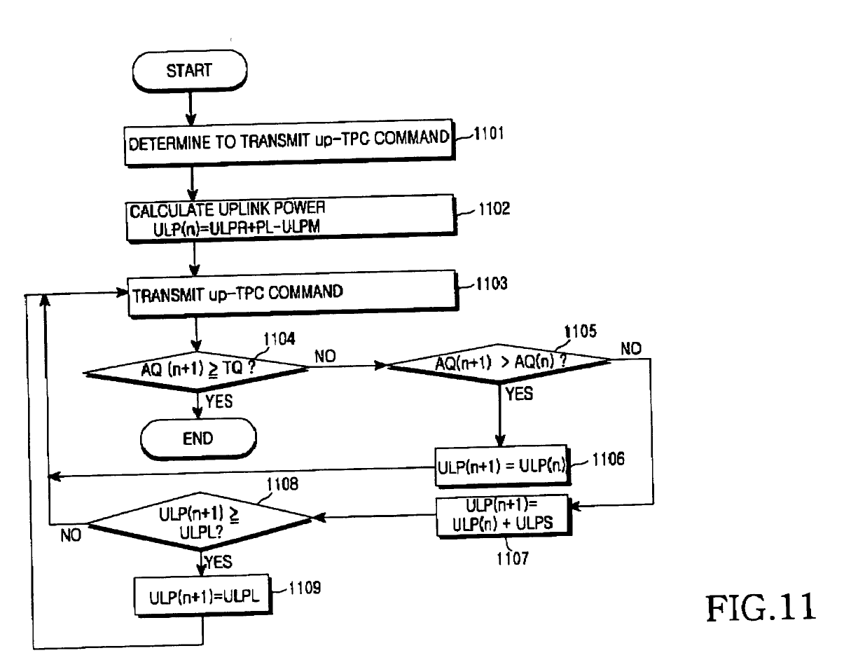

Next, a process of performing transmission power control on the PBMSCH using the CPCCH by the UE will be described with reference to FIG. 10.

FIG. 10 is a flow chart illustrating a downlink transmission power control process by a UE according to a first embodiment of the present invention. Referring to FIG. 10, in step 1001, a UE receives a PBMSCH signal from a Node B to which it belongs, upon detecting an MBMS service request, and then proceeds to step 1002. Here, upon detecting the MBMS service request, the UE sends an MBMS Service Request message to an RNC, and receives an MBMS Information message from the RNC according to the MBMS Service Request message. The MBMS Information message includes MBMS data reception-related information, such as OVSF code information for PBMSCH, or a physical channel over which MBMS data is transmitted or the MBMS data is to be transmitted, MCS level information, TQ (Target Quality) information of a requested MBMS service type, and information on CPCCH slot format. The target quality information can be given in the form of SIR (Signal to Interference Ratio) or FER (Frame Error Rate) for the corresponding PBMSCH. In the present invention, it will be assumed that the target quality information is received from the RNC. That is, the UE can receive the target quality information from the RNC through the MBMS Information message. Therefore, the RNC should have information on the target quality information of each MBMS service. Of course, an entity transmitting the target quality information may be differently defined by a service provider providing the MBMS service. After receiving the MBMS data reception-related information, the UE starts to receive the PBMSCH signal.

In step 1002, the UE receives the PBMSCH signal for the measurement period of the CPCCH corresponding to the PBMSCH and measures an actual quality (AQ) of the MBMS service over the PBMSCH, and then proceeds to step 1003. If the actual quality information of the MBMS service is expressed as SIR, measurement of the SIR can be performed as follows. That is, the UE can measure signal power by multiplying a signal received over the PBMSCH by an OVSF code used for the transmitted PBMSCH signal, and measure interference power (or power of an interference signal) by multiplying another channel having an orthogonal property with an OVSF code used for a signal received over the PBMSCH by an unused OVSF code. Alternatively, the UE measures signal power from the signal received over the PBMSCH and measures interference power from a CPICH signal, to calculate SIR. In step 1003, the UE determines whether the actual quality AQ of the MBMS service over the PBMSCH is equal to or higher than the target quality TQ received from the Node B. As a result of the determination, if the actual quality AQ of the MBMS service is equal to or greater than the target quality TQ received from the Node B, the UE ends the process without taking any measure on the downlink transmission power control for the CPCCH measurement period.

However, if the actual quality AQ of the MBMS service is less than the target quality TQ received from the Node B in step 1003, the UE proceeds to step 1004. In step 1004, the UE randomly selects one sub time slot from idle sub time slots among the sub time slots existing in the TPC command period of the CPCCH, and then proceeds to step 1005. When randomly selecting one sub time slot from idle sub time slots among the sub time slots existing in the TPC command period, the UE uses a function “uni” for randomly selecting one integer at the same probability. X is determined by the function “uni,” i.e., X=uni[1,N], where X represents a time slot for transmitting TPC information. In the function “uni,” N indicates the number of idle sub time slots among n sub time slots existing in the TPC command period. After determining a time slot for transmitting TPC information by the function “uni,” the UE generates in step 1005 an up-TPC command for the PBMSCH since the quality of the MBMS service is less than the target quality TQ, and transmits the generated up-TPC command for the PBMSCH to the Node B using the selected sub time slot, and then ends the process.

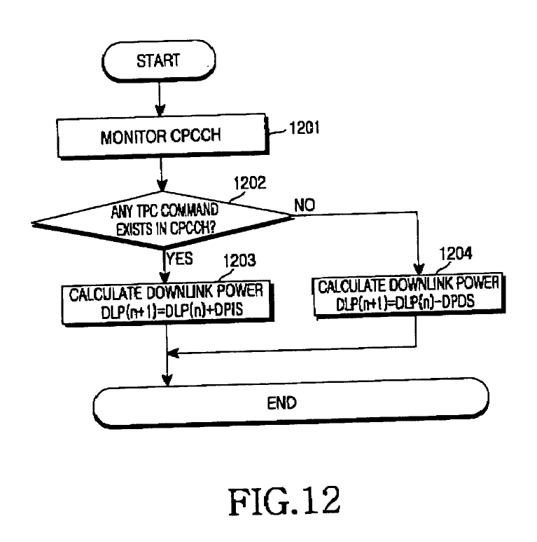

Next, a process of determining a transmission power control (TPC) value to be transmitted through the TPC command by the UE will be described with reference to FIG. 11.

FIG. 11 is a flow chart illustrating a process of determining an uplink transmission power value for controlling transmission power of PBMSCH by a UE according to a first embodiment of the present invention. Referring to FIG. 11, if the service quality of the MBMS received over the PBMSCH is lower than the target quality TQ, the UE determines in step 1101 an up-TPC command for the PBMSCH to increase transmission power of the PBMSCH in order to increase the service quality of the MBMS, and then proceeds to step 1102. In step 1102, the UE calculates uplink transmission power (ULP) for transmitting the TPC command, and then proceeds to step 1003. The uplink transmission power is calculated as follows. Here, the uplink transmission power becomes transmission power of the CPCCH for transmitting a TPC command for improving the service quality of the MBMS transmitted over the PBMSCH.

Before setting up a call for receiving an MBMS service, the UE receives an uplink power reference value (ULPR), an uplink power step size (ULPS) and an uplink power margin value (ULPM), broadcasted by a Node B as system information. After setting up a call for receiving the MBMS service, the UE measures a path loss (PL) of CPICH upon receiving a PBMSCH signal, and determines uplink transmission power control value in accordance with Equation (1).

ULP(n)=ULPR+PL−ULPM Equation (1)

In Equation (1), ULP(n) denotes uplink transmission power for an n^{th} period, and the uplink transmission power reference value ULPR is expressed in terms of dB, and represents transmission power of an uplink signal that the Node B desires to receive. Further, the uplink transmission power margin value ULPM is expressed in terms of dB, and is a constant for reducing the uplink transmission power. The path loss PL is expressed in terms of dB, and can be calculated from a measured power value of the CPICH.

In step 1103, the UE transmits the up-TPC command at the uplink transmission power calculated through Equation (1), and then proceeds to step 1104. In step 1104, the UE determines whether an actual quality, AQ(n+1), of an MBMS service received over PBMSCH for the next period, i.e., an (n+1)^{th} period is greater than or equal to the target quality TQ. As a result of the determination, if the actual quality AQ(n+1) of the MBMS service is greater than or equal to the target quality TQ, the UE ends the process. However, if the actual quality AQ(n+1) of the MBMS service is less than the target quality TQ, the UE proceeds to step 1105. That is, the UE determines in step 1104 whether the TPC command transmitted over the CPCCH by the UE is reflected in downlink transmission power control over the PBMSCH. In step 1105, the UE determines whether the actual quality, AQ(n+1), of the MBMS service for the (n+1)^{th} period is greater than the actual quality, AQ(n), for the n^{th} period. As a result of the determination, if the actual quality, AQ(n+1), of the MBMS service for the (n+1)^{th} period is greater than the actual quality, AQ(n), for the n^{th} period, the UE proceeds to step 1106. In step 1106, the UE sets the uplink transmission power for the (n+1)^{th} period to the uplink transmission power for the n^{th} period (ULP(n+1)=ULP(n)), and then returns to step 1103.

If, however, the actual quality, AQ(n+1), of the MBMS service for the (n+1)^{th} period is less than or equal to the actual quality, AQ(n), for the n^{th} period, the UE proceeds to step 1107. In step 1107, the UE sets the uplink transmission power for the (n+1)^{th} period to a value determined by adding the uplink transmission power step size to the uplink transmission power for the n^{th} period (ULP(n+1)=ULP(n)+ULPS), and then proceeds to step 1108. In step 1108, the UE determines whether the uplink transmission power, ULP(n+1), for the (n+1)^{th} period is greater than or equal to an uplink power limit value (ULPL). As a result of the determination, if the uplink transmission power for the (n+1)^{th} period is greater than or equal to an uplink transmission power limit value, the UE proceeds to step 1109. In step 1109, the UE sets the uplink transmission power for the (n+1)^{th} period to the uplink transmission power limit value (ULP(n+1)=ULPL), and then returns to step 1103. However, if the uplink transmission power for the (n+1)^{th} period is less than the uplink transmission power limit value in step 1108, the UE returns to step 1103.

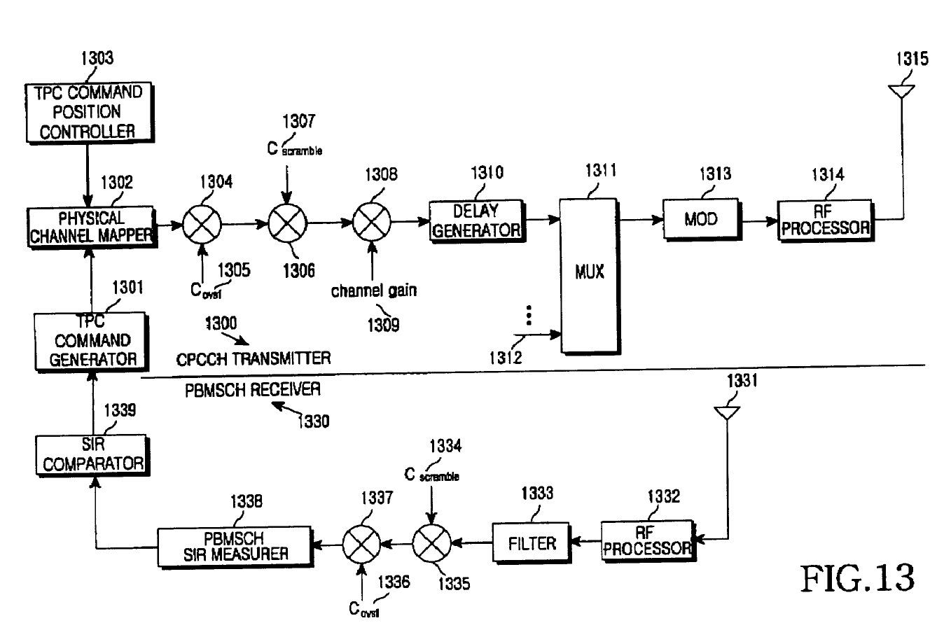

Next, a process of controlling transmission power of PBMSCH by receiving a CPCCH signal by a Node B will be described with reference to FIG. 12.

FIG. 12 is a flow chart illustrating a process of controlling transmission power of PBMSCH by a Node B according to a first embodiment of the present invention. Referring to FIG. 12, in step 1201, a Node B transmits a PBMSCH signal and at the same time, monitors a CPCCH signal transmitted in association with the PBMSCH signal, and then proceeds to step 1202. In step 1202, the Node B determines there is any signal transmitted over the sub time slots of the CPCCH. As a result of the determination, if there is a signal, or a TPC command transmitted over the sub time slots of the CPCCH, the Node B proceeds to step 1203. In step 1203, the Node B determines transmission power of the PBMSCH and transmits the PBMSCH signals at the determined transmission power, and then ends the process. Here, a detailed process of determining the transmission power of the PBMSCH will be described. A method for determining to increase the transmission power of the PBMSCH is divided into two methods. A first method is to previously determine a downlink power maximum value (DP_MAX) for allowing the PBMSCH to arrive at up to a cell radius of the Node B, and upon detecting the TPC command over the sub time slot of the CPCCH, to set transmission power of the PBMSCH to the downlink power maximum value DP_MAX beginning at a period following the period where the TPC command is received. A second method is to previously set a downlink power increasing step size (DPIS) for increasing the transmission power of the PBMSCH, and upon detecting the TPC command over the sub time slots of the CPCCH, to increase the transmission power of the PBMSCH by the downlink power increasing step size DPIS beginning at a period following the period where the TPC command is received. According to the first method of determining to increase the transmission power of the PBMSCH, the Node B sets in step 1203 the downlink transmission power of the PBMSCH to the downlink power maximum value DP_MAX and transmits the PBMSCH signal at the set downlink transmission power. According to the second method of determining to increase the transmission power of the PBMSCH, the Node B sets in step 1203 the downlink transmission power of the PBMSCH to a value determined by adding the downlink power increasing step size DPIS to the downlink transmission power of the PBMSCH for the previous period, and transmits the PBMSCH signal at the set downlink transmission power.

However, as a result of the determination in step 1202, if there is no signal, or no TPC command transmitted over the sub time slots of the CPCCH, the Node B proceeds to step 1204. In step 1204, the Node B determines downlink transmission power of the PBMSCH and transmits the PBMSCH signal at the determined downlink transmission power, and then ends the process. Here, if no TPC command is detected over the sub time slots of the CPCCH, the Node B decreases the downlink transmission power of the PBMSCH. A method of determining to decrease the transmission power of the PBMSCH is as follows. The Node B previously sets a downlink power decreasing step size (DPDS) for decreasing the transmission power of the PBMSCH, and upon failure to detect the TPC command over the sub time slots of the CPCCH, decreases the transmission power of the PBMSCH by the downlink power decreasing step size DPDS beginning at the next period. Accordingly, in step 1204, the Node B sets the downlink transmission power of the PBMSCH to a value determined by subtracting the downlink power decreasing step size DPDS from the downlink transmission power of the PBMSCH for the previous period, and transmits the PBMSCH signal at the set downlink transmission power.

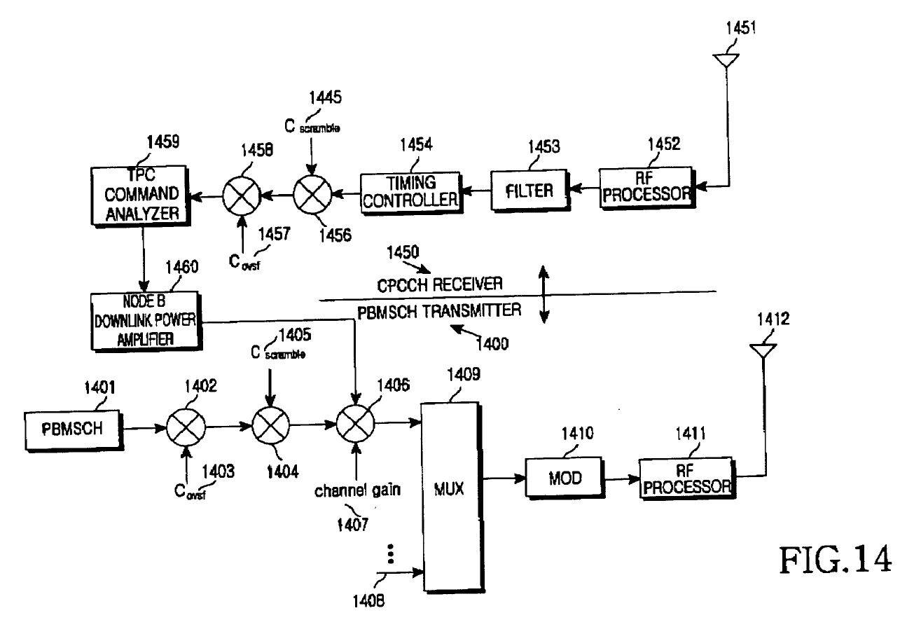

Next, a structure of a UE for receiving the PBMSCH signal and transmitting the CPCCH signal will be described with reference to FIG. 13.

FIG. 13 is a block diagram illustrating an internal structure of a UE according to a first embodiment of the present invention. Referring to FIG. 13, the UE is comprised of a CPCCH transmitter 1300 and a PBMSCH receiver 1330. First, the PBMSCH receiver 1330 will be described. An RF (Radio Frequency) signal received from the air through an antenna 1331 is provided to an RF processor 1332. The RF processor 1332 processes the RF signal provided from the antenna 1331, and provides the processed RF signal to a filter 1333. The filter 1333 band-pass filters a signal output from the RF processor 1332, and provides the band-pass filtered signal to a multiplier 1335. The multiplier 1335 multiplies a signal output from the filter 1333 by the same scrambling code C_{scramble} 1334 as a scrambling code used in a transmitter, or a Node B, for descrambling, and provides the descrambled signal to a multiplier 1337. Here, the multiplier 1335 serves as a descrambler. The multiplier 1337 multiplies a signal output from the multiplier 1335 by the same channelization code C_{OVSF} 1336 as a PBMSCH channelization code used in the Node B, and provides its output to a PBMSCH SIR measurer 1338. Here, an output signal of the multiplier 1337 becomes a PBMSCH signal.

The PBMSCH SIR measurer 1338 measures SIR of the PBMSCH signal output from the multiplier 1337, and provides the measured SIR to an SIR comparator 1339. Here, the PBMSCH SIR measurer 1338 measures SIR of the PBMSCH only for a period identical to a measurement period of the CPCCH, and the SIR of the PBMSCH becomes an actual quality AQ of the MBMS. In the first embodiment of the present invention, the SIR is used as the actual quality AQ of the MBMS. In this case, the SIR is measured as follows. That is, the first embodiment measures signal power by multiplying a signal received over the PBMSCH by an OVSF code used for the transmitted PBMSCH signal, and measures interference power by multiplying another channel having an orthogonal property with an OVSF code used for the signal received over the PBMSCH by an unused OVSF code. Alternatively, the first embodiment measures signal power from the signal received over the PBMSCH and measures interference power from a CPICH signal, thus to calculate SIR. The SIR comparator 1339 compares the measured SIR output from the PBMSCH SIR measurer 1338 with a target SIR SIR_{target}, and provides the comparison result to the CPCCH transmitter 1300. Here, the SIR_{target} becomes a target quality TQ of the MBMS.

Next, the CPCCH transmitter 1330 will be described. The comparison result output from the SIR comparator 1339 is applied to a TPC command generator 1301 in the CPCCH transmitter 1300. The TPC command generator 1301 analyzes the comparison result output from the SIR comparator 1339, i.e., analyzes the comparison result obtained by comparing the actual quality AQ of the MBMS with the target quality TQ of the MBMS, and if the actual quality AQ of the MBMS is less than the target quality TQ of the MBMS, the TPC command generator 1301 generates an up-TPC command (or “+1”) for the PBMSCH, and provides the generated up-TPC command to a physical channel mapper 1302. However, if the actual quality AQ of the MBMS is greater than or equal to the target quality TQ of the MBMS, the TPC command generator 1301 generates no TPC command.

The physical channel mapper 1302 inserts an up-TPC command output from the TPC command generator 1301 into a corresponding sub time slot of an actual physical channel (or CPCCH), performs channel mapping on the CPCCH, and provides the channel-mapped CPCCH to a multiplier 1304. Here, a position of the sub time slot where the up-TPC command is inserted is controlled by a TPC command position controller 1303. The TPC command position controller 1303, as described before, determines the position of the sub time slot using the function “uni,” or determines the position of the sub time slot according to signaling information from an upper layer. That is, the upper layer may provide a signal indicating the sub time slot position to the physical channel mapper 1302, or the TPC command position controller 1303 may calculate the sub time slot position and provide information on the calculated sub time slot position to the physical channel mapper 1302.

The multiplier 1304 multiplies a CPCCH signal output from the physical channel mapper 1302 by a channelization code C_{OVSF} 1305 set for the CPCCH, and provides its output to a multiplier 1306. The multiplier 1306 multiplies a signal output from the multiplier 1304 by a scrambling code C_{SCRAMBLE} 1307 set for the CPCCH, and provides its output to a multiplier 1308. Here, the scrambling code C_{SCRAMBLE} 1307 is previously agreed between the UE and the Node B. The multiplier 1308 multiplies a signal output from the multiplier 1306 by a channel gain 1309, and provides its output to a delay generator 1310. The delay generator 1310 delays a signal output from the multiplier 1308 such that the output signal should be matched to an actual transmission point, and provides the delayed signal to a multiplexer 1311. The multiplexer 1311 multiplexes a signal output from the delay generator 1310 with other channel signals 1312 transmitted by the UE, and provides the multiplexed signal to a modulator 1313. The modulator 1313 modulates a signal output from the multiplexer 1311 by a preset modulation technique, and provides the modulated signal to an RF processor 1314. The RF processor 1314 processes a signal output from the modulator 1313 and transmits the processed RF signal in the air through an antenna 1315.

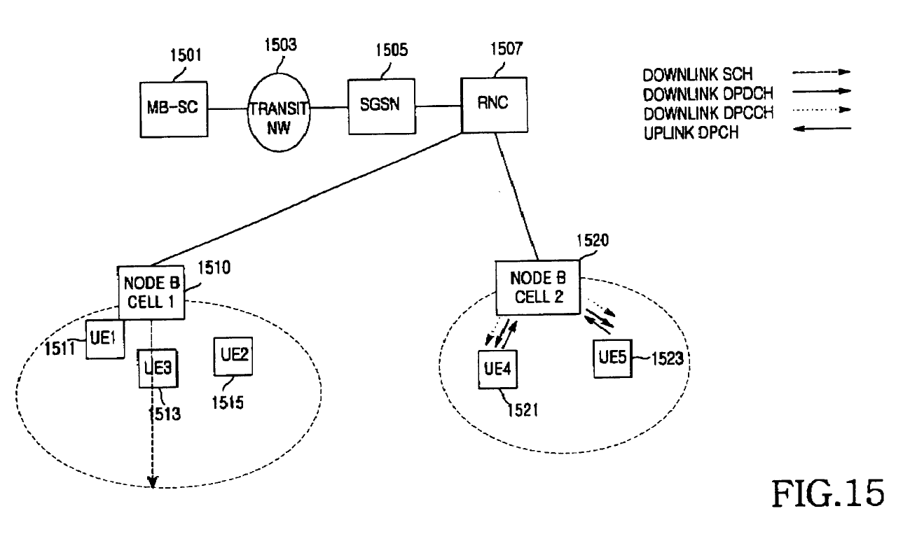

Next, a structure of a Node B for transmitting the PBMSCH signal and receiving the CPCCH signal will be described with reference to FIG. 14.

FIG. 14 is a block diagram illustrating an internal structure of a Node B according to a first embodiment of the present invention. Referring to FIG. 14, the Node B is comprised of a CPCCH receiver 1450 and a PBMSCH transmitter 1400. First, the CPCCH receiver 1450 will be described. An RF signal received from the air through an antenna 1451 is provided to an RF processor 1452. The RF processor 1452 processes the RF signal provided from the antenna 1451, and provides the processed RF signal to a filter 1453. The filter 1453 band-pass filters a signal output from the RF processor 1452, and provides the band-pass filtered signal to a timing controller 1454. The timing controller 1454 controls timing scheduled to descramble a signal output from the filter 1453 with a scrambling code C_{SCRAMBLE} 1455 set for CPCCH, and provides its output to a multiplier 1456. The multiplier 1456 multiplies a signal output from the timing controller 1454 by the scrambling code C_{SCRAMBLE} 1445, for descrambling, and provides the descrambled signal to a multiplier 1458. Here, the multiplier 1456 serves as a descrambler.

The multiplier 1458 multiplies the descrambled signal output from the multiplier 1456 by a CPCCH channelization code C_{OVSF} 1457 used in the UE, and provides its output to a TPC command analyzer 1459. Here, an output signal of the multiplier 1458 becomes a CPCCH signal. The TPC command analyzer 1459 analyzes the CPCCH signal output from the multiplier 1458 to determine whether the received CPCCH signal includes a TPC commands. As a result of the determination, if the CPCCH signal includes a TPC command, the TPC command analyzer 1459 provides a Node B power amplifier (PA) 1460 with a signal for increasing transmission power of the PBMSCH by a preset power increasing step size of the PBMSCH. However, if the CPCCH signal includes no TPC command, the TPC command analyzer 1459 provides the Node B power amplifier 1460 with a signal for decreasing transmission power of the PBMSCH by a preset power decreasing step size of the PBMSCH.

Meanwhile, a PBMSCH signal 1401 is applied to a multiplier 1402. The multiplier 1402 multiplies the PBMSCH signal 1401 by a channelization code C_{OVSF} 1403 set for the PBMSCH, and provides its output to a multiplier 1404. The multiplier 1404 multiplies a signal output from the multiplier 1402 by a scrambling code C_{SCRAMBLE} 1405 set for the PBMSCH, and provides its output to a multiplier 1406. Here, the scrambling code C_{SCRAMBLE} 1405 is previously agreed between the UE and the Node B. The multiplier 1406 multiplies a signal output from the multiplier 1404 by a channel gain 1407, and provides its output to a multiplexer 1409. Here, the multiplier 1406 amplifies the PBMSCH signal at a gain provided from the Node B power amplifier 1460. The multiplexer 1409 multiplexes a signal output from the multiplier 1406 with other channel signals 1408 transmitted by the Node B, and provides the multiplexed signal to a modulator 1410. The modulator 1410 modulates a signal output from the multiplexer 1409 by a preset modulation technique, and provides the modulated signal to an RF processor 1411. The RF processor 1411 processes a signal output from the modulator 1410, and transmits the processed RF signal in the air through an antenna 1412.

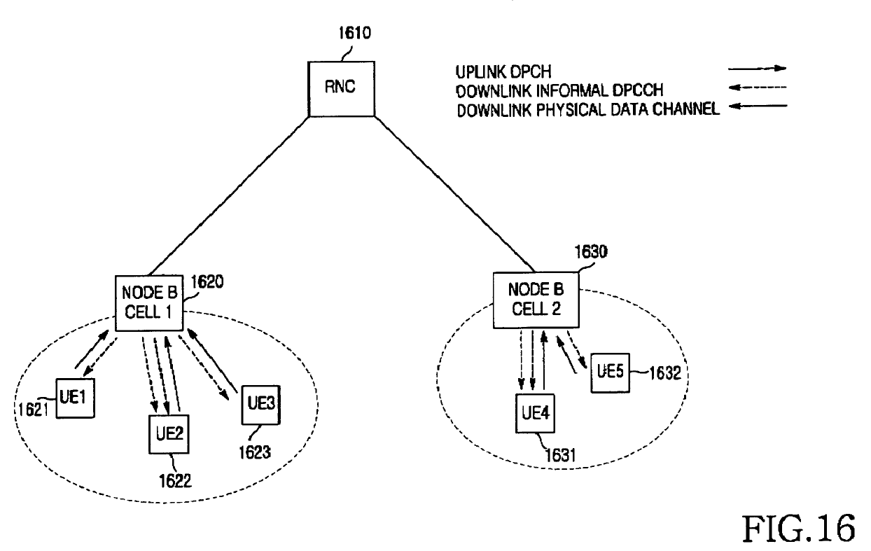

Meanwhile, since the MBMS service, as illustrated in FIG. 3, is generally provided through a shared channel, especially a broadcast channel, in order for all UEs existing in a cell region to be normally provided with the MBMS service, transmission power of the shared channel must be set such that the shared channel can arrive at all points in the cell region, especially up to a cell radius. Transmitting the shared channel at the transmission power set such that the MBMS data can arrive at all points in the cell region is advantageous when a plurality of UEs receiving the MBMS service exist in the cell region. However, when the UEs receiving the MBMS service existing in the cell region are small in number, although the UEs actually receiving the MBMS service are small in number, transmission power of the shared channel must be unnecessarily set high enough so that the MBMS data can arrive at up to the cell radius, causing a waste of transmission power. The waste of transmission power causes a reduction in efficiency of transmission resources. Now, a method of providing the MBMS service using a shared channel will be described with reference to FIG. 15.

FIG. 15 schematically illustrates a scheme for providing an MBMS service using a shared channel in a mobile communication system. Referring to FIG. 15, three UEs receiving an MBMS service, i.e., UE1 1511, UE2 1513 and UE3 1515 exist in a cell region (or a cell #1) of a Node B 1510, and two UEs receiving an MBMS service, i.e., UE1 1521 and UE2 1523 exist in a cell region (or a cell #2) of a Node B 1520. The UEs 1511, 1513, 1515, 1521 and 1523 existing in the cell #1 and cell #2 are located at a relatively short distance from the corresponding Node Bs. The Node B 1510 communicates with the UEs 1511, 1513 and 1515 using a downlink shared channel (SCH), and the Node B 1520 communicates with the UEs 1521 and 1523 using a downlink dedicated physical control channel (DPCCH), a downlink dedicated physical data channel (DPDCH) and an uplink dedicated physical channel (DPCH). The Node B 1510, as it communicates with the UEs 1511, 1513 and 1515 using the downlink shared channel, can save downlink channelization code resources, but it should increase transmission power of the downlink shared channel so that the downlink shared channel can arrive at up to a radius of the cell #1. However, the Node B 1520, as it communicates with the UEs 1521 and 1523 through the downlink DPCCH, the downlink DPDCH and the uplink DPCH, has the increased number of downlink channelization code resources to be assigned, but it is not required to increase transmission power of the downlink DPCCH and the downlink DPDCH so that the downlink DPCCH and the downlink DPDCH can arrive at up to a radius of the cell #2. That is, when providing an MBMS service using the shared channel, the Node B must control transmission power of the shared channel so that the shared channel can cover the entire cell region, but it can save downlink code resources. However, when providing an MBMS service using the dedicated channels, the Node B has the increased number of downlink code resources to be assigned to the dedicated channels, but it is not required to increase transmission power of the dedicated channels, thereby increasing efficiency of transmission power resources.

Therefore, an adaptive MBMS service method has been proposed. In the adaptive MBMS service method, when the number of UEs receiving an MBMS service within the same cell becomes greater than or equal to a preset number of order to solve the inefficiency problem of the channelization code resources and transmission power resources, the MBMS service is provided using a shared channel. However, when the number of UEs receiving the MBMS service is less than the preset number, the MBMS service is provided using dedicated channels. That is, in the service confirm message transmission step of FIG. 6, the RNC 307 determines the number of UEs receiving an MBMS service located in the cells managed by the RNC 307 itself, and the RNC 307 sets up a dedicated channel or a shared channel in step 605 according to the determined number of the UEs requesting the MBMS service, and provides the MBMS service through the configured channel. However, the proposed method of providing the MBMS service using dedicated channels disadvantageously reduces efficiency of channelization code resources. That is, the dedicated channel has a combined structure of a dedicated physical data channel (DPDCH) and a dedicated physical control channel (DPCCH), and the DPDCH and the DPCCH are assigned separate channelization code resources, so the MBMS service method using the dedicated channel brings about a reduction in efficiency of the channelization code resources.

Therefore, the present invention provides a method of providing an MBMS service using a dedicated channel (DCH). The method of providing an MBMS service using a dedicated channel will be described with reference to three different embodiments, the second to fourth embodiments.

First, a second embodiment of the present invention will be described. Before the second embodiment of the present invention is described, the RNC 307, as illustrated in conjunction with FIG. 6, determines in step 604 the number of UEs receiving an MBMS service existing in the cells managed by the RNC 307 itself. Herein, for the sake of convenience, a UE requesting the MBMS service will be referred to as “MBMS UE.” The RNC 307 determines the number of MBMS UEs, and assigns channel resources for providing the MBMS service depending on the determined number of MBMS UEs, as follows.

(1) If 1>N_UE_X>Threshold, a downlink shared channel (SCH) is assigned to MBMS UEs existing in a cell X. For the sake of convenience, this case will be referred to as “Case 1.”

(2) If 1<N_UE_X<Threshold, a downlink dedicated physical data channel (DPDCH), a downlink informal dedicated physical control channel (DPCCH) and an uplink dedicated physical channel (DPCH) are assigned to MBMS UEs existing in a cell X. For the sake of convenience, this case will be referred to as “Case 2.”

In the foregoing paragraph, “N_UE_X” denotes the number of MBMS UEs existing in a cell X, and “Threshold” denotes the number of MBMS UEs located in the cell X, to which a downlink shared channel can be assigned. Here, the Threshold is a parameter which can be varied according to a state of a specific cell, such as a size of the cell and the quantity of transmission resources available at a corresponding time. The Threshold value is applied when transition occurs from Case 1 to Case 2. The Threshold value is also applied when transition takes place from Case 2 to Case 1. That is, since the type of the channels for providing the MBMS service is changed according to the number of MBMS UEs existing in the same cell, the Threshold value is applied to both Case 1 and Case 2.

In the second embodiment of the present invention, in order to differently set the Threshold value for the transition from Case 1 to Case 2 and for the transition from Case 2 to Case 1, a Threshold value applied to the transition from Case 1 to Case 2 is defined as “Threshold_low” and a Threshold value applied to the transition from Case 2 to Case 1 is defined as “Threshold_high.” The reason for differently setting the Threshold value is because in the case where the Threshold value is set to a single value, if the number of MBMS UEs is changed at around the Threshold value, the radio channels for providing the MBMS service must be frequently reestablished.

Therefore, the second embodiment of present invention is not required to frequently reestablish radio channels due to a variation in number of the MBMS UEs at around the Threshold value, by setting the two Threshold values of Threshold_high and Threshold_low. For example, Threshold_high value is set to and Threshold_low value is set to 3. When N_UE_X is changed from a value below Threshold_high to a value over Threshold_low, Case 1 is applied, i.e., a downlink shared channel is set up. When N_UE_X is changed from a value over Threshold_low to a value below Threshold_low, Case 2 is applied, i.e., a downlink DPDCH, a downlink informal DPCCH and an uplink DPCH are set up. Here, the Threshold_high value should be set to an integer exceeding the Threshold_low value. Like the Threshold value, the Threshold_high value and the Threshold_low value are set according to a state of the corresponding cell. When the Threshold_high value and the Threshold_low value are applied, the channels are set up according to circumstances, as follows.

If N_UE_X<Threshold_high & (a channel for a corresponding MBMS service is not set up at a corresponding time point), then a downlink DPDCH, a downlink informal DPCCH and an uplink DPCH are set up to a cell X.

If N_UE_X≧Threshold high & (a channel for a corresponding MBMS service is not set up at a corresponding time point, or a downlink DPDCH, a downlink informal DPCCH and an uplink DPCH for a corresponding MBMS service are set up at a corresponding time point), then a downlink shared data channel is set up to a cell X.

If N_UE_X≦Threshold_high & (a downlink shared data channel for a corresponding MBMS service is set up at a corresponding time point), then a downlink DPDCH, a downlink informal DPCCH and an uplink DPCH are set up to a cell X.

If N_UE_X≧Threshold_high & (a downlink shared data channel for a corresponding MBMS service is set up at a corresponding time point), then the downlink shared data channel set up to a cell X is continuously used.

Meanwhile, it should be noted that the term “Threshold value” used in the second embodiment of the present invention refers to the Threshold_high value.

In addition, the downlink shared channel means a shared channel for providing the MBMS service, and since the downlink shared channel is directly related to the present invention, a detailed description thereof will not be provided. Channel newly proposed by the present invention include the downlink DPDCH and the downlink informal DPCCH. The downlink DPDCH and the downlink informal DPCCH have a structure of including MBMS data, control information shared by MBMS UEs in a cell, and individual control information with TPC command, dedicated to (or exclusively used by) each MBMS UE.

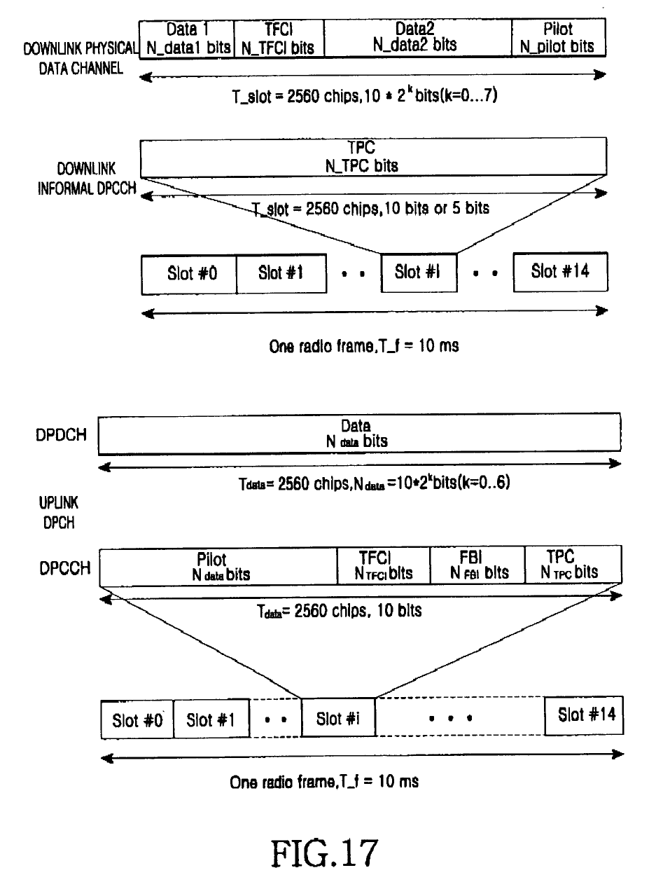

Now, a structure of a mobile communication system for dynamically assigning channel resources based on the number of the MBMS UEs will be described with reference to FIG. 16.

FIG. 16 schematically illustrates a network structure for dynamically assigning channel resources based on the number of MBMS UEs according to a second embodiment of the present invention.

Referring to FIG. 16, an RNC 1610 manages a cell #1 managed by a Node B 1620 and a cell #2 managed by a Node B 1630. In FIG. 16, three MBMS UEs UE1 1621, UE2 1622 and UE3 1623 exist in the Node B 1620, and two MBMS UEs UE4 1631 and UE5 1632 exist in the Node B 1630. The Node B 1620 assigns one downlink DPDCH, three downlink informal DPCCHs, and three uplink DPCHs, and the Node B 1630 assigns one downlink DPDCH, two downlink informal DPCCHs, and two uplink DPCHs. The Node B 1620 and the Node B 1630 each transmit MBMS data over the assigned downlink DPDCHs, and transmit TPC commands for the uplink DPCHs over the downlink informal DPCCHs. Upon receiving the downlink informal DPCCHs from the Node B 1620 and the Node B 1630, the UEs 1621, 1622, 1623, 1631 and 1632 detect TPC commands included in the received downlink informal DPCCHs and control transmission power of the corresponding uplink DPCHs according to the detected TPC commands. In addition, the UEs 1621, 1622, 1623, 1631 and 1632 control TPC commands for the downlink DPDCHs over the uplink DPCHs in order to control transmission power of the downlink DPDCHs.

Therefore, the second embodiment of the present invention maximizes efficiency of channelization code resources and transmission power resources by providing an exclusive MBMS service for separately controlling transmission power of each MBMS UE, while providing MBMS data by assigning a single downlink DPDCH to the MBMS UEs existing in the same cell. That is, there has been proposed a method of assigning as many downlink DPDCHs and downlink DPCCHs as the number of the MBMS UEs, instead of the downlink shared channel, when the number of MBMS UEs is smaller than a preset number. In this case, since the MBMS service is provided using the downlink DPDCHs and the downlink DPCCHs, it is possible to control transmission power more efficiently, compared with when the MBMS service is provided using a single shared channel.

More specifically, when the downlink transmission resources are classified into downlink transmission power resources and downlink channelization code resources, the downlink transmission power DTR_n_DCH required when dedicated channels (DCHs) are used for n MBMS UEs can be defined as

$$DTR\_n \_DCH = n * ( coderesource\_DLDPDCH + coderesource\_DLDPCCH ) + S U M ( Power\_DLDPDCH \_controlled \_n ) + S U M ( Power\_DLDPCCH \_controlled \_n ) \qquad Equation ( 2 )$$

In Equation (2), coderesource_DLDPDCH denotes channelization code resources needed for downlink (DL) DPDCHs set up to transmit a specific MBMS data stream, and coderesource_DLDPCCH denotes channelization code resource needed for downlink DPCCHs to transmit the specific MBMS data stream. Further, SUM(Power_DLDPDCH_controlled_n) denotes the sum of transmission power needed for transmission of the n downlink DPDCHs, and SUM(Power DLDPCCH_controlled n) denotes the sum of transmission power needed for transmission of the n downlink DPCCHs. In addition, it should be noted that Equation (2) is a formula generalized to indicate a relationship between the downlink DPCCHs and DPDCHs and the actual downlink transmission resources, instead of indicating correct mathematical numerical values.

On the contrary, the downlink transmission resources DTR_n_SCH required when a downlink shared channel (SCH) is assigned to n MBMS UEs to provide an MBMS service, can be defined as

DTR_{—}n_{—}SCH=coderesource_{—}SCH+Power_uncontrolled Equation (3)

In Equation (3), coderesource_SCH denotes channelization a code resource assigned to a downlink shared channel set up to transmit a specific MBMS data stream, and it has almost the same meaning as the coderesource_DLDPDCH. Further, Power_uncontrolled denotes transmission power of the downlink shared channel, and it generally indicates transmission power which is high enough to allow the downlink shared channel to arrive at up to a cell radius. A comparison will be made between the downlink transmission resource DTR_n_DCH for the downlink dedicated channel and the downlink transmission resource DTR_n_SCH for the downlink shared channel. The downlink shared channel uses a relatively small quantity of channelization code resources, but it needs transmission power high enough to allow the MBMS data stream to arrive at up to a cell radius. In contrast, the downlink dedicated channel uses a relatively large quantity of channelization code resources, but it can separately control transmission power of the MBMS UEs. In other words, the Threshold value can be set to a value M where it is expected that Power_uncontrolled will be much higher than the sum of SUM(Power_DLDPDCH_controlled_n) and SUM(Power_DLDPCCH_controlled_n).

The second embodiment of the present invention shares a channel (or downlink DPDCH) for actually transmitting an MBMS data stream, assigns as many downlink informal DPCCHs as the number of MBMS UEs, and controls transmission power of the downlink DPDCHs through an uplink DPCH. Therefore, downlink transmission resources DTR_n_SDCH required in the second embodiment of the present invention can be defined as

$$DTR\_n \_SDCH = coderesource\_DLDPDCH + n * coderesource\_DLDPCCH + Power\_DLDPDCHcontrolled \_worstcaseUE + S U M ( Power\_DLDPCCHcontrolled \_n ) \qquad Equation ( 4 )$$

In Equation (4), Power_DLDPDCHcontrolled_worstcaseUE denotes transmission power of an MBMS UE having the worst radio link with a cell among the MBMS UEs. The Power_DLDPDCHcontrolled_worstcaseUE can be rewritten as

Power_DLDPDCHcontrolled_worstcaseUE=MAX[Power_DLDPDCHcontrolled_{—1˜Power}_DLDPDCHcontrolled_{—}n] Equation (5)

In Equation (5), MAX[Power_DLDPDCHcontrolled_{—1 Power}_DLDPDCHcontrolled_n] denotes the maximum transmission power among transmission power of the downlink DPDCHs.

Now, a description will be made as to a quantity of downlink transmission resources used for each of the above-stated three methods: (i) a method of providing an MBMS service using a downlink DPDCH and a downlink DPCCH, (ii) a method of providing an MBMS service using a downlink shared channel, and (iii) a method of providing an MBMS service using one downlink DPDCH, downlink informal DPCCHs and uplink DCH. For example, it will be assumed that three MBMS UEs of UE A, UE B and UE C exist in a cell X. Further, it will be assumed that SF=16 code channel resources are used for the MBMS service, and the minimum transmission power values required by the UE A, UE B and UE C to receive the MBMS service are 10 dB, 20 dB and 30 dB, respectively. In addition, it will be assumed that transmission power applied to the downlink shared channel providing the MBMS service is 100 dB.

First, when the MBMS service is provided using the downlink DPDCH and the downlink DPCCH, a required quantity of downlink transmission resources becomes three SF=16 code channels and transmission power of 60 dB (=10 dB+20 dB+30 dB). Here, since the downlink DPCCH is a relatively low-speed channel, it consumes negligible transmission power compared with the downlink DPDCH. Therefore, transmission power of the downlink DPCCH is not taken into consideration. Second, when the MBMS service is provided using the downlink shared channel, a required quantity of downlink transmission resources becomes one SF=16 code channel and transmission power of 100 dB. Third, when the MBMS service is provided using the downlink DPDCH, the downlink informal DPCCH and the uplink DPCH according to the present invention, a required quantity of downlink transmission resources becomes one SF=16 code channel to be used as the downlink DPDCH, three SF=512 code channels to be used as the downlink informal DPCCHs, and transmission power 30 dB of an MBMS UE, e.g., the UE C having the worst radio link.

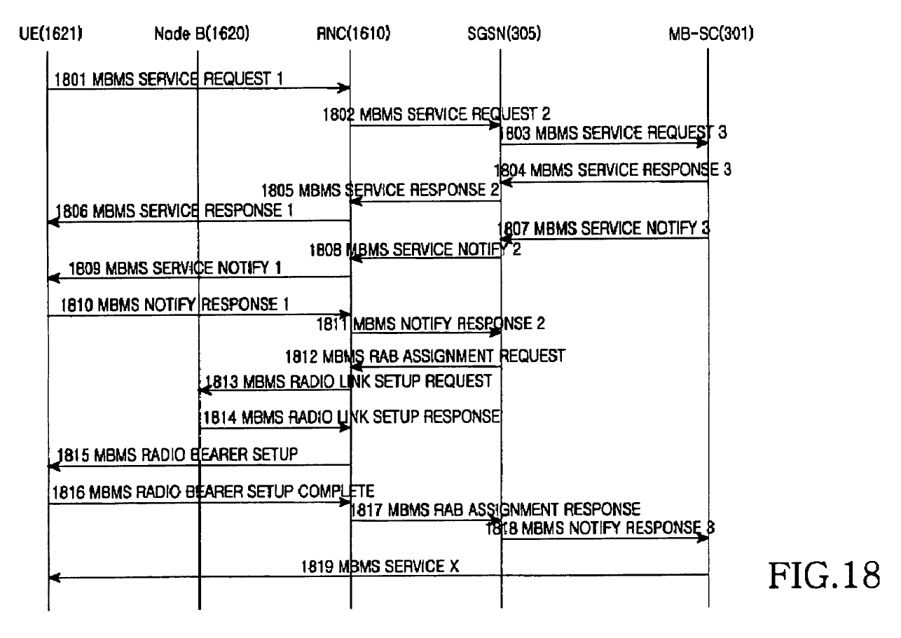

Now, structures of the downlink DPDCH, the downlink informal DPCCH and the uplink DPCH proposed in the second embodiment of the present invention will be described with reference to FIG. 17.

FIG. 17 schematically illustrate structures of a downlink DPDCH, a downlink informal DPCCH and an uplink DPCH according to a second embodiment of the present invention. Referring to FIG. 17, in a general UMTS communication system, a radio frame has a transmission time of 10 ms and is comprised of 15 time slots Slot#0Slot#14. Each of the time slots is comprised of 2,560 chips, and an amount of data that can be transmitted over each time slot is variable according to the SF used for the channel. For example, in the downlink, if k=0 is matched to SF=512, k=1 to SF=256, k=2 to SF=128, k=3 to SF=64, k=4 to SF=32, k=5 to SF=16, k=6 to SF=8, and k=7 to SF=4, then an amount of data transmitted over one time slot becomes 10*2^{k} bits. On the contrary, if k=0 is matched to SF=256, k=1 to SF=128, k=2 to SF=64, k=3 to SF=32, k=4 to SF=16, k=5 to SF=8, and k=6 to SF=4, then an amount of data transmitted over one time slot also becomes 10*2^{k} bits.

Generally, in the UMTS communication system, one radio frame of the uplink DPCH is also comprised of 15 time slots. Each of the time slots is comprise of DPDCH for transmitting data from an upper layer transmitted from a Node B to a UE, and DPCCH including (i) TPC bits, or a physical layer control signal for controlling transmission power of the UE, (ii) TFCI (Transport Format Combination Indicator) bits, and (iii) Pilot symbol. In addition, the downlink DPDCH has a slot format of transmitting Data1 symbol and Data2 symbol for transmitting data from an upper layer, and the downlink DPCCH has a slot format of transmitting TPC symbol for transmitting the TPC bits, TFCI symbol for transmitting the TFCI bits, and Pilot symbol. Here, the TPC symbol transmit information for controlling transmission power of a UE, transmitted from the Node B to the UE, and the TFCI symbol indicate TFC (Transport Format Combination) in which a downlink channel is transmitted for a currently transmitted 10 ms frame. Further, the Pilot symbol indicates a criterion, based on which the UE controls transmission power of the DPCH. In the slot format of the DPCH, a size of each field for transmitting the symbols is previously determined according to SF, transmission of the TFCI and application of a compressed mode. For example, if the TFCI field is not used at SF=256 and the compressed mode is used, the slot format has a 2-bit Data1 field, a 14-bit Data2 field, a 2-bit TPC field, a 0-bit TFCI field, and a 2-bit Pilot field. At present, in the UMTS communication system, 49 slot formats of #0 to #16A are defined.

The second embodiment of the present invention proposes a new channel structure for providing an MBMS service by transmitting only a TPC symbol used in a downlink DPCH slot format of the general UMTS communication system through a separate code channel, i.e., a downlink informal DPCCH, and transmitting Data1 symbol, TFCI symbol, Data2 symbol and Pilot symbol, except the TPC symbol, in the downlink DPCH slot format through a separate code channel, i.e., a downlink DPDCH. This is because since the MBMS data stream is transmitted to a plurality of MBMS UEs, it is preferable to transmit a TPC symbol that must be transmitted to each MBMS UE, over the downlink DPDCH. That is, in the present invention, information that can be shared by a plurality of MBMS UEs receiving the same MBMS data stream is transmitted over the downlink DPDCH, and information exclusively used by each MBMS UE, or information that is not required to be shared by the MBMS UEs is transmitted over the downlink informal DPCCH. That is, the Data1 symbol, the Data2 symbol, the TFCI symbol and the Pilot symbol are information that can be shared by a plurality of MBMS UEs, and the TPC symbol is information that must be exclusively transmitted to each of the MBMS UEs. In conclusion, the downlink DPDCH proposed by the present invention includes Data1 field, TFCI field, Data2 field and Pilot field. The MBMS data stream is actually transmitted over the Data1 field and the Data2 field, and information needed by a physical layer to process the MBMS data stream, such as channel coding information applied to the MBMS data stream, a size of CRC (Cyclic Redundancy Check) bits, or an amount of the MBMS data stream transmitted, is transmitted over the TFCI field. Further, Pilot bits, a criterion based on which MBMS UEs receiving a downlink DPDCH signal can measure the channel quality, is transmitted over the Pilot field. Here, a size of each field in the downlink DPDCH can be properly determined according to an SF value and necessity of the TFCI field, and an example of this is illustrated in Table 2. Since 49 slot formats of #0 to #16A have already been defined in the general UMTS communication system, the present invention will newly define 11 slot formats of #17 to #24 for the downlink DPDCH.

TABLE 2

| Slot | | | | | | |
|---|---|---|---|---|---|---|
| Format | | Bits/ | Bits/Slot | | | |
| # | SF | Slot | N_{Data1} | N_{Data2} | N_{TFCI} | N_{Pilot} |
| 17 | 512 | 10 | 0 | 6 | 0 | 4 |
| 17A | 512 | 10 | 0 | 4 | 2 | 4 |
| 18 | 256 | 20 | 2 | 16 | 0 | 2 |
| 18A | 256 | 20 | 2 | 14 | 2 | 2 |
| 19 | 128 | 40 | 6 | 30 | 0 | 4 |
| 19A | 128 | 40 | 6 | 28 | 2 | 4 |
| 20 | 64 | 80 | 12 | 52 | 8 | 8 |
| 21 | 32 | 160 | 28 | 116 | 8 | 8 |
| 22 | 16 | 320 | 56 | 240 | 8 | 16 |
| 23 | 8 | 640 | 120 | 496 | 8 | 16 |
| 24 | 4 | 1280 | 248 | 1008 | 8 | 16 |

It should be noted that the slot formats illustrated in Table 2 can be subject to a change according to circumstances.

Next, a downlink informal DPCCH will be described. As stated above, the downlink informal DPCCH transmits only TPC commands for controlling transmission power of each of the MBMS UEs. Of course, the downlink informal DPCCH may transmit new information, if necessary. A TPC field of the downlink informal DPCCH has 10 bits for SF=512, and 5 bits for SF=1024. The TPC symbol is binary information, and is used to increase or decrease transmission power of an uplink DPCH. In addition, an SF value to be applied to the downlink informal DPCCH is variable according to circumstances. For example, if SF of the downlink DPDCH is 32, SF of the downlink informal DPCCH is set to 512. Further, if SF of the downlink DPDCH is 64, SF of the downlink informal DPCCH is set to 1024.

Next, the uplink DPCH will be described. The uplink DPCH is comprised of an uplink DPDCH and an uplink DPCCH. The uplink DPDCH transmits uplink data, and the uplink DPCCH transmits uplink control information. Here, the uplink control information includes a channel coding type applied to the uplink data, TFCI indicating an amount of transmission data, Pilot used to measure the quality of the uplink channel, feedback information (FBI) used for transmission diversity, and TPC command for controlling downlink transmission power. A size of each field in the uplink DPCH is previously defined in the slot format, like that of the downlink DPDCH and the downlink informal DPCCH. In the present invention, the existing uplink DPCH slot format of the general UMTS communication system will be used.

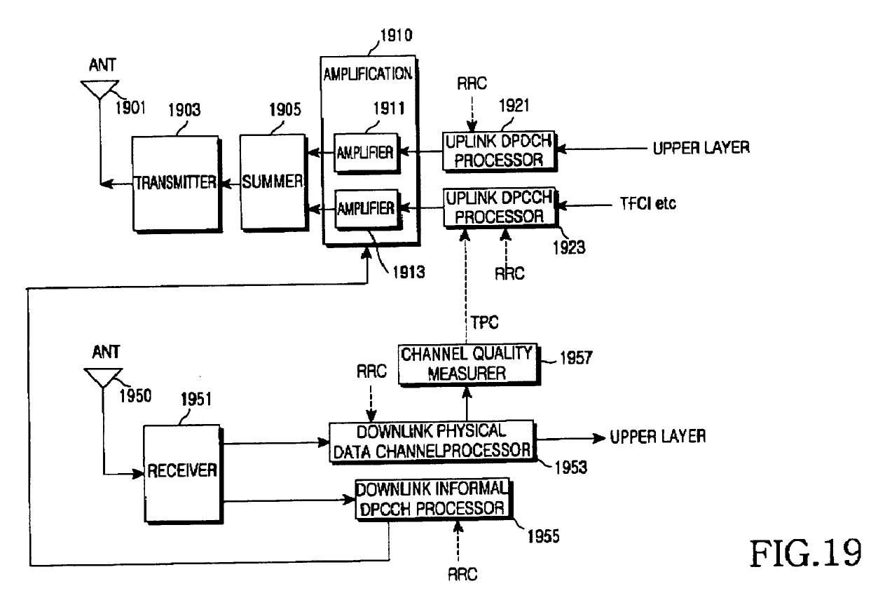

Now, a process of providing an MBMS service according to a second embodiment of the present invention will be described with reference to FIG. 18.

FIG. 18 is a flow diagram illustrating a process of providing an MBMS service in a mobile communication system according to a second embodiment of the present invention. Before a description of FIG. 18, it will be assumed that a mobile communication system for providing the MBMS service is identical in structure to the mobile communication system of FIG. 16. Although MB-SC and SGSN are not illustrated in FIG. 16, it should be noted that the RNC 1610 is connected to the MB-SC and the SGSN as illustrated in FIG. 3. Therefore, in the following description, the SGSN and the MB-SC will have the same reference numerals as the reference numerals used in FIG. 3. Prior to a description of FIG. 18, reference will be made to an RNC Service Context managed by the RNC and an SGSN Service Context managed by the SGSN. The RNC and the SGSN independently manage service-related information for each MBMS service, and the service-related information managed for each MBMS service is referred to as “Service Context.” The service-related information managed for each MBMS service includes UE identifiers of UEs desiring to receive the MBMS service (i.e., a list of UEs desiring to receive the MBMS service), a service area where the UEs are located, and QoS (Quality of Service) needed to provide the MBMS service.

A detailed description of the information included in the RNC Service Context and the SGSN Service Context will be described herein below.

First, the information included in the RNC Service Context is as follows.

$$RNC Service Context = \{ MB \text{-} SC Service ID , RNC Service ID , ID of a cell to receive or receiving an MBMS service ( IDs of UEs located in a corresponding cell ) , QoS needed to provide the MBMS service \}$$

As stated above, one RNC Service Context is comprised of one Service ID, a plurality of cell IDs, and a plurality of UE IDs. In addition, the Service ID includes an MB-SC Service ID and an RNC Service ID. The MB-SC Service ID is a unique ID assigned to the MBMS service provided by the MB-SC, and the RNC Service ID is a unique ID assigned to the MBMS service by the RNC. Here, the RNC Service ID is recognized by only the UE and the RNC, and can be assigned to recognize a service more efficiently in a transmission path between the RNC and the UE, including a radio channel, i.e., a radio bearer. The RNC manages and updates the RNC Service Context for a specific MBMS service, and if the specific MBMS service is actually provided later on, the RNC transmits the MBMS data stream to a proper cell by consulting the RNC Service Context.

Second, the information included in the SGSN Service Context is as follows.

$$SGSN Service Context = \{ MB \text{-} SC Service ID , SGSN Service ID , ID of an RNC to receive or receiving an MBMS service ( IDs of UEs located in a corresponding RNC ) , QoS needed to provide the MBMS service \}$$

In the SGSN Service Context the SGSN Service ID is an ID assigned by the SGSN, and is used to efficiently recognize an MBMS service between a UE and the SGSN. Further, in the SGSN Service Context, an ID of the RNC can be replaced with other information. For example, several RNCs are previously set to one service area, and then, the RNC ID can be substituted for a service area ID associated with the service area.

Further, the RNC Service Context and the SGSN Service Context are continuously updated in a following process of providing an MBMS service. The RNC and the SGSN use the RNC Service Context and the SGSN Service Context in determining a cell (or a Node B) and an RNC, to which an MBMS data stream is to be transmitted, and determining UEs receiving the MBMS service. Now, a process of actually providing an MBMS service will be described with reference to FIG. 18.

First, a UE 1621 transmits a first MBMS Service Request message to an RNC 1610 in order to request an MBMS service X (Step 1801). Here, the first MBMS Service Request message includes an MB-SC Service ID (or a Service ID designating an MBMS service that the UE 1621 desires to receive), and a user ID (or UE ID) indicating a UE that transmits the first MBMS Service Request message. Upon receiving the first MBMS Service Request message, the RNC 1610 updates a formed RNC Service Context, i.e., adds a user ID of the UE 1621 to recipient-related information in the formed RNC Service Context and adds a cell ID of a cell (or a Node B 1620) to which the UE 1621 belongs, to service area-related information in the formed RNC Service Context, and then transmits a second MBMS Service Request message to an SGSN 305 in order to request the MBMS service X (Step 1802). The RNC Service ID can be generated and updated either when the first MBMS Service Request message is received (Step 1801), or when a second MBMS Service Response message is received (Step 1805). Herein, although the RNC 1610 updates the RNC Service Context, if the requested MBMS service X is a new MBMS service, the RNC 1610 forms a new RNC Service Context for the MBMS service X and manages the information in the newly formed RNC Service Context. The second MBMS Service Request message includes an MB-SC Service ID designating an MBMS service that the UE 1621 desires to receive, and a user ID of the UE 1621 that transmits the second MBMS Service Request message. That is, in the case where there is a new UE currently desiring to receive an MBMS service, if there was an old UE that desired to receive the MBMS service, control information is transmitted using the same RNC Service ID in order to transmit control information on a radio link when performing the MBMS service later. If a service requested by the UE desiring to receive the MBMS service is a new service, an RNC Service ID for a new MBMS service is generated and managed. Here, the RNC Service ID can be sequentially generated according to the service type, or can be efficiently assigned and managed according to a given formula. More specifically, in generating or updating the RNC Service ID, the RNC updates or adds the RNC Service Context when it received the first MBMS Service Request message from the UE, and if it is determined that a new RNC Service ID is needed, the RNC may generate the RNC Service ID when it received the second MBMS Service Response message, or generate the RNC Service ID when it received the second MBMS Service Request message. Since this is a matter of realization, the method of generating and updating the RNC service ID is open to modification.

Upon receiving the second MBMS Service Request message from the RNC 1610, the SGSN 305 updates a formed SGSN Service Context, i.e., adds a user ID of the UE 1621 to recipient-related information in the formed SGSN Service Context and adds an ID of the RNC 1610 to which the UE 1621 belongs, to service area-related information in the formed SGSN Service Context, and then transmits a third MBMS Service Request message to an MB-SC 301 in order to request the MBMS service X (Step 1803). Herein, although the SGSN 305 updates the SGSN Service Context, if the requested MBMS service X is a new MBMS service, the SGSN 305 forms a new SGSN Service Context for the MBMS service X and manages the information in the newly formed SGSN Service Context. The third MBMS Service Request message includes an MB-SC Service ID. Upon receiving the third MBMS Service Request message from the SGSN 305, the MB-SC 301 adds the SGSN 305 that transmitted the third MBMS Service Request message, to a list for providing the MBMS service X, and transmits to the SGSN 305 a third MBMS Service Response message indicating correct receipt of the third MBMS Service Request message (Step 1804). Here, the third MBMS Service Response message includes an MB-SC Service ID.

Upon receiving the third MBMS Service Response message from the MB-SC 301, the SGSN 305 performs updating by adding a Service ID for the MBMS service X, i.e., SGSN Service ID to Service ID-related information in the SGSN Service Context, and transmits to the RNC 1610 the second MBMS Service Response message indicating correct receipt of the third MBMS Service Request message (Step 1805). Here, the SGSN 305, as it receives the third MBMS Service Request message, assigns the SGSN Service ID, which is managed by the SGSN 305 in association with the MBMS service X. Upon receiving the second MBMS Service Response message, the RNC 1610 assigns an RNC Service ID, performs updating by adding the assigned RNC Service ID to Service ID-related information in the RNC Service Context, and transmits to the UE 1621 a first MBMS Service Response message indicating correct receipt of the second MBMS Service Request message (Step 1806). Here, the RNC can transmit the RNC Service ID information to the UE along with the MBMS Service Response message, or transmit the RNC Service ID information while transmitting an MBMS Radio Bearer Setup message during MBMS Radio Bearer Setup, as described below. However, since the time when the MBMS service is provided is different, it is preferable to transmit the RNC Service ID when actually setting up a radio bearer. Here, the RNC 1610, as it receives the second MBMS Service Response message, assigns an RNC Service ID, which is managed by the RNC 1610 in association with the MBMS service X. The first MBMS Service Response message includes MB-SC Service ID, SGSN Service ID, and RNC Service ID. Upon receiving the first MBMS Service Response message, the UE 1621 stores the SGSN Service ID and the RNC Service ID, and awaits a next operation.

Meanwhile, the MB-SC 301 transmits to the SGSN 305 a third MBMS Service Notify message for notifying the SGSN 305 that the MBMS service X will be started in the near future and determining a list of UEs (or IDs of UEs) desiring to actually receive the MBMS service X (Step 1807). The third MBMS Service Notify message includes an MB-SC Service ID, a service start time when the MBMS Service X is actually started, and QoS-related information. Upon receiving the third MBMS Service Notify message, the SGSN 305 sets up a radio bearer for providing the MBMS service X on a transmission network 303, sets up lu connection for the MBMS service X, updates QoS-related information and lu connection-related information among service area-related information in the SGSN Service Context, notifies that the MBMS service X will be started in the near future, and then transmits to the RNC 1610 a second MBMS Service Notify message for determining a list of UEs desiring to actually receive the MBMS service X (Step 1808). The second MBMS Service Notify message includes MB-SC Service ID, SGSN Service ID, service start time, and QoS-related information. Upon receiving the second MBMS Service Notify message, the RNC 1610 determines UE IDs existing in its RNC Service Context and a cell to which the UEs belong, and transmits to the UE 1621 a first MBMS Service Notify message notifying that the MBMS service X will be started in the near future (Step 1809). The first MBMS Service Notify message includes MB-SC Service ID, RNC Service ID, service start time, and QoS-related information.

Upon receiving the first MBMS Service Notify message, the UE 1621 determines whether to actually receive the MBMS service X, stores the received QoS-related information, and transmits to the RNC 1610 a first MBMS Notify Response message indicting correct receipt of the first MBMS Service Notify message (Step 1810). The first MBMS Notify Response message includes RNC Service ID and UE ID. Upon receiving the first MBMS Notify Response message, the RNC 1610 performs updating by adding an ID of a UE that transmitted the first MBMS Notify Response message and an ID of a cell to which the UE belongs, to its RNC Service Context, and transmits to the SGSN 305 a second MBMS Notify Response message indicating correct receipt of the second MBMS Service Notify message (Step 1811). It is assumed in step 1810 that the RNC 1610 receives the first MBMS Notify Response message from only the UE 1621. However, the RNC 1610 may receive the first MBMS Notify Response message from a plurality of UEs. In this case, the RNC 1610 updates the RNC Service Context by adding IDs of the respective UEs and IDs of cells to which the UEs belong, to the RNC Service Context.

Meanwhile, the second MBMS Notify Response message includes MB-SC Service ID and UE ID. Upon receiving the second MBMS Notify Response message, the SGSN 305 performs updating by adding UE IDs included in the second MBMS Notify Response message and an RNC ID to its SGSN Service Context. Further, the SGSN 305 transmits to the RNC 1610 an RAB (Radio Access Bearer) Assignment Request message for setting up a radio access bearer (RAB), a transmission path for transmitting a data stream for the MBMS service X to the RNC 1610 that transmitted the second MBMS Notify Response message (Step 1812). The RAB Assignment Request message includes MB-SC Service ID and QoS information. Upon receiving the RAB Assignment Request message, the RNC 1610 determines a cell and a UE, IDs of which are included in its RNC Service Context, prepares to set up a radio link to the cell, or the Node B 1620 according to the received QoS information, and transmits information on the RNC Service ID, thereby collectively transmitting, through the RNC Service ID, radio link information that was conventionally separately transmitted to each UE. At this point, the RNC 1610 examines the number of UEs belonging to the cells, i.e., the number of MBMS UEs stored in the RNC Service Context, thereby to determine whether to set up radio bearers of the corresponding cells as a downlink shared channel or set up the radio bearers as downlink DPDCHs, downlink informal DPCCHs for the MBMS UEs, and uplink DPCHs. That is, as described before, if the number of MBMS UEs existing in the same cell exceeds a Threshold value, the downlink shared channel is set up. However, if the number of MBMS UEs existing in the same cell is less than the Threshold value, the downlink DPDCHs, the downlink informal DPCCHs for the MBMS UEs, and the uplink DPCHs are set up. In the following description, it will be assumed that the number of MBMS UEs existing in the Node B 1620 is greater than or equal to the Threshold value. As a result, the RNC 1610 assigns downlink DPDCHs, downlink informal DPCCHs and uplink DPCHs to the UE 1621.

The RNC 1610 transmits to the Node B 1620 an MBMS Radio Link Setup Request message in order to set up a radio link for transmitting a data stream for the MBMS service X (Step 1813). The MBMS Radio Link Setup Request message includes channelization code information, scrambling code information, slot format number information, and channel coding information to be applied to a downlink DPDCH for transmitting the data stream for the MBMS service X. Further, the MBMS Radio Link Setup Request message includes channelization code information, scrambling code information and channel coding information to be applied to a downlink informal DPCCH. In addition, the MBMS Radio Link Setup Request message includes channelization code information, scrambling code information, TPC-related information, and channel coding information to be applied to an uplink DPCH. Here, the TPC-related information includes channel quality-related information to be applied to an uplink DPCH, and step size information to be used for a downlink DPDCH and a downlink informal DPCCH. The above information will be described later. Upon receiving the MBMS Radio Link Setup Request message, the Node B 1620 sets up a downlink DPDCH and a downlink informal DPCCH using the channelization code information and the scrambling code information included in the MBMS Radio Link Setup Request message, completes preparing to receive an uplink DPCH, and transmits to the RNC 1610 an MBMS Radio Link Setup Response message indicating that the radio link is set up (Step 1814).

Upon receiving the MBMS Radio Link Setup Response message, the RNC 1610 transmits an MBMS Radio Bearer Setup message for setting a radio bearer to an MBMS UE, or the UE 1621 located in a cell of the Node B 1620 that transmitted the MBMS Radio Link Setup Response message (Step 1815). The MBMS Radio Bearer Setup message includes channelization code information for the downlink DPDCH, scrambling code information for the downlink DPDCH, slot format number information, channelization code information for the downlink informal DPCCH, scrambling code information for the downlink informal DPCCH, channelization code information for the uplink DPCH, and scrambling code information for the uplink DPCH. Further, the MBMS Radio Bearer Setup message may include channel quality-related information to be applied to the downlink DPDCH and the downlink informal DPCCH, and step size information to be applied to the uplink DPCH. Upon receiving the MBMS Radio Bearer Setup message, the UE 1621 prepares to receive a downlink DPDCH and a downlink informal DPCCH using the information included in the received MBMS Radio Bearer Setup message, and after completion of the preparation, transmits to the RNC 1610 an MBMS Radio Bearer Setup Complete message indicating completed setup of a radio bearer (Step 1816). The MBMS Radio Bearer Setup Complete message includes MBMS Service ID and user ID. Upon receiving the MBMS Radio Bearer Setup Complete message, the RNC 1610 performs updating by adding an ID of the UE 1621 that transmitted the MBMS Radio Bearer Setup Complete message, to its RNC Service Context, and transmits to the SGSN 305 an MBMS RAB Assignment Response message indicating completed setup of a radio bearer for the MBMS service X (Step 1817). The MBMS RAB Assignment Response message includes MBMS Service ID and a plurality of UE IDs. Upon receiving the MBMS RAB Assignment Response message, the SGSN 305 performs updating by adding UE IDs included in the MBMS RAB Assignment Response message to its SGSN Service Context, and transmits to the MB-SC 301 a third MBMS Notify Response message indicating completed preparation for receiving a data stream for the MBMS service X (Step 1818). The third MBMS Notify Response message includes MBMS Service ID. After the third MBMS Notify Response message, the MB-SC 301 transmits a data stream for the MBMS service X to the UE 1621 (Step 1819). Of course, the messages used in FIG. 18 to transmit the MBMS service may include other information.

When transmission of the MBMS data stream is started, the MBMS data stream is transmitted to the UE 1621 through the previously set transmission paths. That is, the MBMS data stream is transmitted from the Node B 1620 to the UE 1621 over the downlink DPDCH, and the UE 1621 measures channel quality using a Pilot field in the downlink DPDCH, and transmits a down-TPC command for the downlink DPDCH using a TPC field in an uplink DPCH, if the channel quality is satisfactory. If, however, the channel quality of the downlink DPDCH is unsatisfactory, the UE 1621 transmits an up-TPC command for the downlink DPDCH using the TPC field in the uplink DPCH. The channel quality can be measured in several methods. For example, the channel quality can be measured by estimating SIR. In this case, the UE 1621 compares a target SIR value SIR_{target} of the channel quality-related information received in step 1815 with a measured SIR value determined by measuring the Pilot field in the downlink DPDCH. As a result of the comparison, if the measured SIR value is greater than or equal to the target SIR, the UE 1621 generates a down-TPC command. If, however, the measured SIR value is less than the target SIR, the UE 1621 generates an up-TPC command.

Meanwhile, the Node B 1620 monitors MBMS UEs existing in its cell region, i.e., monitors TPC fields of the uplink DPCHs each set up to the UEs 1621, 1622 and 1623. If any one of the TPC fields has an up-TPC command, the Node B 1620 increases transmission power of the downlink DPDCHs and the downlink informal DPCCHs. On the contrary, if all the TPC fields of the uplink DPCHs have a down-TPC command, the Node B 1620 decreases transmission power of the downlink DPDCHs and the downlink informal DPCCHs. At this point, the transmission power is increased or decreased in a unit of the step size received in step 1813. That is, the step size means a level by which the transmission power can be increase or decreased at once. In addition, the Node B 1620 also measures the channel quality using Pilot fields of the uplink DPCHs set up to the UEs 1621, 1622 and 1623. As a result of the measurement, if the channel quality is satisfactory, the Node B 1620 transmits an up-TPC command over a TPC field of a downlink informal DPCCH for the corresponding UE. If, however, the channel quality is unsatisfactory, the Node B 1620 transmits a. down-TPC command over a TPC field of a downlink informal DPCCH for the corresponding UE.

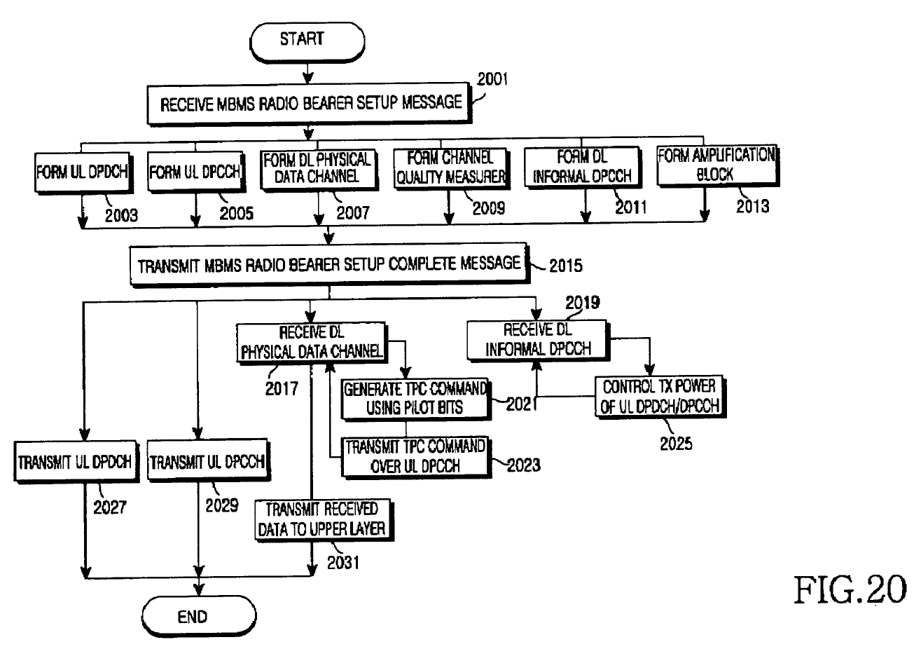

Next, a UE structure according to a second embodiment of the present invention will be described with reference to FIG. 19 as shown.

FIG. 19 illustrates an internal structure of a UE according to a second embodiment of the present invention. Referring to FIG. 19, an uplink DPDCH processor 1921 and an uplink DPCCH processor 1923 transmit an uplink DPDCH signal and an uplink DPCCH signal, respectively, to be transmitted over an uplink DPCH as described in conjunction with FIG. 17. Though not illustrated, the uplink DPDCH processor 1921 and the uplink DPCCH processor 1923 each include channel signal transmission elements such as spreader, channel coder, scrambler, rate matcher and modulator, and set up the DPDCH and the DPCCH in the slot format illustrated in FIG. 17, respectively. A downlink DPDCH processor 1953 and a downlink informal DPCCH processor 1955 process channel signals received over the downlink DPDCH and the downlink informal DPCCH as described in conjunction with FIG. 17, respectively. Though not illustrated, the downlink DPDCH processor 1953 and the downlink informal DPCCH processor 1955 each include channel signal reception elements such as despreader and channel decoder. Further, the downlink DPDCH processor 1953 and the downlink informal DPCCH processor 1955 set up the downlink DPDCH and the downlink informal DPCCH in the slot format illustrated in FIG. 17, respectively.

As described in conjunction with FIG. 18, the UE 1621 receives an MBMS Radio Bearer Setup message, or an RRC message from the RNC 1610, and the MBMS Radio Bearer Setup message includes information needed to set up channels over which the UE 1621 will receive an MBMS service. The MBMS Radio Bearer Setup message is transmitted to an upper layer, or an RRC layer of the UE 1621. The RRC layer then transmits the information needed to set up the above-stated channels to the uplink DPDCH processor 1921, the uplink DPCCH processor 1923, the downlink DPDCH processor 1953 and the downlink informal DPCCH 1955. Here, the RRC layer transmits to the downlink DPDCH processor 1953 a channelization code, a slot format number and a channel coding parameter to be used for the downlink DPDCH among the information included in the MBMS Radio Bearer Setup message, and the downlink DPDCH processor 1953 then forms elements for receiving the downlink DPDCH, such as despreader, channel decoder, rate dematcher and demodulator, using the information provided from the RRC layer.

In addition, the RRC layer transmits to the downlink informal DPCCH processor 1955 a channelization code, a scrambling code and a channel coding parameter to be used for the downlink informal DPCCH among the information included in the MBMS Radio Bearer Setup message, and the downlink informal DPCCH processor 1955 then forms elements for receiving the downlink informal DPCCH, using the information provided from the RRC layer. Further, the RRC layer transmits channelization codes and channel coding parameters to be used for the uplink DPDCH and the uplink DPCCH among the information included in the MBMS Radio Bearer Setup message, to the uplink DPDCH processor 1921 and the uplink DPCCH processor 1923, respectively. Then, the uplink DPDCH processor 1921 and the uplink DPCCH processor 1923 each form a series of elements for transmitting the uplink DPDCH and the uplink DPCCH, such as despreader and channel decoder, respectively.

Meanwhile, the RRC layer transmits a target SIR value SIR_{target} included in the MBMS Radio Bearer Setup message to a channel quality measurer 1957, and the channel quality measurer 1957 measures channel quality of the downlink DPDCH and the downlink informal DPCCH, using the SIR_{target}. The channel quality measurer 1957 generates an up-TPC command or a down-TPC command for increasing or decreasing transmission power of the corresponding channel based on the measured channel quality, and transmits the generated TPC command to the uplink DPCCH 1923. Further, the downlink informal DPCCH processor 1955 provides a step size received from the RRC layer to an amplification block 1910. The amplification block 1910 is comprised of an amplifier 1911 for amplifying a signal output from the uplink DPDCH processor 1921 at a corresponding gain, and an amplifier 1913 for amplifying a signal output from the uplink DPCCH processor 1923 at a corresponding gain. The amplifier 1911 and the amplifier 1913 each a control gain of their input signals in a unit of the step size received from the downlink informal DPCCH processor 1955. For example, if the amplifier 1911 has a transmission power level “a” at a time point “x” and thereafter receives an up-TPC command from the downlink informal DPCCH processor 1955, the amplifier 1911 will amplify its input signal at a transmission power level of “a+(step size).”

A summer 1905 sums up a signal output from the uplink DPDCH processor 1921 and a signal output from the uplink DPCCH processor 1923 in accordance with a predetermined uplink DPCH slot format, and provides the summed signal to a transmitter 1903. The transmitter 1903 scrambles a signal output from the summer 1905 with a corresponding scrambling code, up-converts the scrambled signal into an RF signal, and transmits the RF signal in the air through an antenna 1901. Meanwhile, an RF signal received from the air through an antenna 1950 is applied to a receiver 1951. The receiver 1951 provides the received signal from the antenna 1950 to the downlink DPDCH processor 1953 and the downlink informal DPCCH processor 1955.

Now, a transmission/reception operation of the UE 1621 will be described in detail with reference to FIG. 19.

First, an operation of transmitting an uplink DPCH signal will be described. If user data is transmitted from the upper layer to the uplink DPDCH processor 1921, then the uplink DPDCH processor 1921 performs a series of transmission processes such as spreading and channel coding on the user data, and provides its output to the amplifier 1911. Further, if TFCI from the upper layer and a TPC command from the channel quality measurer 1957 are provided to the uplink DPCCH processor 1923, then the uplink DPCCH processor 1923 performs a series of transmission processes on the signals provided from the upper layer and the channel quality measurer 1957, and provides its output to the amplifier 1913. The amplifier 1911 and the amplifier 1913 amplify a signal output from the uplink DPDCH 1921 processor and a signal output from the uplink DPCCH processor 1923 under the control of the downlink informal DPCCH processor 1955, respectively, and provide their outputs to the summer 1905. The summer 1905 then sums up a signal output from the amplifier 1911 and a signal output from the amplifier 1913 in accordance with a predetermined uplink DPCH slot format, and provides the summed signal to the transmitter 1903. The transmitter 1903 performs an RF process such as modulation and scrambling on the signal output from the summer 1905, and transmits the RF-processed signal in the air through the antenna 1901.

Second, an operation of receiving a downlink DPDCH signal and a downlink informal DPCCH signal will be described. If an RF signal is received from the air through the antenna 1950, the received signal is applied to the receiver 1951. The receiver 1951 down-converts the received RF signal into a baseband signal, performs descrambling and demodulation on the baseband signal, and provides its output to the downlink DPDCH processor 1953 and the downlink informal DPCCH processor 1955. Then, the downlink DPDCH processor 1953 performs a series of reception processes such as despreading and channel decoding on the RF signal provided from the receiver 1951, and separates the signal into Data1 field, TFCI field, Pilot field and Data2 field in accordance with a predetermined downlink DPDCH slot format. Thereafter, the downlink DPDCH processor 1953 processes the Data1 and the Data2 using the TFCI field, provides the processed data to the upper layer, and provides a signal on the Pilot field to the channel quality measurer 1957. The channel quality measurer 1957 then measures an SIR value using the pilot signal provided from the downlink DPDCH processor 1953, compares the measured SIR value with a stored target SIR value SIR_{target}, generates a TPC command based on the comparison result, and provides the generated TPC command to the uplink DPCCH processor 1923. Further, the downlink informal DPCCH processor 1955 performs a series of reception processes such as despreading, descrambling, channel decoding and demodulation on the RF signal provided from the receiver 1951, detects a signal on a TPC field in accordance with a predetermined downlink informal DPCCH slot format, and controls transmission power of the amplification block 1910 according to the detected TPC symbol.

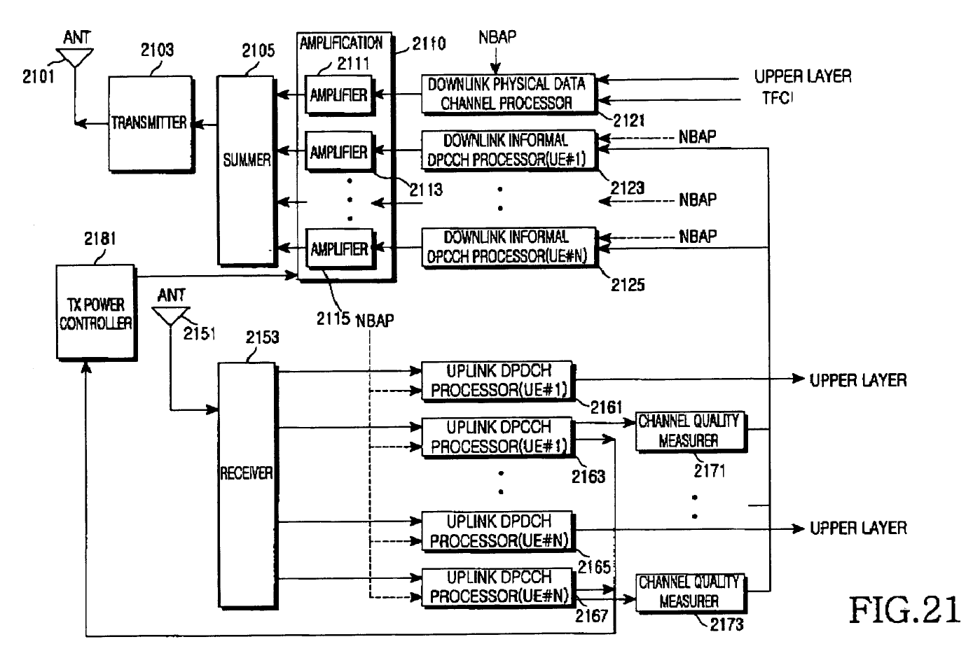

Now, an operating process of the UE 1621 will be described with reference to FIG. 20.

FIG. 20 illustrates an operating process of a UE according to a second embodiment of the present invention. Referring to FIG. 20, the UE 1621 receives an MBMS Radio Bearer Setup message from the RNC 1610 in step 2001, and then proceeds to steps 2003, 2005, 2007, 2009, 2011 and 2013. Here, the reason that the UE 1621 simultaneously proceeds from step 2001 to steps 2003, 2005, 2007, 2009, 2011 and 2013 is because the UE 1621 forms the uplink DPDCH processor 1921, the uplink DPCCH processor 1923, the downlink DPDCH processor 1953, the downlink informal DPCCH processor 1955, the channel quality measurer 1957 and the amplification block 1910 according to the information included in the MBMS Radio Bearer Setup message, as described in conjunction with FIG. 19. That is, the UE 1621 forms (or sets up) the uplink DPDCH processor 1921 in step 2003, the uplink DPCCH processor 1923 in step 2005, the downlink DPDCH processor 1953 in step 2007, the channel quality measurer 1957 in step 2009, the downlink informal DPCCH processor 1955 in step 2011, and the amplification block 1910 in step 2013, based on the information included in the MBMS Radio Bearer Setup message. Here, “setting up” the elements means preparing to transmit or receive a channel signal according to the information included in the MBMS Radio Bearer Setup message.

In step 2015, the UE 1621 transmits an MBMS Radio Bearer Setup Complete message indicating that an operation corresponding to the received MBMS Radio Bearer Setup message is performed, and then proceeds to steps 2017, 2019, 2027 and 2029. In step 2017, the UE 1621 receives a downlink DPDCH signal, and then proceeds to steps 2021 and 2031. In step 2019, the UE 1621 receives a downlink informal DPCCH signal, and then proceeds to step 2025. In step 2021, the UE 1621 generates a TPC command based on a signal on a pilot field, i.e., pilot bits in the received downlink DPDCH signal, and then proceeds to step 2023. In step 2023, the UE 1621 transmits the generated TPC command to the uplink DPCCH processor 1923, and then returns to step 2017. Meanwhile, in step 2025, the UE 1621 detects a signal on a TPC field from the received downlink informal DPCCH signal, controls transmission power of uplink DPDCH and DPCCH signals, and then returns to step 2019.

In step 2027, the UE 1621 transmits user data output from an upper layer over an uplink DPDCH in accordance with a predetermined slot format. In step 2029, the UE 1621 transmits TFCI, TPC, FBI and Pilot over an uplink DPCCH in accordance with a predetermined slot format. In step 2031, the UE 1621 transmits an MBMS data stream received over the downlink DPDCH to the upper layer. The process of FIG. 20 is continuously performed until the MBMS service is ended.

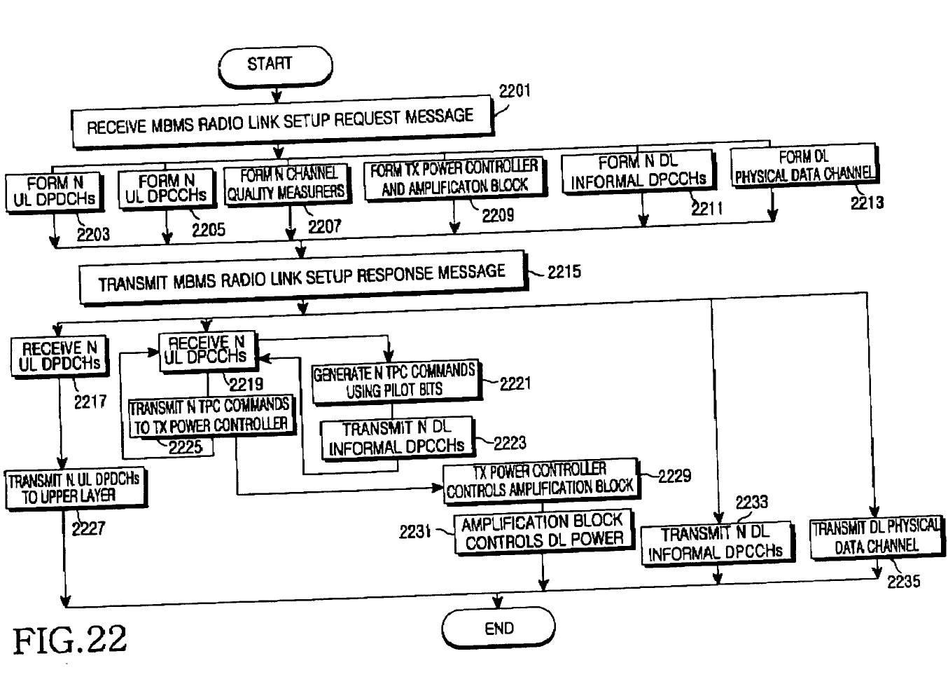

Next, an internal structure of a Node B for performing an operation according to a second embodiment of the present invention will be described with reference to FIG. 21.

FIG. 21 illustrates an internal structure of a Node B according to a second embodiment of the present invention. Referring to FIG. 21, uplink DPDCH processors 2161˜2165, and uplink DPCCH processors 2163˜2167 process control information and user data received over an uplink DPCH illustrated in FIG. 17, respectively. Here, the number of the uplink DPDCH processors 2161˜2165 and the number of the uplink DPCCH processors 2163˜2167 are equal to the number of MBMS UEs using a downlink DPDCH. It is assumed in FIG. 21 that the number of the MBMS UEs is N. The uplink DPDCH processors 2161˜2165, and the uplink DPCCH processors 2163˜2167 each include elements for processing a received signal, such as a despreader and a channel decoder. A downlink DPDCH processor 2121 processes control information and user data to be transmitted in the slot format illustrated in FIG. 17. The downlink DPDCH processor 2121 includes elements for processing transmission signal, such as a spreader and a channel coder. Downlink informal DPCCH processors 2123˜2125 process control information to be transmitted in the slot format illustrated in FIG. 17. Each of the downlink informal DPCCH processors 2123˜2125 also includes elements for processing a transmission signal, such as a spreader and a channel coder. An amplification block 2110 includes an amplifier 2111 for amplifying a signal output from the downlink DPDCH processor 2121, and amplifiers 2113˜2115 for amplifying signals output from the downlink informal DPCCH processors 2123˜2125, respectively. The amplification block 2110 properly controls its gain under the control of the uplink DPCCH processors 2163˜2167. In the second embodiment of the present invention, the same TPC command (up-TPC command or down-TPC command) is applied to all amplifiers constituting the amplification block 2110. Here, a method of determining gains of the amplifiers constituting the amplification block 2110 is as follows. For example, if transmission power of the uplink DPDCH processor 2161 is “a” at a certain time point “x” and the uplink DPDCH processor 2161 generates an up-TPC command at the point “x,” then the amplifier 2111 amplifies a signal output from the downlink DPDCH processor 2121 at transmission power of “a+(step size).”

The Node B 1620, as described in conjunction with FIG. 18, receives an MBMS Radio Link Setup Request message, or an NBAP message from the RNC 1610, and the MBMS Radio Link Setup Request message includes a parameter needed to set up channels for providing an MBMS service, and TPC-related information. An NBAP layer of the Node B 1620 transmits to the downlink DPDCH processor 2121 a channelizatoin code, a slot format number and a channel coding parameter to be used for a downlink DPDCH among the information included in the received MBMS Radio Link Setup Request message. The downlink DPDCH processor 2121 then forms a series of elements for processing a transmission signal, such as a spreader and a channel coder, in accordance with the information received from the NBAP layer. Further, the NBAP layer of the Node B 1620 transmits to the downlink informal DPCCH processors 2123˜2125 a channelizatoin code and a channel coding parameter to be used for a downlink informal DPCCH among the information included in the received MBMS Radio Link Setup Request message. The downlink informal DPCCH processors 2123˜2125 then form a series of elements for processing a transmission signal, such as a spreader and a channel coder, in accordance with the information provided from the NBAP layer.

In addition, the NBAP layer of the Node B 1620 transmits to the uplink DPDCH processors 2161˜2165 a channelization code and a channel decoding parameter to be used for the uplink DPDCH among the information included in the received MBMS Radio Link Setup Request message. The uplink DPDCH processors 2161˜2165 then form a series of elements for processing a received signal, such as a despreader and a channel decoder, in accordance with the information provided from the NBAP layer. In addition, the NBAP layer of the Node B 1620 transmits to the uplink DPCCH processors 2163˜2167 a channelization code and a channel decoding parameter to be used for an uplink DPCCH among the information included in the received MBMS Radio Link Setup Request message. The uplink DPCCH processors 2163˜1167 then form a series of elements for processing a received signal, such as a despreader and a channel decoder, in accordance with the information provided from the NBAP layer.

In addition, the NBAP layer of the Node B 1620 transmits to channel quality measurers 2171˜2173 a target SIR value SIR_{target} among the information included in the received MBMS Radio Link Setup Request message. Then, the channel quality measurers 2171˜2173 store the provided SIR_{target}, and use it later when measuring the channel quality. Further, the NBAP layer of the Node B 1620 transmits to the amplification block 2110 a step size for TPC among the information included in the received MBMS Radio Link Setup Request message. The amplification block 2110 then increases or decreases transmission power of a signal applied to a summer 2105 in a unit of the step size under the control of a transmission power controller 2181. Further, the NBAP layer of the Node B 1620 provides a transmission power control algorithm to the transmission power controller 2181. The transmission power control algorithm, which can be provided to the Node B 1620 by the RNC 1610 through the MBMS Radio Link Setup Request message, is an algorithm indicating how to process TPC commands transmitted by a plurality of MBMS UEs over the uplink DPCCHs. Increasing transmission power of a downlink channel if any one of uplink DPCCHs transmitted by the MBMS UEs includes an up-TPC command, is an example of the transmission power control algorithm. The transmission power control algorithm can be differently selected according to a cell state. For example, it is possible to determine whether to increase or decrease transmission power of a downlink channel based on a ratio of up-TPC commands to down-TPC commands. It is possible to consider using a method for increasing transmission power of a downlink DPDCH only when a ratio of up-TPC commands transmitted by the MBMS UEs receiving the downlink DPDCH is larger than or equal to 0.2.

Now, a transmission/reception operation of the Node B 1620 will be described in detail with reference to FIG. 21.

First, an operation of receiving uplink DPCHs will be described. An RF signal received from the air through an antenna 2151 is applied to a receiver 2153. The receiver 2153 down-converts the RF signal from the antenna 2151 into a baseband signal, performs descrambling and demodulation on the baseband signal, and provides its output to the uplink DPDCH processors 2161˜2165 and the uplink DPCCH processors 2163˜2167. The uplink DPDCH processors 2161˜2165 process an uplink DPDCH signal output from the receiver 2153 through a series of reception processes such as despreading and channel decoding, and transmits the processed DPDCH data to the upper layer. Here, the data transmitted over the uplink DPDCH is provided to the upper layer after being segmented or soft-combined in accordance with TFCI transmitted over the uplink DPCCH. Similarly, the uplink DPCCH processors 2163˜2167 process an uplink DPCCH signal output from the receiver 2153 through a series of reception processes such as despreading and channel decoding, and detect TFCI values and TPC commands from the processed DPCCH signal in accordance with a predetermined slot format. The uplink DPCCH processors 2163˜2167 each transmit the detected TFCIs to the corresponding uplink DPDCH processors 2161˜2165, and transmit the detected TPC commands to the transmission power controller 2181. The uplink DPCCH processors 2163˜2167 transmit pilot signals on Pilot fields in the processed DPCCH to the corresponding channel quality measurers 2171˜2173, respectively. The channel quality measurers 2171˜2173 measure SIR values based on the pilot signals from the uplink DPCCH processors 2163˜2167, respectively, compare the measured SIR values with SIR_{target} values stored therein, and determine TPC commands to be transmitted over the downlink informal DPCCHs based on the comparison result. The transmission power controller 2181 determines whether to increase or decrease transmission power of downlink channels based on the TPC commands provided from the uplink DPCCH processors 2163˜2167 for the MBMS UEs, and controls transmission power of the amplification block 2110. Here, the above-stated power control algorithm can be used for the process of increasing or decreasing transmission power of the downlink channels by the transmission power controller 2181. As a result, the amplification block 2110 increases or decreases transmission power of the downlink channels by a predetermined step size under the control of the transmission power controller 2181.

Next, an operation of transmitting downlink channels will be described. The downlink DPDCH processor 2121 forms user data transmitted from upper layer in the slot format illustrated in FIG. 17, performs a series of transmission processes such as spreading and channel coding, and provides its output to the amplifier 2111. Similarly, the downlink informal DPCCH processors 2123˜2125 form TPC commands provided from the channel quality measurers 2171˜2173 in the slot format illustrated in FIG. 17, perform a series of transmission processes such as spreading and channel coding, and provide their outputs to the amplifiers 2113˜2115, respectively. The amplifier 2111 amplifies a signal output from the downlink DPDCH processor 2121 at a corresponding gain, and provides its output to the summer 2105. Likewise, the amplifiers 2113˜2115 amplify signals output from the downlink informal DPCCH processors 2123˜2125 at corresponding gains, and provide their outputs to the summer 2105. The summer 2105 sums up signals output from the amplifier 2111 and the amplifiers 2113˜2115, and provides its output to a transmitter 2103. The transmitter 2103 performs scrambling and modulation on a signal output form the summer 2105, up-converts the modulated signal into an RF signal, and transmits the RF signal in the air through an antenna 2101.

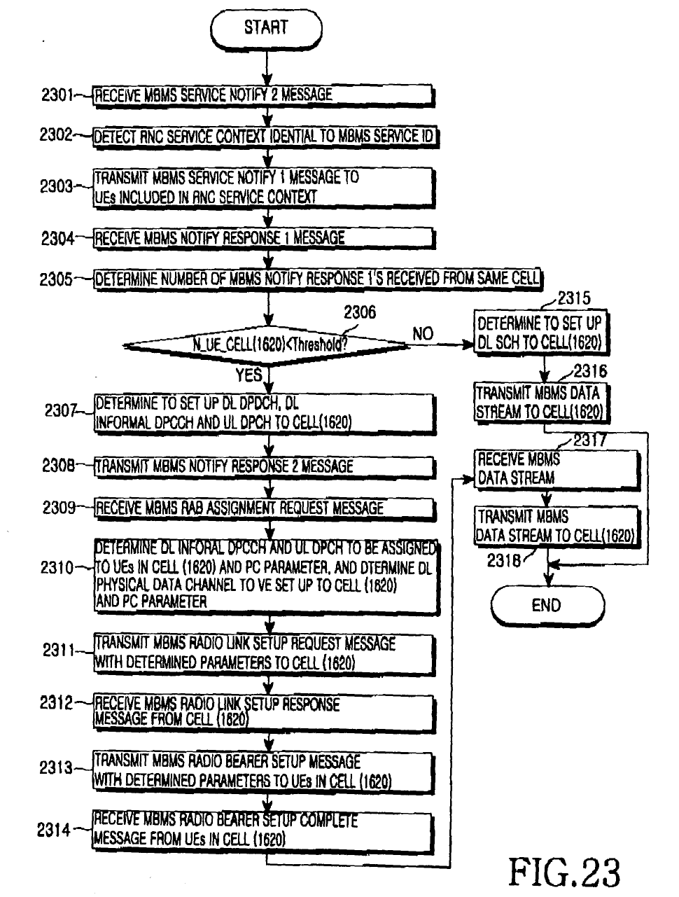

Now, an operation of the Node B 1620 will be described with reference to FIG. 22.

FIG. 22 is a flow chart illustrating an operating process of a Node B according to a second embodiment of the present invention. Referring to FIG. 22, the Node B 1620 receives an MBMS Radio Link Setup Request message from the RNC 1610 in step 2201, and then proceeds to steps 2203, 2205, 2207, 2209, 2211, and 2213. Here, the reason that the Node B 1620 simultaneously proceeds to steps 2203, 2205, 2207, 2209, 2211 and 2213 is because the Node B 1620 forms the downlink DPDCH processor 2121, the transmission power controller 2181, the amplification block 2110, the N downlink informal DPCCH processors 2123˜2125, the uplink DPDCH processors 2161˜2165, and uplink DPCCH processors 2163˜2167, and the channel quality measurers 2171˜2173 according to the information included in the MBMS Radio Setup Request message, as described in conjunction with FIG. 21. That is, the Node B 1620 forms (or sets up) the uplink DPDCH processors 2161˜2165 in step 2203, the uplink DPCCH processors 2163˜2167 in step 2205, the channel quality measurers 2171˜2173 in step 2207, the transmission power controller 2181 and the amplification block 2110 in step 2209, the downlink informal DPCCH processors 2123˜2125 in step 2211, and the downlink DPDCH processor 2121 in step 2213, based on the information included in the MBMS Radio Link Setup Request message. Here, “setting up” the elements means preparing to transmit or receive a channel signal according to the information included in the MBMS Radio Link Setup Request message.

In step 2115, the Node B 1620 transmits to the RNC 1610 an MBMS Radio Link Setup Response message indicating that an operation corresponding to the received MBMS Radio Link Setup Request message is performed, and then proceeds to steps 2217, 2219, 2233 and 2235. In step 2217, the Node B 1620 receives N uplink DPDCH signals, and then proceeds to step 2227. In step 2219, the Node B 1620 receives N uplink DPCCH signals, and then proceeds to steps 2221 and 2225. In step 2227, the Node B 1620 processes the received N uplink DPDCH signals and transmits the processed signals to the upper layer. In step 2225, the Node B 1620 processes the received N uplink DPCCH signals, transmits TPC commands to the transmission power controller 2181, and then proceeds to step 2229. In step 2221, the Node B 1620 processes the received N uplink DPCCH signals, forms TPC commands using pilot bits in each Pilot field, and then proceeds to step 2223. In step 2223, the Node B 1620 transmits the formed TPC commands to the downlink informal DPCCH processors 2123˜2125, and then returns to step 2219.

In step 2229, the transmission power controller 2181 controls transmission power of the signals output from the amplification block 2110 based on the provided TPC commands, and then proceeds to step 2231. In step 2231, the amplification block 2110 controls transmission power of the downlink channels provided to the summer 2105. In step 2233, the Node B 1620 transmits the N downlink informal DPCCHs to the corresponding MBMS UEs. In step 2235, the Node B 1620 transmits the downlink DPDCH to each MBMS UE. The process of FIG. 22 is continuously performed until the MBMS service is ended.

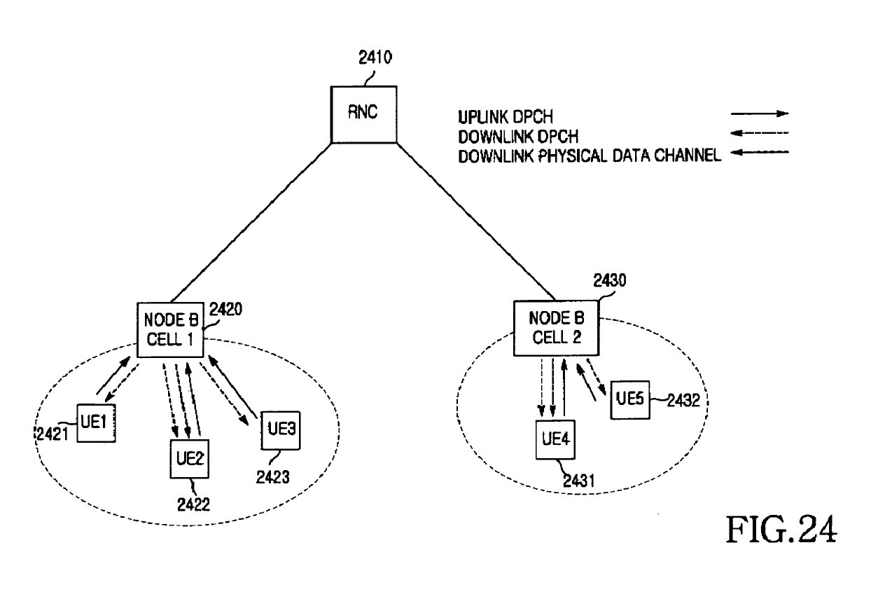

Next, an operating process of the RNC 1610 will be described with reference to FIG. 23. FIG. 23 is a flow chart illustrating an operating process of an RNC according to a second embodiment of the present invention. Referring to FIG. 23, the RNC 1610 receives a second MBMS Service Notify message from the SGSN 305 in step 2301, and then proceeds to step 2302. In step 2302, the RNC 1610 detects an RNC Service Context identical to an MBMS Service ID included in the received second MBMS Service Notify message, and then proceeds to step 2303. In step 2303, the RNC 1610 transmits a first MBMS Service Notify message to MBMS UEs included in the RNC Service Context identical to the detected MBMS Service ID, and then proceeds to step 2304. In step 2304, the RNC 1610 receives a first MBMS Notify Response message from the MBMS UEs in reply to the first MBMS Service Notify message transmitted to the MBMS UEs included in the RNC Service Context, and then proceeds to step 2305. In step 2305, the RNC 1610 determines cells to which the MBMS UEs that transmitted the first MBMS Notify Response message belong, determine the number of MBMS UEs for each cell, which have transmitted the first MBMS Notify Response message, and then proceed to step 2306. It will be assumed in step 2306 and its succeeding steps that the RNC 1610 considers only a cell region of a specific Node B, i.e., the Node B 1620.

In step 2306, the RNC 1610 determines whether the number of MBMS UEs existing in a cell region of the Node B 1620 is less than a predetermined Threshold value (N_UE_CELL(1620)<Threshold). As a result of the determination, if the number, N_UE_CELL(1620), of MBMS UEs existing in the cell region of the Node B 1620 is greater than or equal to the predetermined Threshold value, the RNC 1610 proceeds to step 2315. In step 2315, the RNC 1610 determines to use a downlink shared channel when providing an MBMS service to the MBMS UEs existing in the cell region of the Node B 1620, and then proceeds to step 2316. In step 2316, the RNC 1610 transmits MBMS data stream over the downlink shared channel, and then ends the process. However, if the number, N_UE_CELL(1620), of the MBMS UEs existing in the cell region of the Node B 1620 is greater than the predetermined Threshold value, the RNC 1610 proceeds to step 2307. In step 2307, the RNC 1610 determines to use a downlink DPDCH, a downlink informal DPCCH and an uplink DPCH when providing an MBMS service to the MBMS UEs existing in the cell region of the Node B 1620, and then proceeds to step 2308. In step 2308, the RNC 1610 transmits to the SGSN 305 a second MBMS Notify Response message indicating that an operation corresponding to the received second MBMS Service Notify message is performed, and then proceeds to step 2309. In step 2309, the RNC 1610 receives an MBMS RAB Assignment Request message from the SGSN 305, and then proceeds to step 2310. In step 2310, the RNC 1610 determines such control information as downlink DPDCH, downlink informal DPCCH, uplink DPCH resources to be assigned to the MBMS UEs existing in the cell region of the Node B 1620 and their associated TPC parameters, and then proceeds to step 2311.

In step 2311, the RNC 1610 transmits an MBMS Radio Link Setup Request message including the determined control information to the Node B 1620, and then proceeds to step 2312. In step 2312, the RNC 1610 receives an MBMS Radio Link Setup Response message in reply to the MBMS Radio Link Setup Request message, and then proceeds to step 2313. In step 2313, the RNC 1610 transmits an MBMS Radio Bearer Setup message including the control information determined in step 2310 to each of the MBMS UEs existing in the cell region of the Node B 1620, and then proceeds to step 2314. In step 2314, the RNC 1610 receives an MBMS Radio Bearer Setup Complete message in reply to the MBMS Radio Bearer Setup message from each of the MBMS UEs existing in the cell region of the Node B 1620, and then proceeds to step 2317. In step 2317, the RNC 1610 waits until an MBMS data stream is received from the MB-SC 301, and then proceeds to step 2318 upon receiving the MBMS data stream. In step 2318, the RNC 1610 transmits the received MBMS data stream to the MBMS UEs in the cell region of the Node B 1620 over the downlink DPDCHs set up to the cell, or the Node B 1620.

Next, the third embodiment of the present invention will be described. The above-described second embodiment of the present invention is advantageous in that an operation of controlling transmission power of the channels for providing an MBMS service is simple. The reason is because transmission power of the downlink DPDCHs and transmission power of the downlink informal DPCCHs are controlled in the same way. That is, transmission of the downlink DPDCHs is controlled to be identical to transmission power, worstcaseUE_TP, of an MBMS UE having the worst radio link. However, it is preferable to separately control transmission power of the downlink informal DPCCHs according to conditions of the radio links for the MBMS UEs. Therefore, the third embodiment of the present invention provides an MBMS service method for controlling transmission power of the downlink DPDCHs to be identical to the worstcaseUE_TP, and separately controlling transmission power of the downlink informal DPCCHs according to conditions of the radio links for the MBMS UEs.

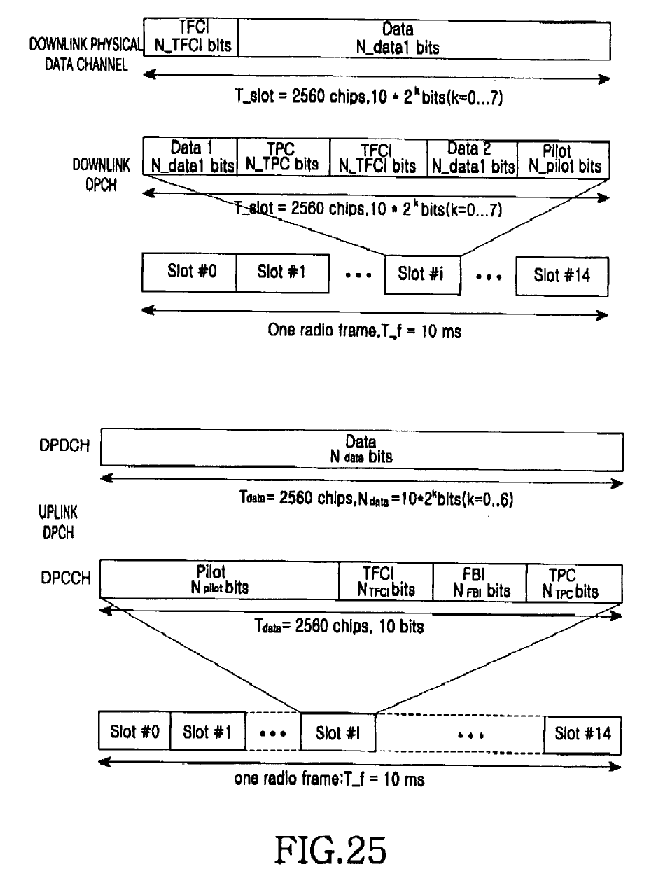

Now, a method of assigning channel resources for providing an MBMS service will be described with reference to FIG. 24.

FIG. 24 schematically illustrates a network structure for dynamically assigning channel resources according to the number of MBMS UEs according to a third embodiment of the present invention. Referring to FIG. 24, an RNC 2410 manages a cell #1 managed by a Node B 2420, and a cell #2 managed by a Node B 2430. In FIG. 24, three MBMS UEs of UE1 2421, UE2 2422 and UE3 2423 exist in the Node B 2420, and two MBMS UEs of UE4 2431 and UE5 2432 exist in the Node B 2430. The Node B 2420 assigns one downlink DPDCH, three downlink DPCHs and three uplink DPCHs, and the Node B 2430 assigns one downlink DPDCH, two downlink DPCHs and two uplink DPCHs. The Node B 2420 and the Node B 2430 transmit MBMS data over their assigned downlink DPDCHs, and transmits TPC signals for the uplink DPCHs over the downlink DPCHs. Upon receiving the downlink DPCHs from the Node B 2420 and the Node B 2430, the UEs 2421, 2422, 2423, 2431 and 2432 detect TPC signals included in the downlink DPCHs and control transmission power of the corresponding uplink DPCHs. Further, the UEs 2421, 2422, 2423, 2431 and 2432 transmit TPC commands for the downlink DPDCHs over the uplink DPCHs in order to control transmission power of the downlink DPDCHs. Therefore, unlike the second embodiment of the present invention, the third embodiment of the present invention maximizes efficiency of channelization code resources and transmission power resources by providing an exclusive MBMS service for separately controlling transmission power of the MBMS UEs according to conditions of the radio links for the MBMS UEs, while providing MBMS data by assigning a single downlink DPDCH to the MBMS UEs existing in the same cell.

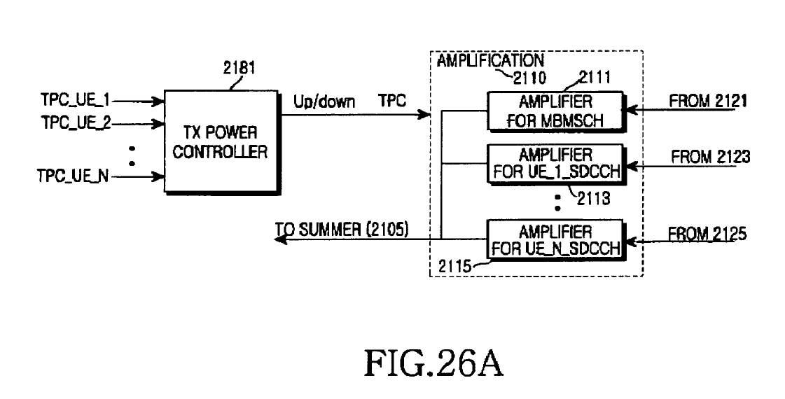

Next, a channel structure for providing an MBMS service according to a third embodiment of the present invention will be described with reference to FIG. 25.

FIG. 25 schematically illustrates structures of a downlink DPDCH, a downlink DPCH and an uplink DPCH according to a third embodiment of the present invention. Referring to FIG. 25, the uplink DPCH is identical in structure to the uplink DPCH illustrated in FIG. 17, so a detailed description of it will not be provided herein. However, the downlink DPDCH is different in structure from the downlink DPDCH illustrated in FIG. 17. That is, the downlink DPDCH according to the third embodiment of the present invention has a TFCI field and a Data field. The TFCI field segments data transmitted over the Data field in a predetermined size, and transmits segmentation information to an upper layer. Further, the TFCI field includes information on presence of CRC, and a size of the CRC, if CRC exists. Here, the TFCI field and the Data field can be previously determined. Table 3 illustrates slot formats of a downlink DPDCH according to a third embodiment of the present invention, by way of example.

TABLE 3

| Slot | | | | |
|---|---|---|---|---|
| Format | | | Bits/Slot | |
| # | SF | Bits/Slot | N_{Data} | N_{TFCI} |
| 1 | 256 | 20 | 20 | 0 |
| 1A | 256 | 20 | 18 | 2 |
| 2 | 128 | 40 | 40 | 0 |
| 2A | 128 | 40 | 38 | 2 |
| 3 | 64 | 80 | 72 | 8 |
| 4 | 32 | 160 | 152 | 8 |
| 5 | 16 | 320 | 312 | 8 |
| 6 | 8 | 640 | 632 | 8 |
| 7 | 4 | 1280 | 1272 | 8 |

Further, the downlink DPCH is identical in structure to a general UMTS downlink DPCH.

In conclusion, the reason that the channel structure for providing the MBMS service according to the second embodiment of the present invention is different from the channel structure for providing the MBMS service according to the third embodiment of the present invention consists in a transmission power control method. A comparison will be made between a transmission power control method for the downlink DPDCH according to the second embodiment and a transmission power control method for the downlink DPDCH according to the third embodiment.

First, in the second embodiment of the present invention, the transmission power controller 2181 of the Node B controls the amplification block 2110 to only increase or decrease transmission power of the downlink DPDCH and the downlink informal DPCCHs, as described in conjunction with FIG. 21. The amplification block 2110 then increases or decreases the current transmission power against previous transmission power in unit of the step size. That is, transmission power determined by the amplification block 2110 is represented by Equation (6) or Equation (7).

MBMSCH_TP(x+1)=MBMSCH_{—}TP(x)+step size

SDCCH_{—}UE_{—1}_{—}TP(x+1)=SDCCH_{—}UE_{—1}TP(x+1)+step size

SDCCH_{—}UE_{—}N_{—}TP(x+1)=SDCCH_{—}UE_{—}N_{—}TP(x+1)+step size Equation (6)

MBMSCH_{—}TP(x+1)=MBMSCH_{—}TP(x)−step size

SDCCH_{—}UE_{—1}_{—}TP(x+1)=SDCCH_{—}UE_{—1}_{—}TP(x+1)−step size

SDCCH_{—}UE_{—}N_{—}TP(x+1)=SDCCH_{—}UE_{—}N_{—}TP(x+1)−step size Equation (7)

In Equation (6) and Equation (7), MBMSCH_TP(x) denotes transmission power of a downlink DPDCH (referred to as “MBMSCH” in Equations (6) and 7)) applied to an x^{th} transmission power control period, and SDCCH_UE_N_TP(x) denotes transmission power of a downlink informal DPCCH (referred to as “SDCCH” in Equations (6) and (7)) applied to an x^{th} transmission power control period. Here, the “transmission power control period” means a period where transmission power control is performed, and the transmission power control period is generally one time slot. Whether the Node B uses Equation (6) or Equation (7) in determining transmission power of the corresponding channels is determined by the transmission power controller 2181. That is, if the transmission power controller 2181 transmits an up-TPC command to the amplification block 2110, all amplifiers in the amplification block 2110 amplify input signals at a gain determined by increasing previous transmission power by the step size. However, if the transmission power controller 2181 transmits a down-TPC command to the amplification block 2110, all amplifiers in the amplification block 2110 amplify input signals at a gain determined by decreasing previous transmission power by the step size.

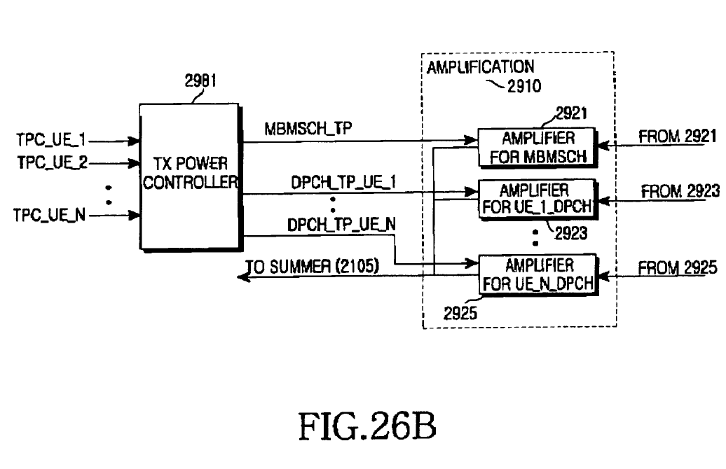

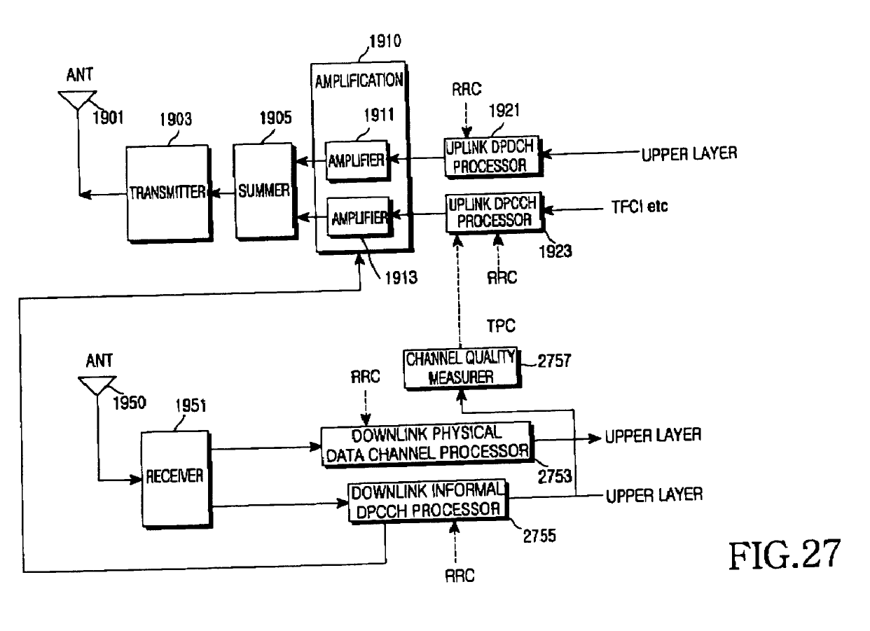

Meanwhile, the transmission power controller 2181 determines an up-TPC command or a down-TCP command based on TPC bits included in the uplink DPCCHs transmitted by the UEs. The transmission power control according to the second embodiment of the present invention will be described with reference to FIG. 26A.

FIG. 26A illustrates a transmission power control operation by the transmission power controller 2181 of FIG. 21 according to the second embodiment of the present invention. Referring to FIG. 26A, the transmission power controller 2181 determines whether to increase or decrease the current transmission power by gathering TPC commands from the UEs provided from the uplink DPCCH processors 2163˜2167. If any one of the TPC commands from the UEs is an up-TPC command, the transmission power controller 2181 provides the amplification block 2110 with an up-TPC command. However, if all of the TPC commands are down-TPC commands, the transmission power controller 2181 provides the amplification block 2110 with a down-TPC command. The amplification block 2110 then equally increases or decreases transmission power of all amplifiers 2111-2115 included therein in a unit of the step size according to the TPC command provided from the transmission power controller 2181.

Unlike the second embodiment, the third embodiment of the present invention separately controls transmission power for the UEs, so a transmission power control method by the Node B according to the third embodiment is different from the transmission power control method according to the second embodiment. This will be described with reference to FIG. 26B.

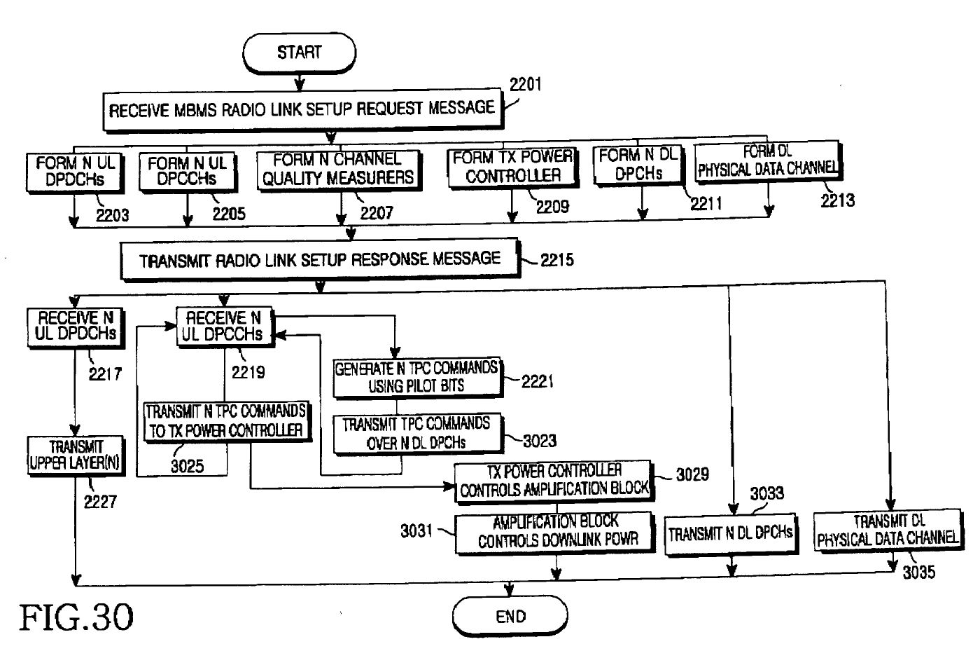

FIG. 26B illustrates a transmission power control operation by a transmission power controller 2981 of FIG. 29 according to a third embodiment of the present invention.

A detailed description of a transmission power controller 2981 and an amplification block 2910 of FIG. 26 will be given later with reference to FIG. 29. Here, reference will be made only to a difference between the transmission power control and amplification operations according to the second embodiment and the transmission power control and amplification operations according to the third embodiment.

The transmission power controller 2981 provides the amplification block 2910 with an absolute transmission power value, and the amplification block 2910 amplifies input signals according to the absolute transmission power value provided from the transmission power controller 2981. The transmission power controller 2981 determines transmission power to be applied to a downlink DPDCH depending on the highest value, worstcaseUE_TP, among the absolute transmission power values of downlink DPCHs. Here, a method of determining transmission power of the downlink DPCHs is identical to the conventional method, and can be expressed as

DPCH_{—}TP_{—}UE_{—}n(x+1)=DPCH_{—}TP_{—}UE_{—}n(x)+step size_{—}n, if TPC_{—}UE_{—}n is ‘up’

DPCH_{—}TP_{—}UE_{—}n(x+1)=DPCH_{—}TP_{—}UE_{—}n(x)−step size_{—}n, if TPC_{—}UE_{—}n is ‘down’ Equation (8)

The transmission power controller 2981 determines transmission power values to be applied to downlink DPCHs for the UEs using Equation (8), and determines transmission power to be applied to a downlink DPDCH depending on the highest value worstcaseUE_TP among the determined transmission power values in accordance with Equation (9).

MBMSCH_{—}TP(x+1)=worstcaseUE_{—}TP(x+1)+PO_{—}MBMS Equation (9)

In Equation (9), PO_MBMS denotes an offset value for correcting a transmission power difference that should be applied to downlink DPCHs and a downlink DPDCH. The PO_MBMS can be determined according to the type of data transmitted over the downlink DPDCH and the downlink DPCHs. Alternatively, the PO_MBMS can be previously set by the Node B. If MBMS data transmitted over the downlink DPDCH needs higher QoS than data transmitted over the downlink DPDCH, the PO_MBMS becomes a positive number. If the transmission power values to be applied to the channels are determined as stated above, the transmission power controller 2981 provides the determined transmission power values to the amplification block 2910, and the amplification block 2910 amplifies corresponding channels based on the transmission power values provided from the transmission power controller 2981.

In conclusion, the third embodiment of the present invention adaptively determines transmission power values of downlink DPCHs depending upon the conditions of the respective channels, and controls transmission power of a downlink DPDCH based on transmission power of the worst radio channel, thereby making it possible to properly control transmission power of the downlink DPCHs as well as the downlink DPDCH. That is, as illustrated in FIG. 16, in the second embodiment of the present invention, transmission power of the downlink informal DPCCHs and transmission power of the downlink DPDCH are controlled in the same way, thus unnecessarily wasting transmission power. On the contrary, as illustrated in FIG. 24, in the third embodiment of the present invention, transmission power values of the downlink DPCHs are adaptively determined according to the conditions of the corresponding channels, thereby preventing an unnecessary waste of the transmission power.

Next, a process of providing an MBMS service according to a third embodiment of the present invention will be described with reference to FIG. 18.

The reason that the third embodiment of the present invention is described with reference to FIG. 18 is because the third embodiment and the second embodiment operate in the same way in steps 1801 to 1813 and steps 1817 to 1819, but operate in a different way only in steps 1814 to 1816. In the following description, the elements 1610, 1620 and 1621 of FIG. 16 will be replaced with the corresponding elements 2410, 2420 and 2421 of FIG. 24, respectively. Upon receiving an MBMS RAB Assignment Request message in step 1812, the RNC 2410 determines a cell and UEs, IDs of which are included in its RNC Service Context, and prepares to set up a radio link to the cell, or the Node B 2420 according to QoS information included in the received MBMS RAB Assignment Request message. Here, the RNC 2410 can determine whether to set up a radio bearer of the corresponding cell as a downlink DPDCH or set up the radio bearer as a downlink DPDCH and downlink DPCHs and uplink DPCHs for UEs, based on the number of the UEs belonging to the cells stored in the RNC Service Context. That is, as stated above, a downlink DPDCH is set up to a cell, the number of UEs existing in which is larger than or equal to a Threshold value, while a downlink DPDCH, and downlink DPCHs and uplink DPCHs for the UEs are set up to a cell, the number of UEs existing in which is smaller than the Threshold value. It will be assumed herein that the RNC 2410 decides to set up a downlink DPDCH, a downlink DPCH and an uplink DPCH to the UE 2421.

The RNC 2410 transmits to the Node B 2420 an MBMS Radio Link Setup Request message in order to set up a radio link for transmitting a data stream to the MBMS service X (Step 1813). The MBMS Radio Link Setup Request message includes information on radio channels to be set up as downlink and uplink channels. As described in the second embodiment of the present invention, the radio channel-related information includes channelization code information, scrambling code information and channel coding information to be applied to each channel, a slot format number and TPC-related information. That is, in order to provide an MBMS service to N users, the radio channel-related information must include information on one downlink DPDCH and information on N downlink DPCHs and N uplink DPCHs. This information can be transmitted over one MBMS Radio Link Setup Request message as described in conjunction with FIG. 18. Alternatively, the information can be transmitted through an MBMS Radio Link Setup Request message with downlink DPDCH information and N Radio Link Setup Request messages with downlink and uplink DPCH information. Table 4 below illustrates information that must be transmitted in the second embodiment and information that must be transmitted in the third embodiment.

TABLE 4

| Channel | Second Embodiment | Third Embodiment |
|---|---|---|
| Downlink | Channelization code, | Channelization code, scrambling |
| DPDCH | scrambling code, slot format | code, slot format number (see |
| | number (see TABLE 1), power | TABLE 2), power control |
| | control information (step size), | information (PO_MBMS), and |
| | and transport format-related | transport format-related |
| | information | information |
| Downlink | Channelization code, | N/A |
| informal | scrambling code, channel | |
| DPCCH | coding type, modulation type | |
| Downlink | N/A | Channelization code, slot format |
| DPCH | | number (see TS 25.211), power |
| | | control information (step |
| | | size_n), and transport format- |
| | | related information |
| Uplink | Channelization code, slot | Same as left |
| DPCH | format number (see TS 25.211), | |
| | power control information | |
| | (target SIR_n), and transport | |
| | format-related information | |

In addition to the information illustrated in Table 4, other channel-related information can also be included in Table 4. The “transport format-related nformation” means information on a transport format of data to be transmitted ver the corresponding channel, and can include information on an amount of data to be transmitted for 15 time slots, a channel coding type to be applied to the data, a size of a transport block, application of CRC, and a length of CRC. Here, the “transport block” means a unit of data transmitted from an upper layer to a physical layer. For example, if a size of the transport block is 100 bits, it means that the upper layer transmits data to the physical layer in a unit of 100 bits. The transport formation-related information is transmitted to a receiver over a TFCI field stated before, and the receiver can properly process received data using the TFCI. As illustrated in Table 4, the third embodiment of the present invention transmits PO_MBMS as transmission power control-related information for a downlink DPDCH, and uses a slot format different from that used in the second embodiment of the present invention. Since downlink DPCHs and uplink DPCHs set up in the third embodiment of the present invention are identical to downlink DPCHs and uplink DPCHs used in the existing UMTS communication system, the information related thereto is also identical. In addition, “target SIR_n” and “step size n” in Table 4 mean target SIR and step size for UE_n.

Meanwhile, the Node B 2420 forms a downlink DPDCH processor and downlink DPCH processors based on channel-related information included in the MBMS Radio Link Setup Request message or included in the MBMS Radio Link Setup Request message and the plurality of Radio Link Setup Request messages, forms uplink DPCCH processors, and then transmits an MBMS Radio Link Setup Response message to the RNC 2410 (Step 1814). Likewise, one MBMS Radio Link Setup Response message and a plurality of Radio Link Setup Response messages can be used herein.

Thereafter, the RNC 2410 transmits an MBMS Radio Bearer Setup message to UEs scheduled to receive an MBMS service (Step 1815). The MBMS Radio Bearer Setup message includes information on the channels to be set up. Specifically, the message includes the information illustrated in Table 5.

TABLE 5

| Channel | Second Embodiment | Third Embodiment |
|---|---|---|
| Downlink | Channelization code, scrambling | Channelization code, |
| DPDCH | code, slot format number (see | scrambling code, slot format |
| | TABLE 1), power control | number (see TABLE 2), and |
| | information (target SIR), and | transport format-related |
| | transport format-related | information |
| | information | |
| Downlink | Channelization code, scrambling | N/A |
| informal | code, channel coding type, | |
| DPCCH | modulation type | |
| Downlink | N/A | Channelization code, slot |
| DPCH | | format number (see TS |
| | | 25.211), power control |
| | | information (target SIR_n), and |
| | | transport format-related |
| | | information |
| Uplink | Channelization code, slot format | Same as left |
| DPCH | number (see TS 25.211), power | |
| | control information (step size_n), | |
| | and transport format-related | |
| | information | |

Table 5 illustrates information that must be transmitted in the second embodiment of the present invention and information that must be transmitted in the third embodiment of the present invention. In Table 5, “target SIR” among the downlink DPDCH-related information used for the second embodiment means a reference value to be compared with a measured quality of a Pilot field in a downlink DPDCH received by the UE. Further, in Table 5, since the third embodiment does not measure the quality of a received downlink DPDCH, the target SIR is not required. Information on the downlink DPCH and the uplink DPCH is identical to that in the conventional UMTS communication system, so a detailed description of it will not be provided. Then, UE_n, or the UE 2421 forms corresponding channel processors based on the above-stated information, and transmits an MBMS Radio Bearer Setup Complete message to the RNC 2410 (Step 1816). At this point, all UEs that received the MBMS Radio Bearer Setup message in step 1815 must transmit their MBMS Radio Bearer Setup Complete messages.

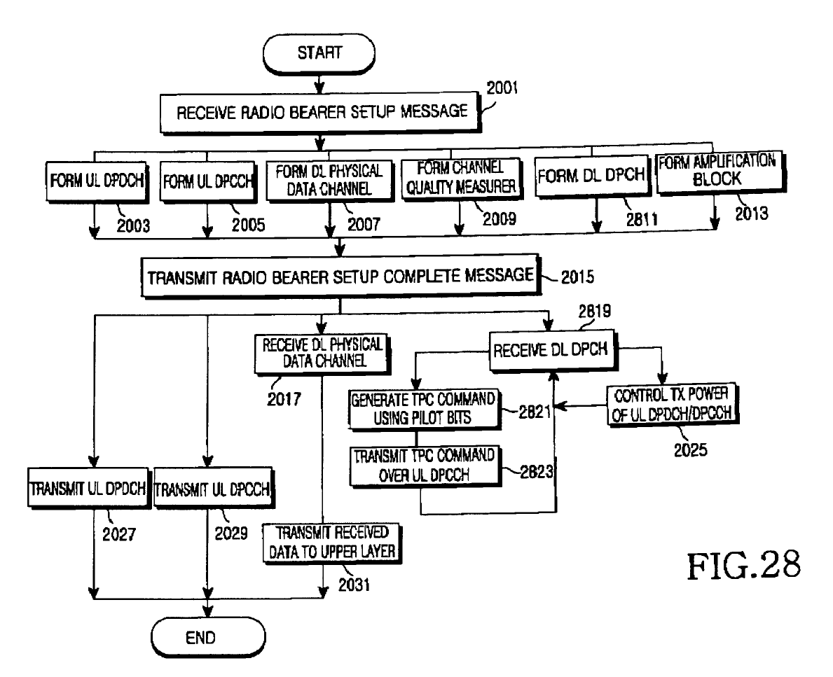

Next, a structure of a UE according to a third embodiment of the present invention will be described with reference to FIG. 27.

FIG. 27 is a block diagram illustrating an internal structure of a UE according to a third embodiment of the present invention. Referring to FIG. 27, the UE is substantially identical in structure to the UE of FIG. 19. However, since the channels used in the third embodiment of the present invention are different from the channels used in the second embodiment of the present invention, corresponding channel processors, i.e., a downlink DPDCH processor 2753 and a downlink DPCH are formed to have a different structure. The other operations are identical, so a detailed description thereof will not be provided.

First, reference will be made to a difference between a UE structure for performing the second embodiment and a UE structure for performing the third embodiment.

(1) The second embodiment uses the downlink informal DPCCH processor 1955, whereas the third embodiment uses a downlink DPCH processor 2755.

(2) The downlink DPDCH processor 1953 used in the second embodiment is different from the downlink DPDCH processor 2753 used in the third embodiment.

(3) In the second embodiment, the channel quality measurer 1957 measures a channel quality using a Pilot field of a downlink DPDCH. However, in the third embodiment, a channel quality measurer 2757 measures a channel quality using a Pilot field of a downlink DPCH.

Now, an operation of a UE will be described with reference to FIG. 27.

First, a description will be made of a downlink DPDCH and a downlink DPCH. An RF signal received from an antenna 1950 is applied to a receiver 1951. The receiver 1951 down-converts the received RF signal into a baseband signal, performs descrambling and demodulation on the baseband signal, and provides its output to the downlink DPDCH processor 2753 and the downlink DPCH processor 2755. The downlink DPDCH processor 2753 performs a series of reception processes such as despreading and channel decoding on the signal provided from the receiver 1952, separates a Data field and a TFCI field by consulting a preset slot format illustrated in FIG. 25, processes data on the Data field depending on the TFCI field, and provides its output to an upper layer. The downlink DPCH processor 2755 performs a series of reception processes such as despreading and channel decoding on the signal provided from the receiver 1951, analyzes a signal on a TPC field by consulting a predetermined slot format illustrated in FIG. 13, and controls transmission power of the amplification block 1910 based on the analyzed TPC signal. In addition, the downlink DPCH processor 2755 provides a signal on a Pilot field to the channel quality measurer 2757. The channel quality measurer 2757 measures SIR of the Pilot field signal provided from the downlink DPCH processor 2755, generates a TPC command by comparing the measured SIR with a preset target SIR value SIR_{target}, and provides the generated TPC command to the uplink DPCCH processor 1923.

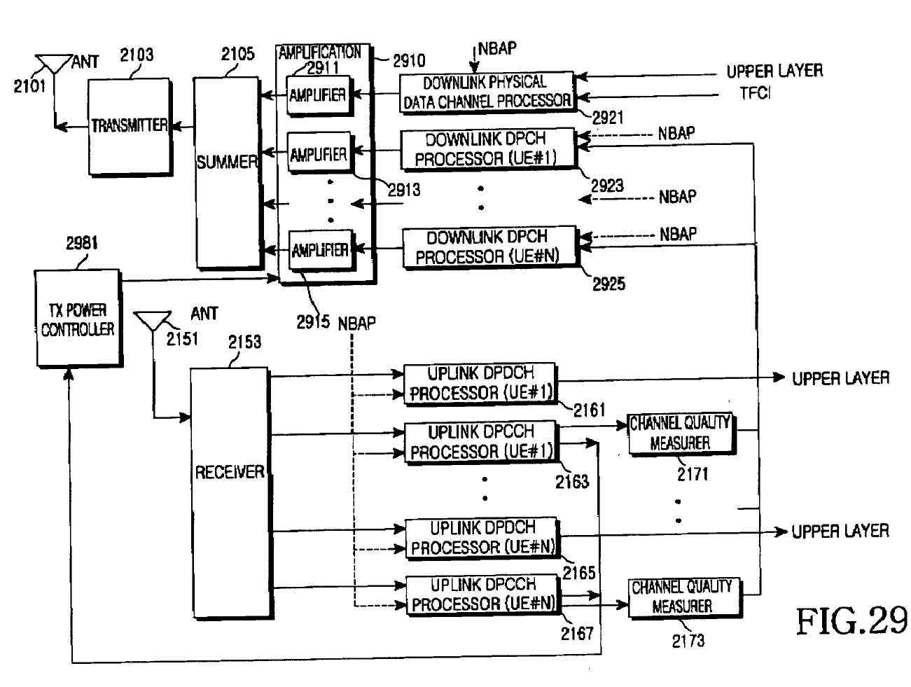

Next, an operating process of the UE 2421 will be described with reference to FIG. 28.

FIG. 28 is a flow chart illustrating an operating process of a UE according to a third embodiment of the present invention. In the following description, the same operations as described in conjunction with FIG. 20 will not be described for simplicity, and the corresponding steps will be represented by the same reference numerals. Upon receiving an MBMS Radio Bearer Setup message in step 2001, the UE 2421 forms the uplink DPDCH processor 1921 in step 2003, the uplink DPCCH processor 1923 in step 2005, the downlink DPDCH processor 2753 in step 2007, the channel quality measurer 2757 in step 2009, the downlink DPCH processor 2755 in step 2811, and the amplification block 1910 in step 2013, based on the information included in the MBMS Radio Bearer Setup message. Here, the information provided to the respective channel processors is defined as follows.

(1) The uplink DPDCH processor 1921: channelization code, channel coding type and slot format information to be used for an uplink DPDCH.

(2) The uplink DPCCH processor 1923: channelization code, channel coding type and slot format information to be used for an uplink DPCCH.

(3) The downlink DPDCH processor 2753: channelization code, channel coding type, slot format information and transport format information to be used for a downlink DPDCH.

(4) The downlink DPCH processor 2755: channelization code, channel coding type, slot format information and transport format information to be used for a downlink DPCH.

(5) The channel quality measurer 2757: target SIR

(6) The amplification block 1910: step size When the respective channel processors, the channel quality measurer 2757 and the amplification block 1910 are formed based on the above-stated information, the UE 2421 transmits a Radio Bearer Setup Complete message to the RNC 2420 in step 2015, and then proceeds to step 2017. Upon receiving a downlink DPDCH and a downlink DPCH in step 2017, the downlink DPDCH processor 2753 processes the received data and transmits the processed data to the upper layer depending on a TFCI value in step 2031. In step 2025, the downlink DPCH processor 2755 controls transmission power of an uplink DPCH by the amplification block 1910 based on TPC bits. In step 2821, the downlink DPCH processor 2755 provides a Pilot signal to the channel quality measurer 2757. In step 2823, the channel quality measurer 2757 generates a TPC command by comparing an SIR value of a Pilot signal with a target SIR, and provides the generated TPC command to the uplink DPCCH processor 1923. The other operations are identical to the operations described in conjunction with FIG. 20, so a detailed description thereof will not be provided.

Next, a structure of a Node B according to a third embodiment of the present invention will be described with reference to FIG. 29.

FIG. 29 illustrates a structure of a Node B for performing an operation according to a third embodiment of the present invention. In the following description, elements identical to the elements of the Node B illustrated in FIG. 21 will be represented by the same reference numerals even in FIG. 29, and a detailed description of them will not be provided for simplicity. Now, reference will be made to a difference between a Node B structure for the second embodiment and a Node B structure for the third embodiment.

(1) The second embodiment uses the downlink informal DPCCH processors 2123˜2125, whereas the third embodiment uses the downlink DPCH processors 2923˜2925.

(2) A slot format applied to the downlink DPDCH processor 2121 used in the second embodiment is different from a slot format applied to the downlink DPDCH processor 2921 used in the third embodiment.

(3) In the second embodiment, the transmission power controller 2181 has a structure illustrated in FIG. 26A. However, in the third embodiment, the transmission power controller 2981 has a structure illustrated in FIG. 26B. Therefore, the second embodiment and the third embodiment control transmission power of the amplification block 2110 and the amplification block 2910, respectively, in different manners.

Meanwhile, the uplink DPDCH processors 2161˜2165, and the uplink DPCCH processors 2163˜2167 operate in the same way in both the second embodiment and the third embodiment, so a detailed description of the operations will not be provided. The downlink DPCH processors 2923˜2925 process control signals and user data transmitted over downlink DPCHs, transmitted by UEs as described in conjunction with FIG. 27. That is, the downlink DPCH processors 2923˜2925 each include a series of elements for processing transmission signals, such as a spreader and a channel coder, and form downlink DPCHs in the slot format illustrated in FIG. 25. The amplification block 2910 amplifies input signals based on an absolute transmission power value provided from the transmission power controller 2981. Here, the amplification block 2910 is comprised of a plurality of amplifiers 2911 and 2913 2915. The amplifiers 2911 and 2913˜2915 are connected to the channel processors 2921 and 2923˜2925, respectively. The amplifiers 2911 and 2913˜2915 amplify outputs of the channel processors 2921 and 2923˜2925 based on a TPC signal from the transmission power controller 2981, respectively.

As described before, in step 1813 of FIG. 18, the Node B 2420 receives an MBMS Radio Link Setup Request message, or an NBAP message, and the MBMS Radio Link Setup Request message includes parameters for forming the respective channels and TPC-related information. The Node B 2420 forms the downlink DPDCH processor 2921, the downlink DPCH processors 2923˜2925, and uplink DPCH processors (including uplink DPDCH processors and uplink DPCCH processors) based on the channel-related information. Then, a transmission/reception operation of the Node B 2420 will be described with reference to FIG. 29.

In describing the transmission/reception operation of the Node B 2420, the same elements as described in conjunction with FIG. 21 will be represented by the same reference numerals, and a detailed description of them will not be provided. In addition, a reception operation of the uplink DPCH processors according to the third embodiment is identical to the reception operation of the uplink DPCH processors according to the second embodiment, so a detailed description thereof will not be provided.

First, channel quality measurers 2171˜2173 each measure SIR values of pilot signals output from the uplink DPCCH processors 2163˜2167, determine TPC commands to be transmitted over downlink DPCHs by comparing the measured SIR values with their predetermined target SIR values, and provide the determined TPC commands to the corresponding downlink DPCH processors 2923˜2925. The transmission power controller 2981 determines whether to increase or decrease transmission power of the downlink DPCHs based on TPC commands output from the uplink DPCCH processors 2163˜2167, and controls transmission power of the amplification block 2910 according to the decision. Here, a process of controlling the transmission power will be described herein below. First, the transmission power controller 2981 determines absolute transmission power values, DPCH_TP_UE_{—1}(x+1)˜DPCH_TP_UE_N(x+1), to be applied to the downlink DPCHs for the UEs for the next transmission power control period, using TPC commands TPC_UE_{—1}˜TPC_UE_N provided from the uplink DPCCH processors 2163˜2167, and Equation (8). The transmission power controller 2981 selects the highest value, worstcaseUE_TP(x+1), among the N absolute transmission power values calculated using Equation (8), and determines absolute transmission power values to be applied to the downlink DPDCH and the downlink DPCHs by adding PO_MBMS to the selected value. Thereafter, the transmission power controller 2981 provides the absolute transmission power values to the amplifiers 2911 and 2913˜2915. Then, the amplifiers 2911 and 2913˜2915 amplify signals provided from the downlink DPDCH processor 2921 and the downlink DPCH processors 2923˜2925 based on the absolute transmission power values provided from the transmission power controller 2981.

Next, a process of transmitting downlink channels will be described. The downlink DPDCH processor 2921 forms user data transmitted from the upper layer in the slot format illustrated in FIG. 25, performs a series of transmission processes such as channel coding and spreading on the user data, and provides its output to the amplification block 2910. At this point, the upper layer may transmit a TFCI value. The downlink DPCH processors 2923˜2925 form TPC commands provided from the channel quality measurers 2171˜2173 in the slot format illustrated in FIG. 25, perform a series of transmission processes such as channel coding and spreading, and provide their outputs to the amplification block 2910. The amplification block 2910 amplifies signals provided from the channel processors under the control of the transmission power controller 2981, and provides its outputs to the summer 2105. The summer 2105 sums up the signals provided from the downlink DPDCH processor 2921 and the downlink DPCH processors 2923˜2925, and provides its output to the transmitter 2103. The transmitter 2103 up-converts a signal output from the summer 2105 into an RF signal, and transmits the RF signal in the air through the antenna 2101.

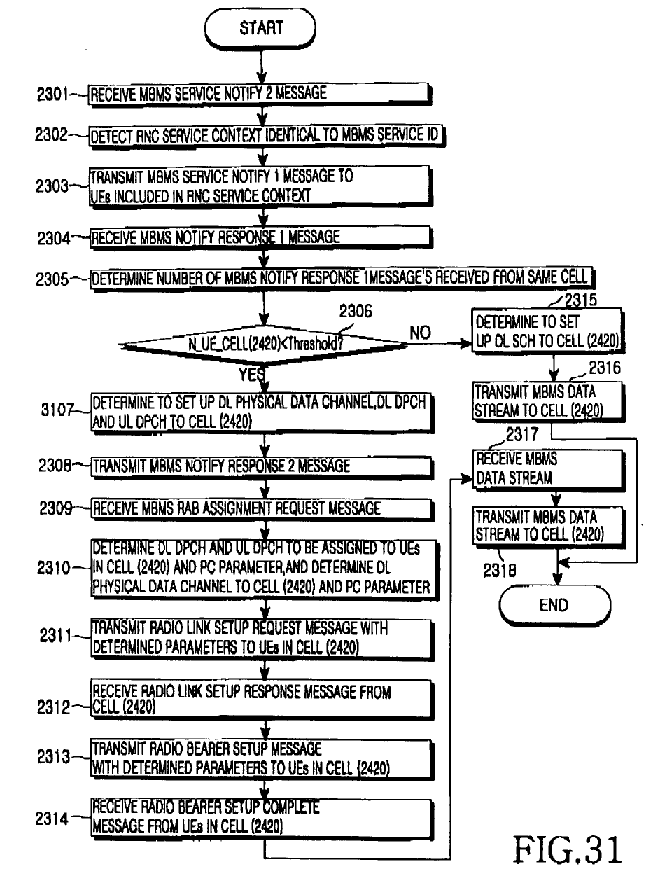

Next, an operating process of the Node B 2420 will be described with reference to FIG. 30.

FIG. 30 is a flow chart illustrating an operating process of a Node B according to a third embodiment of the present invention. In the following description, the same operation as described in conjunction with FIG. 22 will not be described for simplicity, and the corresponding steps will be represented by the same reference numbers. Upon receiving an MBMS Radio Link Setup Request message in step 2201, the Node B 2420 forms the downlink DPDCH processor 2921 in step 2213, the transmission power controller 2981 in step 3009, the N downlink DPCH processors 2923˜2925 in step 2211, the N uplink DPDCH processors 2161˜2165 in step 2203, the N uplink DPCCH processors 2163˜2167 in step 2205, and the N channel quality measurers 2171˜2173 in step 2107, based on the information included in the MBMS Radio Link Setup Request message. Here, the information provided to the respective channel processors is defined as follows.

(1) The uplink DPDCH processors 2161˜2165: channelization code, channel coding type and slot format information to be used for uplink DPDCHs.

(2) The uplink DPCCH processors 2163˜2167: channelization code, channel coding type and slot format information to be used for uplink DPCCHs.

(3) The downlink DPDCH processor 2921: channelization code, channel coding type, slot format information and transport format information to be used for a downlink DPDCH.

(4) The downlink DPCH processors 2923˜2925: channelization code, channel coding type, slot format information and transport format information to be used for downlink DPCHs.

(5) The channel quality measurers 2171˜2173: target SIRs used to measure the qualities of uplink DPCCH pilot signals.

(6) The transmission power controller 2981: PO_MBMS, step size_1˜step size_N. Here, “step size_n” means a step size to be applied to a UE_n.

Thereafter, in step 2115, the Node B 2420 transmits a Radio Link Setup Response message to the RNC 2410 and waits for the next operation. Meanwhile, the receiver 2153 down-converts the received RF signal into a baseband signal, and provides the baseband signal to the corresponding channel processors, i.e., the uplink DPDCH processors 2161˜2165 and the uplink DPCCH processors 2163˜2167. Then, in step 2217, the uplink DPDCH processors 2161˜2165 process the received uplink DPDCH signals, process data using the processed TFCI, and provide the processed data to the upper layer (Step 2227). The uplink DPCCH processors 2163˜2167 extract such control signals as TFCIs, TPCs and Pilots by performing a series of reception processes such as despreading on the provided baseband signal, and then provide the TFCIs to the uplink DPDCH processors 2161˜2165, the TPC commands to the transmission power controller 2981 (Step 3025), and the Pilot signals to the channel quality measurers 2171˜2173. The channel quality measurers 2171˜2173 determine TPC commands to be transmitted over the downlink DPCHs by measuring SIR values of the provided Pilot signals (Step 2221), and transmit the determined TPC commands to the downlink DPCH processors 2923˜2925, respectively (Step 3023). The transmission power controller 2981 determines an absolute transmission power value of the downlink DPDCH and the downlink DPCHs, using the N provided TPC commands and the above-stated formulas, and transmits the determined absolute transmission power value to the amplification block 2910. The amplification block 2910 then controls transmission power depending on the absolute transmission power value output from the transmission power controller 2981 (Step 3031). In addition, the downlink DPCH processors 2923˜2925 form TPC commands provided from the uplink DPCCH processors 2163˜2167 in the slot format illustrated in FIG. 25, perform a series of transmission processes such as channel coding and spreading, and provide their outputs to the amplification block 2910 (Step 3033). Further, the downlink DPDCH processor 2921 converts such control signals as MBMS stream and TFCI provided from the upper layer in accordance with the slot format of FIG. 25, performs a series of transmission processes such as channel coding and spreading, and provides its output to the amplification block 2910 (Step 3035). The other operations are identical to the operations described in conjunction with FIG. 22, so a detailed description thereof will not be provided.

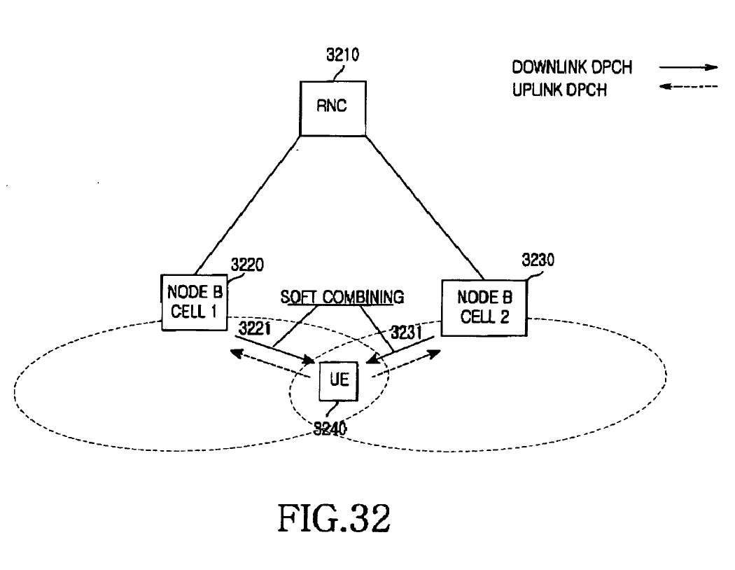

Next, an operation of the RNC 2410 supporting the third embodiment of the present invention will be described with reference to FIG. 31.

FIG. 31 is a flow chart illustrating an operating process of an RNC according to a third embodiment of the present invention. In the following description, the same operation as described in conjunction with FIG. 23 will not be described for simplicity, and the corresponding steps will be represented by the same reference numerals. Upon receiving a second MBMS Service Notify message in step 2301, the RNC 2410 proceeds to step 2302. In step 2302, the RNC 2410 searches an RNC Service Context identical to an MBMS Service ID included in the second MBMS Service Notify message, and then proceeds to step 2303. In step 2303, the RNC 2410 transmits a first MBMS Service Notify message to UEs included in the RNC Service Context, and then proceeds to step 2304. Upon receiving first MBMS Notify Response messages from several UEs in step 2304, the RNC 2410 proceeds to step 2305. In step 2305, the RNC 2410 determines the number of UEs in the same cell, which have transmitted the messages, and then proceeds to step 2306. For the sake of convenience, the following description will be made with reference to a cell (or Node B) 2420. If the number of UEs located in the cell 2420 is greater than or equal to a Threshold, a downlink shared channel is set up. Since the downlink shared channel is not related to the present invention, a detailed description of it will not be provided.

However, as a result of the determination in step 2306, if the number of UEs located in the cell 2420 is less than the Threshold, the RNC 2410 sets up a downlink DPDCH, downlink DPCHs and uplink DPCHs in step 3107, and then proceeds to step 2308. Here, after determining the types of the channels to be set up to the cell 2420, the RNC 2410 transmits a second MBMS Notify Response message to a core network (CN) in step 2308, and then proceeds to step 2309. In step 2309, the RNC 2410 receives an MBMS RAB Assignment Request message, and then proceeds to step 2310. In step 2310, the RNC 2410 determines transmission resources of downlink DPCHs and uplink DPCHs to be assigned to the UEs located in the cell 2420, and transmission resources to be applied to the downlink DPDCH, determines TPC parameters to be applied to the downlink and uplink channels, and then proceeds to step 2311. The RNC 2410 transmits an MBMS Radio Link Setup Request message with the determined parameters to a Node B managing the cell 2420 in step 2311, and receives a Radio Link Setup Response message indicating completed setup of the downlink DPDCH in step 2312, and then proceeds to step 2313. In step 2313, the RNC 2410 transmits MBMS Radio Bearer Setup messages with the determined parameters to the respective UEs, and then proceeds to step 2314. Here, the downlink DPDCH information included in the MBMS Radio Bearer Setup messages for all UEs is identical to each other. However, the downlink DPCH, uplink DPDCH and uplink DPCCH information included in the MBMS Radio Bearer Setup messages for the UEs is different from each other.

In step 2314, the RNC 2410 receives an MBMS Radio Bearer Setup Complete message from each UE, and then proceeds to step 2317. Upon receiving an MBMS data stream in step 2317, the RNC 2410 transmits the MBMS data stream to the Node B managing the cell 2420 in step 2318. Here, the steps 2317 and 2318 are continuously performed until the corresponding service is ended.

Next, reference will be made to efficient downlink transmission power control during a soft handover (hereinafter, referred to as “SHO”) according to a third embodiment of the present invention.

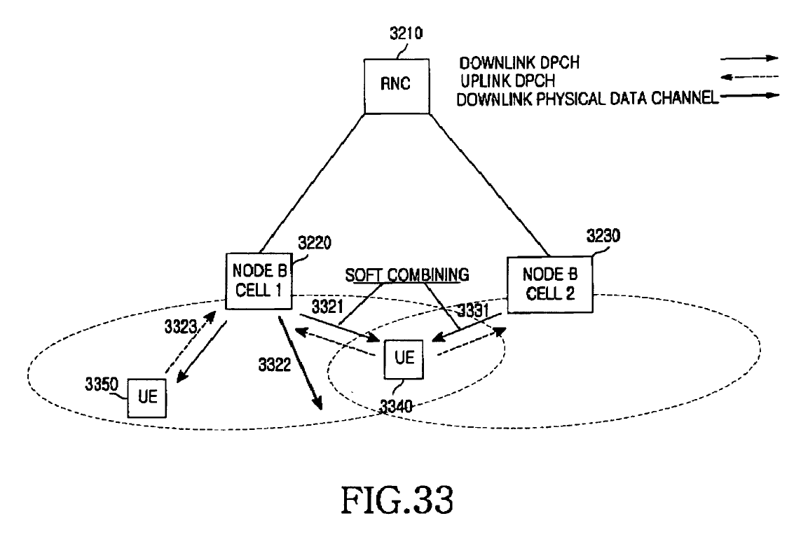

First, transmission power control during a general SHO will be described with reference to FIG. 32.

FIG. 32 schematically illustrates transmission power control during a general SHO. Referring to FIG. 32, the term “SHO” refers to an operation in which a certain UE 3240 receives downlink DPCHs transmitted from cell #1 3220 and cell #2 3230 at a boundary region of a plurality of cells, e.g., the cell #1 3220 and the cell #2 3230, and performs soft combining on the received downlink DPCHs. It is possible to reduce transmission power of the downlink DPCHs through the soft combining. For example, let's say that the cell #1 3220 must use transmission power of 10 dB when the downlink DPCH is transmitted from only the cell #1 3220. In this case, when the downlink DPCHs are transmitted from both the cell #1 3220 and the cell #2 3230, the cell #1 3220 is allowed to use transmission power of about 5 dB.

More specifically, the UE 3240 located in an SHO region soft-combines a pilot field signal on a downlink DPCH 3221 transmitted by the cell #1 3220 with a pilot field signal on a downlink DPCH 3231 transmitted by the cell #2 3230, and then measures SIR of the soft-combined pilot field signal. The UE 3240 compares the measured SIR value with a predetermined target SIR value, and transmits a TPC command over uplink DPCHs based on the comparison result. That is, a soft combining gain obtained by the soft combining is reflected in generation of a TPC command.

In the third embodiment of the present invention, UEs receive a downlink DPCH and a downlink DPDCH, and determines a TPC command by measuring a pilot signal on a Pilot field in the downlink DPCH. Therefore, if the downlink DPDCH is transmitted from only one cell and the downlink DPCH is transmitted from a plurality of cells, a transmission power controller 2981 of a Node B may miscalculate transmission power of the downlink DPDCH. A method for preventing miscalculation of transmission power will be described herein below.

First, if a downlink DPDCH signal and a downlink DPCHsignal are transmitted from the same cell, the third embodiment of the present invention will correctly operate, so a detailed description of this case will not be provided. Otherwise, if a downlink DPDCH signal is transmitted from only one cell and a downlink DPCH signal is transmitted from a plurality of cells, a transmission power control operation will be described with reference to a fourth embodiment of the present invention.

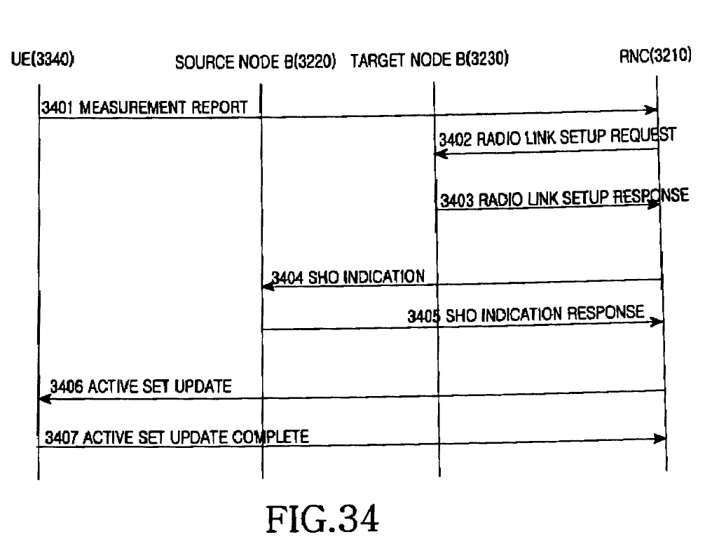

FIG. 33 schematically illustrates a transmission power control process during a soft handover according to a fourth embodiment of the present invention. Referring to FIG. 33, a UE 3340 is located in a boundary region of a cell #1 3220 and a cell #2 3230, receives a downlink DPCH 3321 from the cell #1 3220 and a downlink DPCH 3331 from the cell #2 3230, and performs soft combining on the received downlink DPCHs 3321 and 3331. Further, the UE 3340 receives a downlink DPDCH 3322 from the cell #1 3220. The UE 3340 soft-combines pilot signals on the downlink DPCH 3321 and the downlink DPCH 3331, measures SIR of the soft-combined pilot signal, and compares the measured SIR value with a preset target SIR value. Based on the comparison result, the UE 3340 transmits a TPC command TPC_3340 over an uplink DPCH. At this point, a UE 3350 existing in the cell #1 3220 also receives the same downlink DPDCH 3322, measures SIR of a pilot field in a downlink DPCH 3323, compares the measured SIR with the target SIR, and transmits a TPC command TPC_3350 over an uplink DPCH based on the comparison result. Then, the transmission power controller 2981 of the Node B calculates worstcaseUE_TP using the TPC_3340, the TPC_3350 and Equation (8). In this case, if the UE 3340 performing SHO is a worstcase UE, TP_MBMSCH(x+1) is calculated through TP_DPCH(x+1) of the UE 3340. However, since TP DPCH(x+1) is calculated on condition of soft combining, it cannot correctly reflect a state of the downlink DPDCH which doest not undergo soft combining, so it is necessary to correct a soft combining gain.

More specifically, when transmission power control on a channel (or downlink DPCH) that currently undergoes soft combining and a channel (or downlink DPDCH) that does not undergo soft combining is performed on the basis of the channel that undergoes soft combining, transmission power of the channel that does not undergo soft combining should be set relatively higher. That is, although the channel that is subject to soft combining needs transmission power of 5 dB, the channel that is not subject to soft combining needs transmission power higher than 5 dB.

Therefore, in order to solve the SHO problem that may occur in the third embodiment of the present invention, the fourth embodiment of the present invention assigns unique power offsets (POs) to UEs located in an SHO region, and this is called “PO_MBMS_SHO.” PO_MBMS_SHO should be set higher than PO_MBMS, and its value must be determined taking broadness of the SHO region into consideration. The fourth embodiment is identical to the third embodiment except a method of calculating TP_MBMSCH(x+1). Herein, only a difference between the fourth embodiment and the third embodiment will be described.

$$TP\_MBMSCH ( x + 1 ) = worst case UE\_TP ( x + 1 ) \_Embodiment \#4 worstcaseUE\_TP ( x + 1 ) = MAX [ DPCH\_TP \_UE \_ 1 ( x + 1 ) + PO\_ 1 \_Embodiment \#4 , … , DPCH\_TP \_UE \_N ( x + 1 ) + PO\_N \_Embodiment \#4 ] PO\_n \_Embodiment \#4 = PO\_MBMS \_SHO , if UE\_n is in SHO region Else PO\_n \_Embodiment \#4 = PO\_MBMS \qquad Equation ( 10 )$$

DPCH_TP_UE_n(x+1) of Equation (10) can be calculated through Equation (8).

Further, TP_MBMSCH(x+1) can be calculated more simply using Equation (11) below.

MBMSCH_{—}TP(x+1)=worstcaseUE_{—}TP(x+1)+PO_Embodiment#4

PO_Embodiment#4=PO_{—}MBMS, if worstcase UE is not in SHO region

Else

PO_Embodiment#4=PO_{—}MBMS Equation (11)

In Equation (11), if worstcaseUE is located in the SHO region, PO_MBMS_SHO is applied, and if worstcase UE is not located in the SHO region, the PO_MBMS is applied.

Further, TP_MBMSCH(x+1) can be calculated more simply using Equation (12) below.

MBMSCH_{—}TP(x+1)=worstcaseUE_{—}TP(x+1)+PO_{—}MBMS, if all UEs are not in SHO region

MBMSCH_{—}TP(x+1)=worst case UE_{—}TP(x+1)+PO_{—}MBMS_{—}SHO, if any UE is in SHO region Equation (12)

In Equations (10), (11) and (12), the “UE located in an SHO region” means a UE which receives downlink DPCHs from a plurality of cells and a downlink DPDCH from one cell. Therefore, the UEs that receive downlink DPDCHs from a plurality of cells, though they receive downlink DPCHs from a plurality of cells, do not correspond to the UE located in an SHO region.

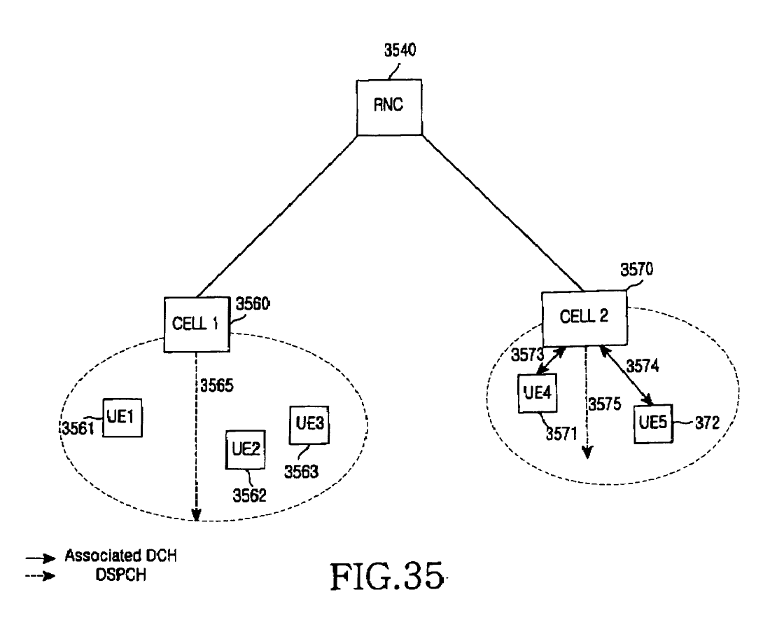

Meanwhile, the fourth embodiment is identical in operation to the third embodiment except that Equation (10), (11) or (12) is used instead of Equation (8). However, in order to apply Equation (10), (11) or (12), the Node B should be able to recognize whether a given UE is located in the SHO region. To this end, in the fourth embodiment of the present invention, if a given UE enters the SHO region, an RNC indicates this fact to the Node B. This will be described with reference to FIG. 34.

FIG. 34 is a flow diagram schematically illustrating a process of indicating by an RNC to a Node B that a UE enters an SHO region according to a fourth embodiment of the present invention. Referring to FIG. 34, a UE 3340 transmits a Measurement Report message to an RNC 3210 (Step 3401). The Measurement Report message includes a measured power level of a common pilot channel (CPICH) received from neighboring cells. The UE 3340 can previously receive a list of cells to be measured and scrambling code information, when initially setting up a call or setting up signaling. In addition, the UE 3340 can transmit a Measurement Report message when a power level of CPICH received from a given cell is higher than a power level of CPICH received from a current cell. Upon receiving the Measurement Report, the RNC 3210 can recognize the fact that the UE 3340 has entered the SHO region, and determine to set up a downlink transport channel to a target cell. In this case, the RNC 3210 transmits a Radio Link Setup Request message with downlink DPCH and uplink DPCH information to a Node B 3230 of the target cell (Step 3402). Upon receiving the Radio Link Setup Request message, the target Node B 3230 forms a downlink channel processor and an uplink channel processor based on the information included in the received Radio Link Setup Request message, and transmits a Radio Link Setup Response message to the RNC 3210 (Step 3403). The process in steps 3401 to 3403 are already defined in the existing UMTS communication system, and messages to be used in steps 3404 and 3405 should be newly defined to support the fourth embodiment of the present invention.

After setting up a downlink DPCH and an uplink DPCH to the target cell 3230, i.e., upon receiving the Radio Link Setup Response message, the RNC 3210 transmits an SHO Indication message to a source Node B 3220 (Step 3404). The SHO Indication message includes ID of the UE 3340, Activation Time, and PO_MBMS_SHO. PO_MBMS_SHO may be transmitted to the source Node B 3220 in step 1813 of FIG. 18. The source Node B 3220 recognizes that the UE 3340 has entered the SHO region, using ID of the UE 3340 included in the SHO Indication message, and calculates TP_MBMSCH(x+1) from Activation Time using PO_MBMS_SHO. After receiving the SHO Indication message and forming a transmission power controller, the source Node B 3220 transmits an SHO Indication Response message to the RNC 3210 in order to indicate this fact. The RNC 3210 transmits an Active Set Update message to the UE 3340 (Step 3406). The Active Set Update message includes ID of the target cell 3230, information on a downlink DPCH to be set up to the target cell 3230, and Activation Time. Upon correctly receiving the Active Set Update message, the UE 3340 forms a downlink DPCH processor, and then transmits an Active Set Update Complete message to the RNC 3210 (Step 3407). From Activation Time, the UE 3340 receives a downlink DPCH even from the target cell 3230, and soft-combines the received downlink DPCH with a downlink DPCH received from the source cell 3220.

As described above, in the third embodiment of the present invention, a single downlink DPDCH is assigned to MBMS UEs existing in the same cell in order to maximize channelization code resource efficiency and transmission power resource efficiency by providing an exclusive MBMS service which performs power control according to a state of each radio link of the MBMS UEs, while providing MBMS data. That is, based on the number of MBMS UEs existing in the same cell, a downlink DPDCH and associated dedicated channel (ADCHs) for MBMS UEs are all set up, or only the downlink DPDCH is set up. Here, it should be noted that the ADCH refers to both a downlink DPCH and an uplink DPCH assigned to the MBMS UEs.

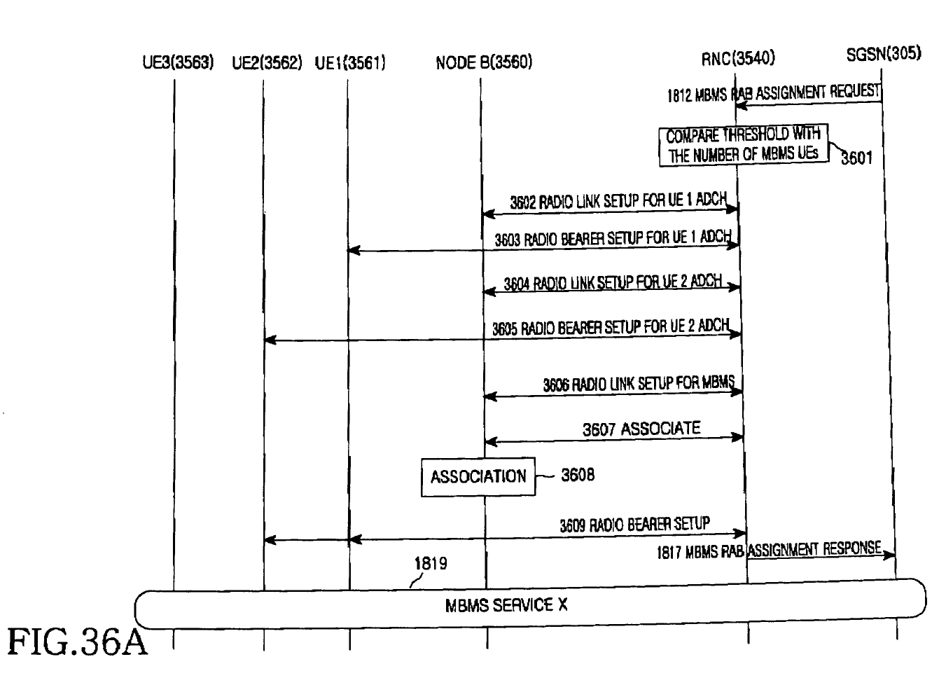

Now, a method of determining a type of channels to be assigned to MBMS UEs for an MBMS service according to the number of the MBMS UEs in the same cell will be described with reference to FIG. 35.

FIG. 35 schematically illustrates a network structure for determining a type of channels to be dynamically assigned based on the number of MBMS UEs according to a fifth embodiment of the present invention. Referring to FIG. 35, if it is assumed that a Threshold value indicating the number of channels, a type of which is a downlink shared physical channel (DSPCH), to be assigned to MBMS UEs existing in a certain cell is set to 3, then a cell #1 3560 assigns only DSPCH 3565, since three MBMS UEs exist in the cell #1 3560. However, a cell #2 3570 assigns DSPCH 3575 and ADCHs (Associated Dedicated Channels) 3573 and 3574 to MBMS UEs, since two MBMS UEs exist in the cell #2 3570. Here, the reason for differently determining the types of the channels assigned to provide the MBMS service according to the number of MBMS UEs existing in the cell is because when the number of MBMS UEs is greater than or equal to the Threshold value, power control efficiency will be probably low, so it is not necessary to set up ADCHs for separately controlling transmission power of the MBMS UEs. In contrast, if the number of MBMS UEs existing in the cell is less than the Threshold value, it is possible to increase channel resource efficiency through power control, so the ADCHs are set up to separately perform power control on the MBMS UEs.

If a new MBMS UE enters the cell #2 3570 at a certain time point making the number of MBMS UEs greater than or equal to the Threshold value, the cell #2 3570 must deactivate the ongoing power control on the MBMS UEs. That is, the cell #2 3570 must release the ADCHs assigned for separate power control on the MBMS UEs, and assign DSPCH to perform common power control. Therefore, in the fifth embodiment of the present invention, the ADCHs and the DSPCH are separately activated or deactivated to increase power control efficiency according to the number of MBMS UEs. Particularly, the fifth embodiment of the present invention proposes such new NBAP messages as Associate Request message, Associate Response message, Disassociate Request message and Disassociate Response message, and provides a method of increasing power control efficiency by activating and deactivating power control on DSPCH using the newly proposed NBAP messages.

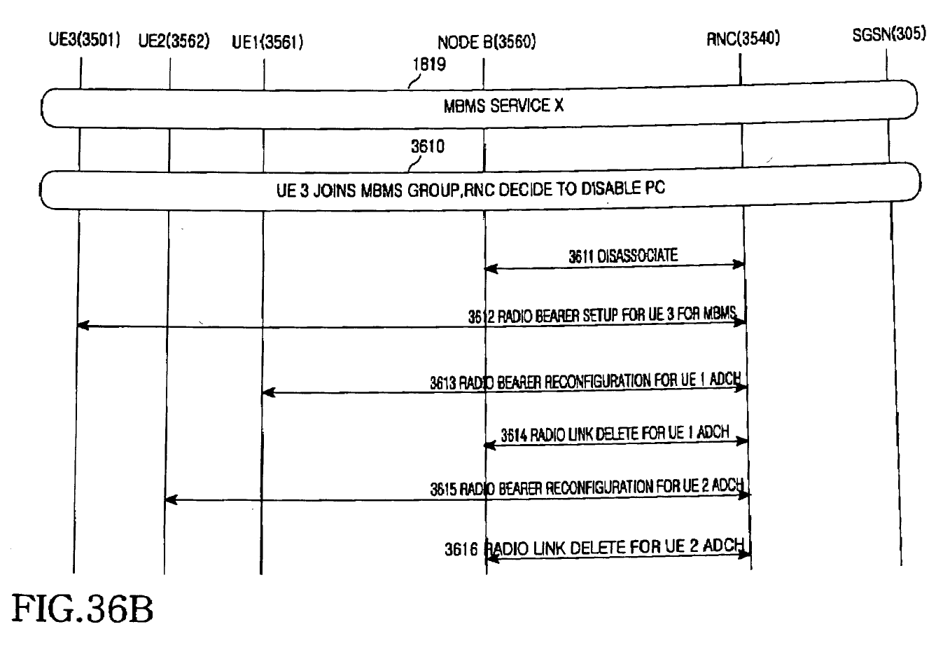

Now, a process of providing an MBMS service according to a fifth embodiment of the present invention will be described with reference to FIGS. 36A and 36B.

FIGS. 36A and 36B are flow diagrams illustrating a process of providing an MBMS service in a mobile communication system according to a fifth embodiment of the present invention. Before a description of FIGS. 36A and 36B, it should be noted that the same reference numbers as those used in FIG. 18 represent the same operation as performed in FIG. 18.

Referring to FIG. 36A, in step 1812, an SGSN 305 transmits to an RNC 3540 an MBMS RAB Assignment Request message in order to set up RAB, or a transmission path for transmitting an MBMS data stream (Step 1812). The MBMS RAB Assignment Request message includes MB-SC Service ID and QoS information. Upon receiving the MBMS RAB Assignment Request message, the RNC 3540 determines a cell ID and UE IDs existing in its RNC Service Context, prepares to set up a radio link to the cell, or the Node B 3560 according to the received QoS information, and transmits information on the RNC Service ID. In this manner, the RNC 3540 simultaneously transmits information on the radio links, which was conventionally separately transmitted to the UEs for the MBMS service, through the RNC Service ID. The RNC 3540 determines the number of UEs belonging to the cells stored in the RNC Service Context, i.e., determines the number of MBMS UEs, and determines whether to assign a radio bearer (or a channel type) of the corresponding cell as DSPCH or ADCH (Step 3601). For example, as mentioned above, if the number of MBMS UEs existing in the same cell is greater than or equal to Threshold, the RNC 3540 assigns DSPCH. If, however, the number of MBMS UEs is less than Threshold, the RNC 3540 assigns ADCH. It will be assumed in FIG. 36A that the number of MBMS UEs existing in the corresponding cell, or the Node B 3560 is 2; UE1 3561 and UE2 3562.

The RNC 3540 assigns ADCHs to the two MBMS UEs, or the UE1 3561 and the UE2 3562, since the number, 2, of the MBMS UEs existing in the Node B 3560 is less than Threshold. Therefore, the RNC 3540, together with the Node B 3560, performs a Radio Link Setup process for assigning ADCH to the UE1 3561 (Step 3602), and performs a Radio Bearer Setup process for assigning ADCH to the UE2 3562 (Step 3603). In the Radio Link Setup process, a Radio Link Setup Request message and a Radio Link Setup Response message are exchanged between the RNC 3540 and the Node B 3560. The Radio Link Setup Request message and the Radio Link Setup Response message include several information elements (IEs), and only the information elements needed in the present invention will be described herein.

First, an IE included in the Radio Link Setup Request message includes a CRNC (Control RNC) Communication Context ID (hereinafter, referred to as “CRCC ID”), and the CRCC ID serves as a UE ID used to identify a UE by the RNC. In addition, one UE can have a plurality of radio links, and the radio links are identified by Radio Link IDs. The radio links each include such radio link information as downlink channelization code, uplink channelization code, downlink transport format information, and uplink transport format information. In the fifth embodiment of the present invention, the RNC 3540 sets up ADCH to be used by the UE1 3561, using the Radio Link Setup Request message, so the radio link information for the ADCH for the UE1 3561 is included in the Radio Link Setup Request message. Upon receiving the Radio Link Setup Request message from the RNC 3540, the Node B 3560 forms a transmitter and a receiver in accordance with the radio link information included in the Radio Link Setup Request message, and transmits a Radio Link Setup Response message to the RNC 3540 in reply to the received Radio Link Setup Request message. An IE included in the Radio Link Setup Response message includes a Node B Communication Context ID (hereinafter, referred to as “NBCC ID”), and the NBCC ID serves as a UE ID used to identify a UE by the Node B. From now on, the RNC uses the NBCC ID in transmitting a message related to the UE to the Node B, and the Node B uses the CRCC ID in transmitting a message related to the UE to the RNC.

After the Radio Link Setup process between the RNC 3540 and the Node B 3560, the RNC 3540, together with the UE1 3561, performs the Radio Bearer Setup process (Step 3603). In the Radio Bearer Setup process, a Radio Bearer Setup message and a Radio Bearer Setup Complete message are exchanged between the RNC 3540 and the UE1 3561. The Radio Bearer Setup message includes radio bearer information for ADCH to be used by the UE1 3561, like the radio link information transmitted from the RNC 3540 to the Node B 3560 in step 3602, i.e., such radio link bearer information as downlink channelization code, uplink channelization code, downlink transport format information and uplink transport format information. Therefore, the UE1 3561 forms a transmitter and a receiver according to the radio bearer information included in the Radio Bearer Setup message, and transmits a Radio Bearer Setup Complete message to the RNC 3540 in reply to the received Radio Bearer Setup message.

ADCH assignment to the UEI 3561 is completed by performing steps 3602 and 3603, and ADCH assignment to another MBMS UE, or the UE2 3562 existing in the Node B 3560 is also completed by performing steps 3604 and 3605. The steps 3604 and 3605 are substantially identical in operation to the steps 3602 and 3603 except that the UE2 3562 substitutes for UE1 3561, so a detailed description thereof will not be provided.

After the ADCH assignment to the UE1 3561 and the UE2 3562 is completed, a Radio Link Setup process for assigning DSPCH for transmitting an MBMS data stream is performed between the RNC 3540 and the Node B 3560 (Step 3606). In the Radio Link Setup process, a Radio Link Setup Request message and a Radio Link Setup Response message are exchanged between the RNC 3540 and the Node B 3560. The Radio Link Setup Request message for assigning the DSPCH is identical to the Radio Link Setup Request message for assigning the ADCH except that it does not include uplink-related information as it is used to assign the DSPCH. As the step 3606 is completed, a plurality of radio links such as ADCHs for the UE1 3561 and the UE2 3562, and one DSPCH are set up in the Node B 3560. Since the ADCHs are used to control transmission power of the DSPCH, the RNC 3540 should notify this fact to the Node B 3560. That is, the RNC 3540 should notify the Node B 3560 that the radio links that should be considered to determine transmission power, MBMSCH_TP, of the DSPCH by the transmission power controller 2981 of FIG. 29 are ADCHs for the UE1 3561 and the UE2 3652. Therefore, the fifth embodiment of the present invention newly proposes an Associate process (Step 3607). In the Associate process, an Associate Request message and an Associate Response message are exchanged between the RNC 3540 and the Node B 3560. An IE included in the Associate Request message includes message type information, DSPCH information and ADCH information. The DSPCH information includes NBCC ID and Radio Link ID, and the ADCH information also includes NBCC ID and Radio Link ID.

Upon receiving the Associate Request message from the RNC 3540, the Node B 3560 is set to connect MBMSCH_TP of the transmission power controller 2981 of FIG. 29 to an amplification block for a radio link indicated by the NBCC ID and the Radio Link ID among DSPCH information included in the Associate Request message. In addition, the Node B 3560 is set to connect TPC commands TPC_UE_I TPC_UE_N for uplink DPCCH receivers for the radio links indicated by NBCC ID and Radio Link ID among the ADCH information included in the Associate Request message, to the transmission power controller 2981. Such an operation of associating DSPCH for power control with ADCHs to be used for actual power control will be defined as “Association” (Step 3608).

After the Association process, the RNC 3540 performs a Radio Bearer Setup process for transmitting radio bearer information for DSPCH to the UE1 3561 and the UE2 3562 desiring to receive the MBMS service (Step 3609). In the Radio Bearer Setup process, a Radio Bearer Setup message and a Radio Bearer Setup Complete message are exchanged in the above-mentioned manner, and a detailed description thereof will be made later. Thereafter, the RNC 3540 transmits an MBMS RAB Assignment Response message to the SGSN 305 in reply to the MBMS RAB Assignment Request message. Upon receiving the MBMS RAB Assignment Response message, the SGSN 305 transmits an MBMS data stream received from the MB-SC over the set DSPCH.

While an MBMS service X is being provided over DSPCH as described in conjunction with FIG. 36A, if a UE3 3563 requests the MBMS service X as illustrated in FIG. 36B making the number of MBMS UEs receiving the MBMS service X be equal to Threshold, then the RNC 3540 determines not to perform power control on the DSPCH which transmits a data stream for the MBMS service X (Step 3610). That is, the RNC 3540 must release Association between the DSPCH and the ADCHs for providing the MBMS service, and release the ADCHs set up to the UE1 3561 and the UE2 3562.

Since the number of MBMS UEs existing in the Node B 3560 is equal to Threshold, the RNC 3540 performs a Disassociate process together with the Node B 3560 (Step 3611). In the Disassociate process, the RNC 3540 exchanges a Disassociate Request message and a Disassociate Response message with the Node B 3560. The Disassociate Request message includes NBCC ID and Radio Link ID for DSPCH for releasing the Association. If transmission power of DSPCH to be applied during non-power control is not transmitted to the Node B 3560, the RNC 3540 may include a transmission power value of DSPCH to be newly applied to the Node B 3560 in the Disassociate Request message before transmission. Upon receiving the Disassociate Request message form the RNC 3540, the Node B 3560 sets MBMSCH_TP of the transmission power controller 2981 of FIG. 29 to become a DSPCH transmission power value to be applied when no power control is performed. That is, MBMSCH_TP described in the third embodiment of the present invention is calculated using Equation (13) rather than Equation (9).

MBMSCH_{—}TP(x+1)=Static Downlink transmission power for DSPCH Equation (13)

Further, the Node B 3560 prevents TPC commands TPC_UE_1˜TPC_UE_N for the ADCHs from being no longer provided to the transmission power controller 2981. Thereafter, the Node B 3560 transmits a Disassociate Response message to the RNC 3540. After the Disassociate process between the Node B 3560 and the RNC 3540 is completed, the RNC 3540 performs a Radio Bearer Setup process for providing an MBMS service to the UE3 3563 (Step 3612). That is, the RNC 3540 notifies radio bearer information for DSPCH to the UE3 3563 so that the UE3 3563 can receive the DSPCH. Thereafter, the RNC 3540 performs a Radio Bearer Reconfiguration process together with the UE1 3561 (Step 3613). In the Radio Bearer Reconfiguration process, the RNC 3540 releases transmission/reception resources, or a transmitter and a receiver formed to transmit and receive the currently set ADCH by the UE1 3561, in order not to no longer use the currently set ADCH.

Thereafter, the RCN 3540, together with the Node B 3560, performs a Radio Link Delete process on ADCH for the UE1 3561 (Step 3614). In the Radio Link Delete process, a Radio Link Delete Request message is transmitted from the RNC 3540 to the Node B 3560 and a Radio Link Delete Response message is transmitted from the Node B 3560 to the RNC 3540. The Radio Link Delete Request message includes radio link information for ADCH for the UE1 3561 so that the Node B 3560 can release a radio link for ADCH for the UE1 3561. Thereafter, the RNC 3540 performs a Radio Bearer Reconfiguration process together with the UE2 3562 (Step 3615), and then performs a Radio Link Delete process on ADCH for the UE2 3562 (Step 3616). The steps 3615 and 3616 are identical in operation to the steps 3613 and 3614, so a detailed description thereof will not be provided.

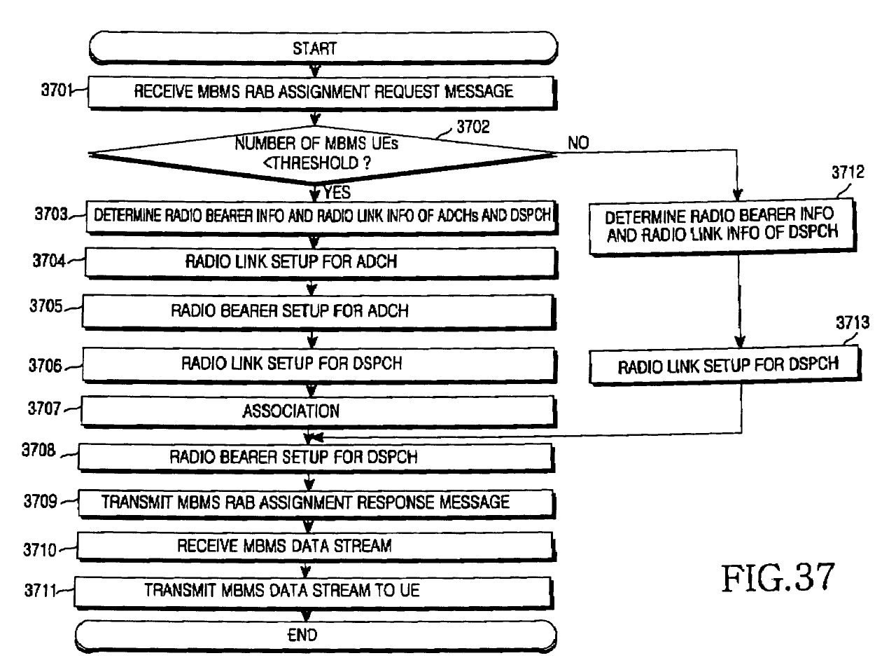

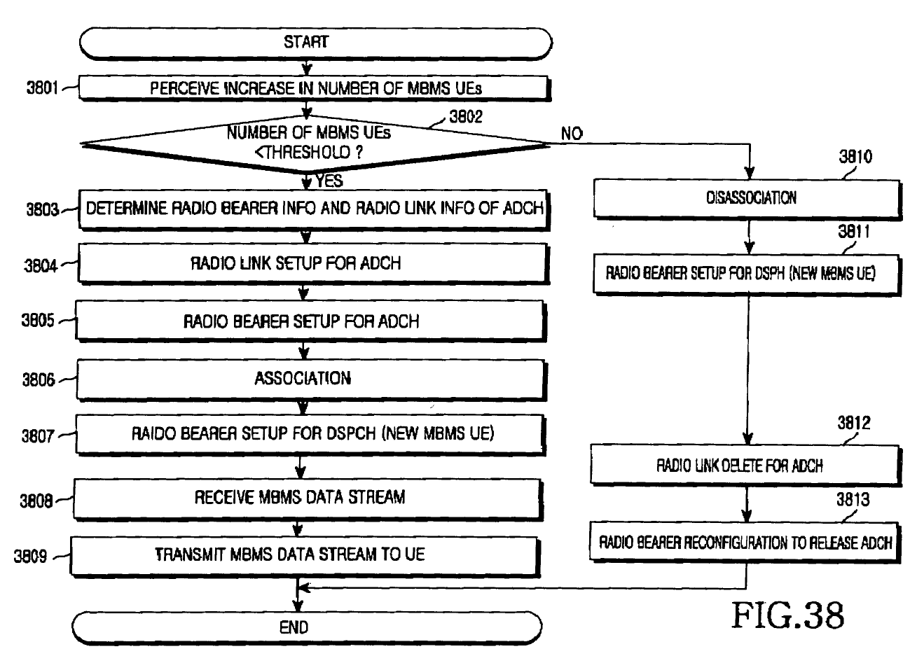

Next, an operation of the RNC 3540 will be described with reference to FIGS. 37 and 38.

FIG. 37 is a flow chart illustrating an operating process of the RNC shown in FIG. 36A according to a fifth embodiment of the present invention. Referring to FIG. 37, in step 3701, the RNC 3540 receives an MBMS RAB Assignment Request message for an MBMS service from the SGSN 305, and then proceeds to step 3702. Upon receiving the MBMS RAB Assignment Request message, the RNC 3540 determines a list and the number of UEs requesting the MBMS service, i.e., MBMS UEs existing in a given cell X, or the Node B 3560. In step 3702, the RNC 3540 determines whether the number of MBMS UEs existing in the Node B 3560 is less than a preset Threshold value. As a result of the determination, if the number of MBMS UEs existing in the Node B 3560 is less than the Threshold value, i.e., if the UE1 3561 and the UE2 3562 receive the MBMS service, then the RNC 3540 proceeds to step 3703. In step 3703, the RNC 3540 determines ADCH-related transmission resource information to be assigned to the UE1 3561 and the UE2 3562 existing in the Node B 3560, i.e., radio bearer information, radio link information and DSPCH-related transmission resource information, and then proceeds to step 3704.

In step 3704, the RNC 3540, together with the Node B 3560, performs a Radio Link Setup process on ADCH to be assigned to a given MBMS UE, i.e., a UE1 3561 or UE2 3562, and then proceeds to step 3705. In step 3705, the RNC 3540 performs a Radio Bearer Setup process on ADCH to be assigned to the UE1 3561 or the UE2 3562, and then proceeds to step 3706. In step 3706, the RNC 3540 performs a Radio Link Setup process on DSPCH assigned to provide the MBMS service, and then proceeds to step 3707. The Radio Link Setup process and the Radio Bearer Setup process in the steps 3704 to 3706 are performed in the same way as described in conjunction with FIG. 36A, so a detailed description thereof will not be provided. In step 3707, the RNC 3540 performs an Association process together with the Node B 3560, and then proceeds to step 3708. In the Association process, an Associate Request message and an Associate Response message are exchanged between the RNC 3540 and the Node B 3560 as described in conjunction with FIG. 36A. Here, NBCC ID and Radio Link ID acquired in the Radio Link Setup process for the DSPCH in the step 3706, i.e., NBCC ID and Radio Link ID designating the DSPCH are inserted in DSPCH information of the Associate Request message. Further, NBCC ID and Radio Link ID of each ADCH acquired in the Radio Link Setup process for the ADCH in the step 3704 are inserted in ADCH information of the Associate Request message.

After completing the Association process in step 3707, the RNC 3540 performs in step 3708 a Radio Bearer Setup process on the DSPCH together with the MBMS UEs existing in the Node B 3560, i.e., the UE1 3561 and the UE2 3562, and then proceeds to step 3709. In the Radio Link Bearer Setup process for DSPCH, the RNC 3540 transmits radio bearer information for the DSPCH to the UE1 3561 and the UE2 3562 so that the UE1 3561 and the UE2 3562 can set up a radio bearer for the DSPCH. In step 3709, the RNC 3540 transmits an MMS RAB Assignment Response message to the SGSN 305 in reply to the MBMS RAB Assignment Request message, and then proceeds to step 3710. In step 3710, the RNC 3540 receives an MBMS data stream provided by the MB-SC from the SGSN 305, and then proceeds to step 3711. In step 3711, the RNC 3540 transmits the received MBMS data stream to the UEI 3561 and the UE2 3562 using the set DSPCH, and then ends the process.

However, if the number of MBMS UEs existing in the Node B 3560 is greater than or equal to a present Threshold value in step 3702, i.e., if the MBMS UEs existing in the Node B 3560 include the UE1 3561, the UE2 3562 and the UE3 3563, then the RNC 3540 proceeds to step 3712. In step 3712, the RNC 3540 determines DSPCH-related transmission resource information for transmitting the MBMS data stream, i.e., radio bearer information and radio link information, and then proceeds to step 3713. In step 3713, the RNC 3540 performs a Radio Link Setup process for DSPCH assignment, and then proceeds to step 3708.

FIG. 38 is a flow chart illustrating an operating process of the RNC shown in FIG. 36B according to a fifth embodiment of the present invention. Referring to FIG. 38, in step 3801, the RNC 3540 perceives an increase in number of the MBMS UEs existing a given cell X, or the Node B 3560 described in conjunction with FIG. 36B, and then proceeds to step 3802. In step 3802, the RNC 3540 determines whether the number of MBMS UEs existing in the Node B 3560 is less than a preset Threshold value. As a result of the determination, if the number of MBMS UEs existing in the Node B 3560 is less than the Threshold value, i.e., if the UE1 3561 and the UE2 3562 receive the MBMS service, the RNC 3540 proceeds to step 3803. That is, it is assumed herein that while the UEI 3561 is receiving the MBMS service in the Node B 3560, the UE2 3562 newly requests the MBMS service in the Node B 3560. In step 3803, the RNC 3540 determines transmission resource information, i.e., radio bearer information and radio link information related to ADCH to be assigned to the new MBMS UE, or the UE2 3562, and then proceeds to step 3804.

In step 3804, the RNC 3540, together with the Node B 3560, performs a Radio Link Setup process on ADCH to be assigned to the UE2 3562, and then proceeds to step 3805. In step 3805, the RNC 3540 performs a Radio Bearer Setup process on ADCH to be assigned to the UE2 3562, and then proceeds to step 3806. In step 3806, the RNC 3540 performs Association process together with the Node B 3560, and then proceeds to step 3807. In the Association process, an Associate Request message and an Associate Response message are exchanged between the RNC 3540 and the Node B 3560 as described in conjunction with FIG. 36B. Here, previously assigned NBCC ID and Radio Link ID for DSPCH, i.e., NBCC ID and Radio Link ID designating the DSPCH are inserted in DSPCH information of the Associate Request message. Further, NBCC ID and Radio Link ID for ADCH for the UE2 3562, acquired in the Radio Link Setup process for the ADCH in step 3804, are inserted in ADCH information of the Associate Request message.

After completing the Association process in step 3806, the RNC 3540 performs in step 3807 a Radio Bearer Setup process on the DSPCH together with the UE2 3562, and then proceeds to step 3808. In the Radio Link Bearer Setup process for DSPCH, the RNC 3540 transmits radio bearer information for the DSPCH previously assigned to provide the MBMS service to the UE2 3562 so that the UE2 3562 can set up a radio bearer for the DSPCH. Alternatively, the RNC 3540 may transmit radio bearer information for DSPCH to the UE2 3562 in step 3805. In this case, the RNC 3540 is not required to perform the step 3807. In step 3808, the RNC 3540 receives MBMS data stream provided by the MB-SC from the SGSN 305, and then proceeds to step 3809. In step 3809, the RNC 3540 transmits the received MBMS data stream to the UE1 3561 and the UE2 3562 using the set DSPCH, and then ends the process. However, if the number of MBMS UEs existing in the Node B 3560 is greater than or equal to a present Threshold value in step 3802, i.e., if the MBMS UEs existing in the Node B 3560 include the UE1 3561, the UE2 3562 and the UE3 3563, then the RNC 3540 proceeds to step 3810. That is, it is assumed herein that while the UEI 3561 and the UE2 3562 are receiving the MBMS service in the Node B 3560, the UE3 3563 newly requests the MBMS service in the Node B 3560. In step 3810, the RNC 3540 performs a Disassociation process together with the Node B 3560, and then proceeds to step 3811. In the Disassociation process, a Disassociation Request message and a Disassociation Response message are exchanged between the RNC 3540 and the Node B 3560 as described in conjunction with FIG. 36B, and the Disassociation Request message has NBCC ID and Radio Link ID for the currently set DSPCH. In step 3811, the RNC 3540 performs a Radio Bearer Setup process on DSPCH together with the UE3 3563, and then proceeds to step 3812. In the Radio Bearer Setup process for DSPCH, the RNC 3540 informs the UE3 3563 of radio bearer information for DSPCH previously set to provide the MBMS service so that the UE3 3563 can set up a radio bearer for DSPCH.

In step 3812, the RNC 3540, together with the Node B 3560, performs a Radio Link Delete process for releasing a radio link for ADCHs set up to the UE1 3561 and the UE2 3562, and then proceeds to step 3813. In step 3813, the RNC 3540 performs a Radio Bearer Reconfiguration process for releasing the ADCHs together with the UE1 3561 and the UE2 3562, and then ends the process.

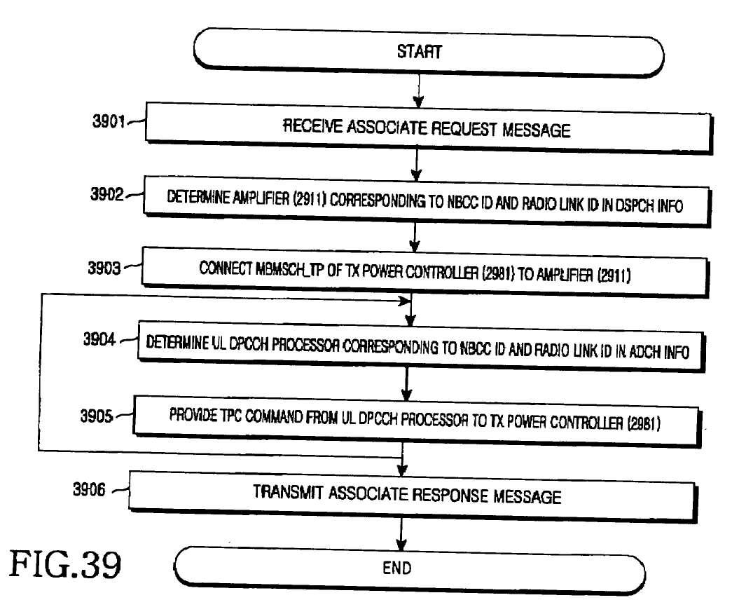

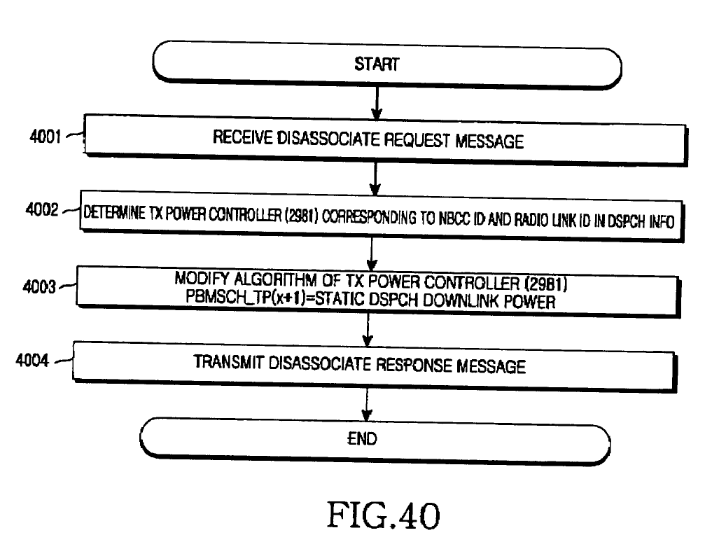

Next, an operation of the Node B 3560 according to a fifth embodiment of the present invention will be described with reference to FIGS. 39 and 40.

FIG. 39 is a flow chart illustrating an operating process of the Node B shown in FIG. 36A according to a fifth embodiment of the present invention. Referring to FIG. 39, in step 3901, the Node B 3560 receives an Associate Request message from the RNC 3540 in an Association process, and then proceeds to step 3902. In step 3902, the Node B 3560 determines an amplifier corresponding to NBCC ID and Radio Link ID included in the DSPCH information in the Associate Request message, and then proceeds to step 3903. The Node B 3560 receives a Radio Link Setup Request message including radio link information for DSPCH described in step 3606 of FIG. 36A, and forms the downlink DPDCH processor 2921 and its associated amplifier 2911 based on the radio link information in the received Radio Link Setup Request message. Therefore, the “amplifier corresponding to NBCC ID and Radio Link ID” means the amplifier 2911 connected to the downlink DPDCH processor 2921 formed through the above process. In other words, the Node B 3560 receives a Radio Link Request message with NBCC ID and Radio Link ID, and sets up a radio link x based on the received message. If the radio link x is comprised of processors y, z and w, the radio link and the related information are identified by the NBCC ID and Radio Link ID.

In step 3903, the Node B 3560 connects MBMSCH TP output from the transmission power controller 2981 to the amplifier 2911, and then proceeds to step 3904. That is, the Node B 3560 provides MBMSCH_TP(x+1) calculated by Equation (9) to the amplifier 2911, and the amplifier 2911 amplifies an input signal at the MBMSCH_TP(x+1). In step 3904, the Node B 3560 determines an uplink DPCCH processor corresponding to NBCC ID and Radio Link ID included in the ADCH information, and the proceeds to step 3905. A process of determining an uplink DPCCH processor corresponding to NBCC IC and Radio Link ID will be described herein below in detail. The Node B 3560 receives a Radio Link Setup Request message from the RNC 3540 in steps 3602 and 3604 of FIG. 36A, and forms the downlink DPCH processors 2923˜2925, the uplink DPDCH processors 2161˜2165, the uplink DPCCH processors 2163˜2167, and the amplifiers 2913˜2915, illustrated in FIG. 29, based on radio link information in the received Radio Link Setup Request message.

In step 3905, the Node B 3560 connects a TPC command output from an plink DPCCH processor corresponding to NBCC ID and Radio Link ID included in the ADCH information among the uplink DPCCH processors for the UEs, to an input terminal of the transmission power controller 2981, and then proceeds to step 3906. The steps 3904 and 3905 are repeated as many times as the number of ADCHs included in the Associate Request message. In step 3906, the Node B 3560 transmits an Associate Response message to the RNC 3540 in reply to the Associate Request message, and then ends the process.

FIG. 40 is a flow chart illustrating an operating process of the Node B shown in FIG. 36B according to a fifth embodiment of the present invention. Referring to FIG. 40, in step 4001, the Node B 3560 receives a Disassociate Request message from the RNC 3540 while performing a Disassociation process together with the RNC 3540, and then proceeds to step 4002. In step 4002, the Node B 3560 determines a transmission power controller corresponding to NBCC ID and Radio Link ID included in DSPCH information in the received Disassociate Request message, and then proceeds to step 4003. Here, “determining a transmission power controller corresponding to NBCC ID and Radio Link ID included in DSPCH information in the received Disassociate Request message” means determining a transmission power controller connected to an amplifier for a radio link corresponding to NBCC ID and Radio Link ID, i.e., determining the transmission power controller 2981. In step 4003, the Node B 3560 modifies an algorithm of the transmission power controller 2981 such that PBMSCH_TP(x+1) output through TBMSCH_TP output from the transmission power controller 2981 should be adjusted to a static DSPCH downlink power value, rather than a value calculated by Equation (9), and then proceeds to step 4004. In step 4004, the Node B 3560 transmits a Disassociate Response message to the RNC 3540 in reply to the Disassociate Request message, and then ends the process.

As described above, the present invention can control transmission power of PBMSCH for transmitting MBMS data in a mobile communication system supporting an MBMS service. In addition, it is possible to maximize efficiency of transmission resources by controlling transmission power of the PBMSCH through CPCCH. Further, if the number of MBMS UEs existing in a cell is relatively small, the mobile communication system supporting an MBMS service performs transmission power control by assigning unique downlink informal DPCCHs and uplink DPCHs to the MBMS UEs, while broadcasting an MBMS data stream over one downlink DPDCH, thereby increasing the quality of the MBMS service. In addition, it is possible to maximize efficiency of transmission resources by broadcasting an MBMS data stream over the downlink DPDCH while separately controlling transmission power for the MBMS UEs.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for controlling transmission power to a plurality of UEs (User Equipments) for multimedia multicast/broadcast service in a mobile communication system including a Node B and the plurality of UEs capable of communicating with the Node B in a cell occupied by the Node B, the Node B being capable of broadcasting multimedia multicast/broadcast data to specified UEs among the plurality of UEs, comprising the steps of:
receiving channel quality information from the plurality of UEs; and
increasing or decreasing transmission power of the Node B based on the worst channel quality information among the channel quality information received from the plurality of UEs.

2 The method of claim 1, wherein the channel quality information is a power contol bit.

3. The method of claim 1, wherein the channel quality information is a value measured multimedia multicast/broadcast data signal strength by UE.

4. The method of claim 1, wherein the Node B receives the channel quality information over a common power control channel.

5. The method of claim 4, wherein the common power control channel comprises:
measurement sub time slots for allowing the plurality of UEs to measure channel quality using the broadcasted data; and TPC (Transmission Power Control) command sub time slots for allowing the plurality of UEs to transmit a TPC command to the Node B based on the measured channel quality information.

6. A method for controlling transmission power of a Node B by a UE (User Equipment) in a mobile communication system including the Node B and a plurality of UEs capable of communicating with the Node B in a cell occupied by the Node B, the Node B being capable of broadcasting common information to specific UEs among the plurality of UEs, comprising the steps of:
measuring a channel quality by receiving the common data stream for a first predetermined period; and
transmitting an up-TPC command for a second predetermined period if the measured channel quality is less than a predetermined target channel quality.

7. The method of claim 6, wherein the UE transmits the up-TPC command over a common power control channel.

8. The method of claim 7, wherein the common power control channel comprises:
measurement sub time slots for the first preset period for allowing the UE to measure channel quality using the broadcasted common data stream; and
TPC (Transmission Power Control) command sub time slots for the second preset period for allowing the UE to transmit a TPC command to the Node B based on the measured channel quality information.

9. An apparatus for controlling transmission power to plurality of UEs (User Equipments) for multimedia multicast/broadcast service in a mobile communication system including a Node B and the plurality of UEs capable of communicating with the Node B in a cell occupied by the Node B, the Node B being capable of broadcasting multimedia multicast/broadcast data to specified UEs among the plurality of UEs, comprising:
a receiver for receiving channel quality information for each UE from the plurality of UEs; and
a transmitter for increasing or decreasing transmission power of the Node B based on the worst channel quality information among the channel quality information received from the plurality of UEs.

10. The apparatus of claim 9, wherein the receiver receives the channel quality information over a common power control channel.

11. The apparatus of claim 10, wherein the common power control channel comprises:
measurement sub time slots for allowing the plurality of UEs to measure channel quality using the broadcasted data ; and
TPC (Transmission Power Control) command sub time slots for allowing the plurality UEs to transmit a TPC command to the Node B based on the measured channel quality information.

12. An apparatus for controlling transmission power of a Node B by a UE (User Equipment) in a mobile communication system including the Node B and a plurality of UEs capable of communicating with the Node B in a cell occupied by the Node B, the Node B being capable of broadcasting multimedia multicast/broadcast data to specific UEs among the plurality of UEs, comprising:
a receiver for measuring a channel quality by receiving the data for a first predetermined period; and
a transmitter for transmitting an up-TPC command for a second predetermined period if the measured channel quality is less than a predetermined target channel quality.

13. The apparatus of claim 12, wherein the transmitter transmits the up-TPC command over a common power control channel.

14. The apparatus of claim 13, wherein the common power control channel comprises:
measurement sub time slots for the first preset period for allowing the UE to measure channel quality using the broadcasteddata; and
TPC (Transmission Power Control) command sub time slots for the second predetermined period for allowing the UE to transmit a TPC command to the Node B based on the measured channel quality information.

15. A method for controlling transmission power of a plurality of UEs (User Equipments) for multimedia multicast/broadcast service in a mobile communication system including the Node B and the plurality of UEs capable of communicating with the Node B in a cell occupied by the Node B, the Node B being capable of broadcasting multimedia multicast/broadcast data to specified UEs among the plurality of UEs, comprising the steps of:
transmitting the multimedia multicast/broadcast data to the plurality of UEs over a downlink shared channel, if the number of UEs receiving the data is less than a predetermined number;
after transmitting the downlink shared channel, receiving a TPC (Transmission Power Control) command corresponding to channel quality of each UE from the plurality of UEs over an uplink dedicated channel; and
increasing or decreasing transmission power of the downlink shared channel data based on the worst channel quality information among the channel quality information received from the plurality of UEs, and transmitting a TPC command corresponding to the channel quality of each UE over a downlink dedicated channel.

16. The method of claim 15, wherein the downlink shared channel includes reference information based on which of the plurality of UEs measures channel quality.

17. The method of claim 15, further comprising the step of increasing transmission power of the downlink shared channel against current transmission power by a preset power offset, if the Node B recognizes that a given UE among the plurality of UEs is soft-handed over from the Node B to a target Node B.

18. A method for controlling transmission power of a Node B by a UE (User Equipment) in a mobile communication system including the Node B and a plurality of UEs capable of communicating with the Node B in a cell occupied by the Node B, the Node B being capable of broadcasting multimedia multicast/broadcast data to specified UEs among the plurality of UEs, comprising the steps of:
receiving a downlink shared channel signal with the multimedia multicast/broadcast data from the Node B, and measuring channel quality using the received downlink shared channel signal; and
transmitting a TPC (Transmission Power Control) command for increasing or decreasing transmission power of the downlink shared channel over an uplink dedicated channel based on the measured channel quality.

19. The method of claim 18, wherein the downlink shared channel includes reference information based on which the channel quality is measured.

20. The method of claim 18, further comprising the step of receiving a downlink dedicated channel signal from the Node B, detecting a TPC command for the uplink dedicated channel from the received downlink dedicated channel signal, and increasing or decreasing transmission power of the uplink dedicated channel based on the detected TPC command.

21. An apparatus for controlling transmission power of a plurality of UEs (User Equipments) by a Node B to perform multimedia multicast/broadcast service in a mobile communication system including the Node B and the UEs capable of communicating with the Node B in a cell occupied by the Node B, the Node B being capable of broadcasting multimedia multicast/broadcast data to specified UEs among the plurality of UEs, comprising:
a downlink shared channel transmitter for transmitting the multimedia multicast/broadcast data to the UEs, if the number of UEs receiving the common information is less than a preset number;
an uplink dedicated channel receiver for receiving, after transmitting the downlink shared channel, a TPC (Transmission Power Control) command corresponding to channel quality of each UE from the at least one UE; and
a downlink dedicated channel transmitter for increasing or decreasing transmission power of the downlink shared channel based on the worst channel quality information among the channel quality information received from the UEs, and transmitting a TPC command corresponding to the channel quality of each UE.

22. The apparatus of claim 21, wherein the downlink shared channel includes reference information based on which of the UEs measure channel quality.

23. The apparatus of claim 21, wherein the downlink shared channel transmitter increases transmission power of the downlink shared channel against current transmission power by a preset power offset, if the Node B recognizes that a given UE among the UEs is soft-handed over from the Node B to a target Node B.

24. An apparatus for controlling transmission power of a Node B by a UE (User Equipment) in a mobile communication system including the Node B and a plurality of UEs capable of communicating with the Node B in a cell occupied by the Node B, the Node B being capable of broadcasting common information to specified UEs among the plurality of UEs, comprising:
a downlink shared channel receiver for receiving a downlink shared channel signal with the common information from the Node B, and measuring channel quality using the received downlink shared channel signal; and
an uplink dedicated channel transmitter for transmitting a TPC (Transmission Power Control) command for increasing or decreasing transmission power of the downlink shared channel based on the measured channel quality.

25. The apparatus of claim 24, wherein the downlink shared channel includes reference information based on the UE of which the channel quality is measured.

26. The apparatus of claim 24, further comprising a downlink dedicated channel receiver for receiving a downlink dedicated channel signal from the Node B, and detecting a TPC command for the uplink dedicated channel from the received downlink dedicated channel signal.

27. The apparatus of claim 26, wherein the uplink dedicated channel transmitter increases or decreases transmission power of the uplink dedicated channel based on the detected TPC command.

28. A method for controlling transmission power to a plurality of UEs (User Equipments) for multimedia broadcast/multicast service in a mobile communication system including the Node B and the plurality of UEs capable of communicating with a Node B in a cell occupied by the Node B, the Node B being capable of broadcasting multimedia multicast/broadcast data to specified UEs among the plurality of UEs, comprising the steps of:
determining to interrupt transmission power control on the Node B while increasing or decreasing transmission power of the Node B, based on power control information received over dedicated channels from the plurality of UEs; and
interrupting transmission power control on the Node B by releasing dedicated channels assigned to the plurality of UEs according to the determination to interrupt the transmission power control on the Node B.

29. A method for controlling transmission power of a shared channel in a mobile communication system including a Node B and a plurality of UEs (User Equipments) capable of communicating with the Node B in a cell occupied by the Node B, the Node B being capable of broadcasting common information to the plurality of UEs over a single shared channel, comprising the steps of:
if the number of the plurality of UEs is less than a predetermined threshold value, assigning dedicated channels for transmission power control on the shared channel to the plurality of UEs;
controlling transmission power of the shared channel based on transmission power control information received from the plurality of UEs over the dedicated channels; and
if the number of the plurality of UEs is greaterthan or equal to the threshold value, releasing the dedicated channels for transmission power control on the shared channel.

30. A method for controlling transmission power of downlink common channel signal in a mobile communication system, comprising the steps of:
receiving a information of the downlink common channel signal strength from at least one UE; and
determining the transmission power of downlink common channel signal by the information.
